(19) United States
(12) Patent Application Publication
(10) Pub. No.: US 2021/0025997 A1
(43) Pub. Date: Jan. 28, 2021

(54) LIDAR SYSTEMS AND METHODS WITH INTERNAL LIGHT CALIBRATION

(71) Applicant: Innoviz Technologies Ltd., Rosh Ha'Ayin (IL)

(72) Inventors: Oren ROSENZWEIG, Tel Aviv (IL); Elad RAICHMAN, Tel Mond (IL)

(73) Assignee: Innoviz Technologies Ltd., Rosh Ha'Ayin (IL)

(21) Appl. No.: 17/045,579

(22) PCT Filed: Apr. 8, 2019
(86) PCT No.: PCT/IB2019/000316

§ 371 Date: Oct. 6, 2020

Related U.S. Application Data
(60) Provisional application No. 62/654,714, filed on Apr. 9, 2018.
(60) Provisional application No. 62/747,761, filed on Oct. 19, 2018.
(60) Provisional application No. 62/754,055, filed on Nov. 1, 2018.

(51) Int. Cl. G01S 7/497; G01S 17/931; G01S 7/486

(52) U.S. Cl. CPC G01S 7/497; G01S 7/4868; G01S 17/931

(57) ABSTRACT

The present disclosure relates to systems and methods for calibrating LIDAR systems using internal light. In one implementation, at least one processor of a LIDAR system may control at least one light source; receive from a group of detectors a first plurality of input signals associated with light projected by the at least one light source and reflected from an object external to the LIDAR system; determine based on the first plurality of input signals a distance to the object; receive from the group of detectors a second plurality of input signals associated with light projected internal to the LIDAR system by the at least one light source; determine based on the second plurality of input signals that there is performance degradation in at least one detector of the group of detectors; and initiate a remedial action in response to the determined performance degradation.

### CROSS-REFERENCES TO RELATED APPLICATIONS

The present application claims priority to U.S. Provisional Application No. 62/654,714, filed Apr. 9, 2018; U.S. Provisional Application No. 62/747,761, filed Oct. 19, 2018; and U.S. Provisional Application No. 62/754,055, filed Nov. 1, 2018. All of the applications listed above are incorporated herein by reference in their entirety.

### BACKGROUND

### I. Technical Field

The present disclosure relates generally to surveying technology for scanning a surrounding environment, and, for example, to systems and methods that use LIDAR technology to detect objects in the surrounding environment.

### II. Background Information

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, a number of differing technologies have been suggested including radar, LIDAR, camera-based systems, operating alone or in a redundant manner.

One consideration with driver assistance systems and autonomous vehicles is an ability of the system to determine surroundings across different conditions including, rain, fog, darkness, bright light, and snow. A light detection and ranging system, (LIDAR a/k/a LADAR) is an example of technology that can work well in differing conditions, by measuring distances to objects by illuminating objects with light and measuring the reflected pulses with a sensor. A laser is one example of a light source that can be used in a LIDAR system. As with any sensing system, in order for a LIDAR-based sensing system to be fully adopted by the automotive industry, the system should provide reliable data enabling detection of far-away objects. Currently, however, the maximum illumination power of LIDAR systems is limited by the need to make the LIDAR systems eye-safe (i.e., so that they will not damage the human eye which can occur when a projected light emission is absorbed in the eye's cornea and lens, causing thermal damage to the retina.)

The systems and methods of the present disclosure are directed towards improving performance of LIDAR systems while complying with eye safety regulations.

### SUMMARY

Embodiments consistent with the present disclosure provide systems and methods for using LIDAR technology to detect objects in the surrounding environment.

Consistent with a disclosed embodiment, a LIDAR system may comprise at least one processor configured to: control at least one light source; receive from a group of detectors a first plurality of input signals, wherein the first plurality of input signals are associated with light projected by the at least one light source and reflected from an object external to the LIDAR system; determine based on the first plurality of input signals a distance to the object; receive from the group of detectors a second plurality of input signals, wherein the second plurality of input signals are associated with light projected internal to the LIDAR system by the at least one light source and impinging on the group of detectors at a time when external light reflections are not expected; determine based on the second plurality of input signals that there is performance degradation in at least one detector of the group of detectors; and initiate a remedial action in response to the determined performance degradation.

Consistent with a disclosed embodiment, a method for detecting degradation in a LIDAR system may comprise controlling at least one light source; receiving, from a group of detectors, a first plurality of input signals, wherein the first plurality of input signals are associated with light projected by the at least one light source and reflected from an object external to the LIDAR system; determining, based on the first plurality of input signals, a distance to the object; receiving, from the group of detectors, a second plurality of input signals, wherein the second plurality of input signals are associated with light projected internal to the LIDAR system by the at least one light source and impinging on the group of detectors at a time when external light reflections are not expected; determining, based on the second plurality of input signals, that there is performance degradation in at least one detector of the group of detectors; and initiating a remedial action in response to the determined performance degradation.

Consistent with a disclosed embodiment, a vehicle may comprise at least one housing; at least one LIDAR system mounted in the at least one housing and comprising: at least one light source; at least one light source configured to project light toward an environment of the vehicle; a group of detectors; and at least one mirror configured to direct the projected light toward portions of the environment and to direct reflections from objects in the environment toward the group of detectors. The vehicle may further comprise at least one processor configured to: control the at least one light source; receive from the group of detectors a first plurality of input signals, wherein the first plurality of input signals are associated with the light projected by the at least one light source and reflected from an object external to the LIDAR system; determine based on the first plurality of input signals a distance to the object; receive from the group of detectors a second plurality of input signals, wherein the second plurality of input signals are associated with light projected internal to the LIDAR system by the at least one light source and impinging on the group of detectors at a time when external light reflections are not expected; determine based on the second plurality of input signals that there is performance degradation in at least one detector of the group of detectors; and initiate a remedial action in response to the determined performance degradation.

Consistent with a disclosed embodiment, a LIDAR system may comprise at least one processor configured to: control light emission of at least one light source, wherein light projected from the at least one light source is directed to at least one deflector for scanning a field of view; control positioning of the at least one light deflector to deflect light from the at least one light source along a scanning pattern to scan the field of view; receive signals from at least one sensor configured to measure positions of the at least one light deflector, wherein the received signals are indicative of an actual scanning pattern of the at least one deflector; access data indicative of an expected scanning pattern of the at least one deflector; use the accessed data and the received signals to determine that there is a deviation between the expected scanning pattern and the actual scanning pattern; and initiate a remedial action in response to the determined deviation.

Consistent with a disclosed embodiment, a LIDAR system for use in a vehicle may comprise at least one processor configured to: control at least one light source in a manner enabling light flux to vary over scans of a field of view using light from the at least one light source; receive from at least one sensor first signals indicative of an output power of the at least one light source; determine from the first signals a first decline in the output power of the at least one light source; adjust an amount of energy delivered to the at least one light source to increase the output power of the light source in response to the first decline; receive from the at least one sensor second signals indicative of an updated output power of the at least one light source after the amount of energy delivered to the at least one light source was increased; determine from the second signals a second drop in the updated output power of the at least one light source; based at least on the second decline, determine if a performance of the at least one light source meets a performance degradation criterion; and after determining that the performance of the at least one light source meets the performance degradation criterion, output a signal to impose a performance restriction on the vehicle until the performance degradation is abated.

Consistent with other disclosed embodiments, a method may include one or more steps of any of the processor-executed steps above and/or include any of the steps described herein.

Consistent with yet other disclosed embodiments, non-transitory computer-readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A is a diagram illustrating an exemplary LIDAR system consistent with disclosed embodiments.

FIG. 1B is an image showing an exemplary output of single scanning cycle of a LIDAR system mounted on a vehicle consistent with disclosed embodiments.

FIG. 1C is another image showing a representation of a point cloud model determined from output of a LIDAR system consistent with disclosed embodiments.

FIGS. 2A-2G are diagrams illustrating different configurations of projecting units in accordance with some embodiments of the present disclosure.

FIGS. 3A-3D are diagrams illustrating different configurations of scanning units in accordance with some embodiments of the present disclosure.

FIGS. 4A-4E are diagrams illustrating different configurations of sensing units in accordance with some embodiments of the present disclosure.

FIG. 5A includes four example diagrams illustrating emission patterns in a single frame-time for a single portion of the field of view.

FIG. 5B includes three example diagrams illustrating emission scheme in a single frame-time for the whole field of view.

FIG. 5C is a diagram illustrating the actual light emission projected towards and reflections received during a single frame-time for the whole field of view.

FIGS. 6A-6C are diagrams illustrating a first example implementation consistent with some embodiments of the present disclosure.

FIG. 6D is a diagram illustrating a second example implementation consistent with some embodiments of the present disclosure.

FIG. 7A is a diagram illustrating an exemplary LIDAR system with an internal light source consistent with disclosed embodiments.

FIG. 7B is a diagram illustrating an exemplary LIDAR system using internal reflections from a light source consistent with disclosed embodiments.

FIG. 8A is a diagram illustrating different signal changes indicative of performance degradation consistent with disclosed embodiments.

FIG. 8B is a diagram illustrating a comparison of signals at different pixels to identify performance degradation consistent with disclosed embodiments.

FIG. 9 is a flowchart of a method for identifying performance degradation in a LIDAR detector consistent with disclosed embodiments.

FIG. 10A is a diagram illustrating an exemplary LIDAR system with a deflector position sensor consistent with disclosed embodiments.

FIG. 10B is a flowchart of a method for detecting scanning deviations in a LIDAR detector consistent with disclosed embodiments.

FIG. 11A is a diagram illustrating an exemplary LIDAR system with an illumination level detector consistent with disclosed embodiments.

FIG. 11B is a flowchart of a method for detecting illumination level changes consistent with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### Terms Definitions

Disclosed embodiments may involve an optical system. As used herein, the term “optical system” broadly includes any system that is used for the generation, detection and/or manipulation of light. By way of example only, an optical system may include one or more optical components for generating, detecting and/or manipulating light. For example, light sources, lenses, mirrors, prisms, beam splitters, collimators, polarizing optics, optical modulators, optical switches, optical amplifiers, optical detectors, optical sensors, fiber optics, semiconductor optic components, while each not necessarily required, may each be part of an optical system. In addition to the one or more optical components, an optical system may also include other non-optical components such as electrical components, mechanical components, chemical reaction components, and semiconductor components. The non-optical components may cooperate with optical components of the optical system. For example, the optical system may include at least one processor for analyzing detected light.

Consistent with the present disclosure, the optical system may be a LIDAR system. As used herein, the term “LIDAR system” broadly includes any system which can determine values of parameters indicative of a distance between a pair of tangible objects based on reflected light. In one embodiment, the LIDAR system may determine a distance between a pair of tangible objects based on reflections of light emitted by the LIDAR system. As used herein, the term “determine distances” broadly includes generating outputs which are indicative of distances between pairs of tangible objects. The determined distance may represent the physical dimension between a pair of tangible objects. By way of example only, the determined distance may include a line of flight distance between the LIDAR system and another tangible object in a field of view of the LIDAR system. In another embodiment, the LIDAR system may determine the relative velocity between a pair of tangible objects based on reflections of light emitted by the LIDAR system. Examples of outputs indicative of the distance between a pair of tangible objects include: a number of standard length units between the tangible objects (e.g. number of meters, number of inches, number of kilometers, number of millimeters), a number of arbitrary length units (e.g. number of LIDAR system lengths), a ratio between the distance to another length (e.g. a ratio to a length of an object detected in a field of view of the LIDAR system), an amount of time (e.g. given as standard unit, arbitrary units or ratio, for example, the time it takes light to travel between the tangible objects), one or more locations (e.g. specified using an agreed coordinate system, specified in relation to a known location), and more.

The LIDAR system may determine the distance between a pair of tangible objects based on reflected light. In one embodiment, the LIDAR system may process detection results of a sensor which creates temporal information indicative of a period of time between the emission of a light signal and the time of its detection by the sensor. The period of time is occasionally referred to as “time of flight” of the light signal. In one example, the light signal may be a short pulse, whose rise and/or fall time may be detected in reception. Using known information about the speed of light in the relevant medium (usually air), the information regarding the time of flight of the light signal can be processed to provide the distance the light signal traveled between emission and detection. In another embodiment, the LIDAR system may determine the distance based on frequency phase-shift (or multiple frequency phase-shift). Specifically, the LIDAR system may process information indicative of one or more modulation phase shifts (e.g. by solving some simultaneous equations to give a final measure) of the light signal. For example, the emitted optical signal may be modulated with one or more constant frequencies. The at least one phase shift of the modulation between the emitted signal and the detected reflection may be indicative of the distance the light traveled between emission and detection. The modulation may be applied to a continuous wave light signal, to a quasi-continuous wave light signal, or to another type of emitted light signal. It is noted that additional information may be used by the LIDAR system for determining the distance, e.g. location information (e.g. relative positions) between the projection location, the detection location of the signal (especially if distanced from one another), and more.

In some embodiments, the LIDAR system may be used for detecting a plurality of objects in an environment of the LIDAR system. The term “detecting an object in an environment of the LIDAR system” broadly includes generating information which is indicative of an object that reflected light toward a detector associated with the LIDAR system. If more than one object is detected by the LIDAR system, the generated information pertaining to different objects may be interconnected, for example a car is driving on a road, a bird is sitting on the tree, a man touches a bicycle, a van moves towards a building. The dimensions of the environment in which the LIDAR system detects objects may vary with respect to implementation. For example, the LIDAR system may be used for detecting a plurality of objects in an environment of a vehicle on which the LIDAR system is installed, up to a horizontal distance of 100 m (or 200 m, 300 m, etc.), and up to a vertical distance of 10 m (or 25 m, 50 m, etc.). In another example, the LIDAR system may be used for detecting a plurality of objects in an environment of a vehicle or within a predefined horizontal range (e.g., 25°, 50°, 100°, 180°, etc.), and up to a predefined vertical elevation (e.g., ±10°, ±20°, +40°-20°, ±90° or 0°-90°).

As used herein, the term “detecting an object” may broadly refer to determining an existence of the object (e.g., an object may exist in a certain direction with respect to the LIDAR system and/or to another reference location, or an object may exist in a certain spatial volume). Additionally or alternatively, the term “detecting an object” may refer to determining a distance between the object and another location (e.g. a location of the LIDAR system, a location on earth, or a location of another object). Additionally or alternatively, the term “detecting an object” may refer to identifying the object (e.g. classifying a type of object such as car, plant, tree, road; recognizing a specific object (e.g., the Washington Monument); determining a license plate number; determining a composition of an object (e.g., solid, liquid, transparent, semitransparent); determining a kinematic parameter of an object (e.g., whether it is moving, its velocity, its movement direction, expansion of the object). Additionally or alternatively, the term “detecting an object” may refer to generating a point cloud map in which every point of one or more points of the point cloud map correspond to a location in the object or a location on a face thereof. In one embodiment, the data resolution associated with the point cloud map representation of the field of view may be associated with 0.1°×0.1° or 0.3°×0.3° of the field of view.

Consistent with the present disclosure, the term “object” broadly includes a finite composition of matter that may reflect light from at least a portion thereof. For example, an object may be at least partially solid (e.g. cars, trees); at least partially liquid (e.g. puddles on the road, rain); at least partly gaseous (e.g. fumes, clouds); made from a multitude of distinct particles (e.g. sand storm, fog, spray); and may be of one or more scales of magnitude, such as ˜1 millimeter (mm), ˜5 mm, ˜10 mm, ˜50 mm, ˜100 mm, ˜500 mm, ˜1 meter (m), ˜5 m, ˜10 m, ˜50 m, ˜100 m, and so on. Smaller or larger objects, as well as any size in between those examples, may also be detected. It is noted that for various reasons, the LIDAR system may detect only part of the object. For example, in some cases, light may be reflected from only some sides of the object (e.g., only the side opposing the LIDAR system will be detected); in other cases, light may be projected on only part of the object (e.g. laser beam projected onto a road or a building); in other cases, the object may be partly blocked by another object between the LIDAR system and the detected object; in other cases, the LIDAR's sensor may only detects light reflected from a portion of the object, e.g., because ambient light or other interferences interfere with detection of some portions of the object.

Consistent with the present disclosure, a LIDAR system may be configured to detect objects by scanning the environment of LIDAR system. The term “scanning the environment of LIDAR system” broadly includes illuminating the field of view or a portion of the field of view of the LIDAR system. In one example, scanning the environment of LIDAR system may be achieved by moving or pivoting a light deflector to deflect light in differing directions toward different parts of the field of view. In another example, scanning the environment of LIDAR system may be achieved by changing a positioning (i.e. location and/or orientation) of a sensor with respect to the field of view. In another example, scanning the environment of LIDAR system may be achieved by changing a positioning (i.e. location and/or orientation) of a light source with respect to the field of view. In yet another example, scanning the environment of LIDAR system may be achieved by changing the positions of at least one light source and of at least one sensor to move rigidly respect to the field of view (i.e. the relative distance and orientation of the at least one sensor and of the at least one light source remains).

As used herein the term “field of view of the LIDAR system” may broadly include an extent of the observable environment of LIDAR system in which objects may be detected. It is noted that the field of view (FOV) of the LIDAR system may be affected by various conditions such as but not limited to: an orientation of the LIDAR system (e.g. is the direction of an optical axis of the LIDAR system); a position of the LIDAR system with respect to the environment (e.g. distance above ground and adjacent topography and obstacles); operational parameters of the LIDAR system (e.g. emission power, computational settings, defined angles of operation), etc. The field of view of LIDAR system may be defined, for example, by a solid angle (e.g. defined using ϕ, θ angles, in which ϕ and θ are angles defined in perpendicular planes, e.g. with respect to symmetry axes of the LIDAR system and/or its FOV). In one example, the field of view may also be defined within a certain range (e.g. up to 200 m).

Similarly, the term “instantaneous field of view” may broadly include an extent of the observable environment in which objects may be detected by the LIDAR system at any given moment. For example, for a scanning LIDAR system, the instantaneous field of view is narrower than the entire FOV of the LIDAR system, and it can be moved within the FOV of the LIDAR system in order to enable detection in other parts of the FOV of the LIDAR system. The movement of the instantaneous field of view within the FOV of the LIDAR system may be achieved by moving a light deflector of the LIDAR system (or external to the LIDAR system), so as to deflect beams of light to and/or from the LIDAR system in differing directions. In one embodiment, LIDAR system may be configured to scan scene in the environment in which the LIDAR system is operating. As used herein the term “scene” may broadly include some or all of the objects within the field of view of the LIDAR system, in their relative positions and in their current states, within an operational duration of the LIDAR system. For example, the scene may include ground elements (e.g. earth, roads, grass, sidewalks, road surface marking), sky, man-made objects (e.g. vehicles, buildings, signs), vegetation, people, animals, light projecting elements (e.g. flashlights, sun, other LIDAR systems), and so on.

Disclosed embodiments may involve obtaining information for use in generating reconstructed three-dimensional models. Examples of types of reconstructed three-dimensional models which may be used include point cloud models, and Polygon Mesh (e.g. a triangle mesh). The terms “point cloud” and “point cloud model” are widely known in the art, and should be construed to include a set of data points located spatially in some coordinate system (i.e., having an identifiable location in a space described by a respective coordinate system). The term “point cloud point” refer to a point in space (which may be dimensionless, or a miniature cellular space, e.g. 1 cm³), and whose location may be described by the point cloud model using a set of coordinates (e.g. (X,Y,Z), (r,ϕ,θ)). By way of example only, the point cloud model may store additional information for some or all of its points (e.g. color information for points generated from camera images). Likewise, any other type of reconstructed three-dimensional model may store additional information for some or all of its objects. Similarly, the terms “polygon mesh” and “triangle mesh” are widely known in the art, and are to be construed to include, among other things, a set of vertices, edges and faces that define the shape of one or more 3D objects (such as a polyhedral object). The faces may include one or more of the following: triangles (triangle mesh), quadrilaterals, or other simple convex polygons, since this may simplify rendering. The faces may also include more general concave polygons, or polygons with holes. Polygon meshes may be represented using differing techniques, such as: Vertex-vertex meshes, Face-vertex meshes, Winged-edge meshes and Render dynamic meshes. Different portions of the polygon mesh (e.g., vertex, face, edge) are located spatially in some coordinate system (i.e., having an identifiable location in a space described by the respective coordinate system), either directly and/or relative to one another. The generation of the reconstructed three-dimensional model may be implemented using any standard, dedicated and/or novel photogrammetry technique, many of which are known in the art. It is noted that other types of models of the environment may be generated by the LIDAR system.

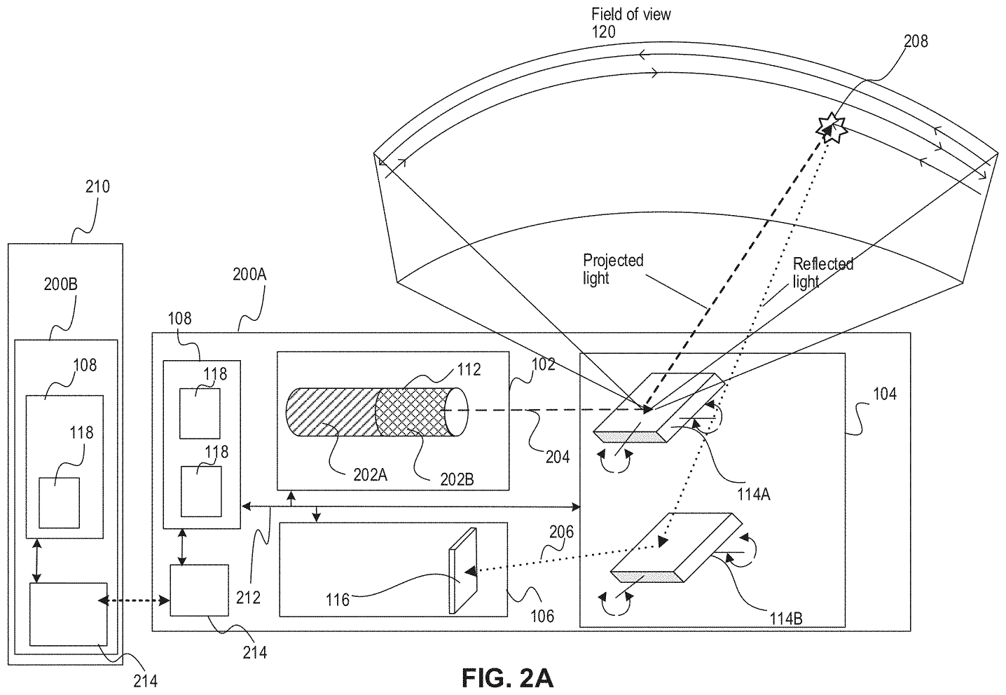

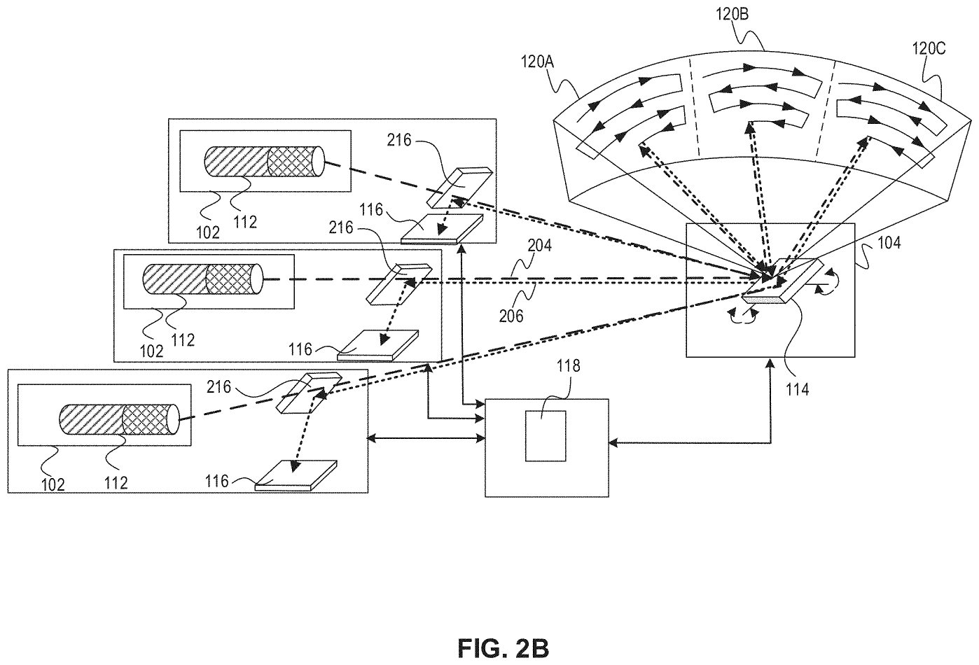

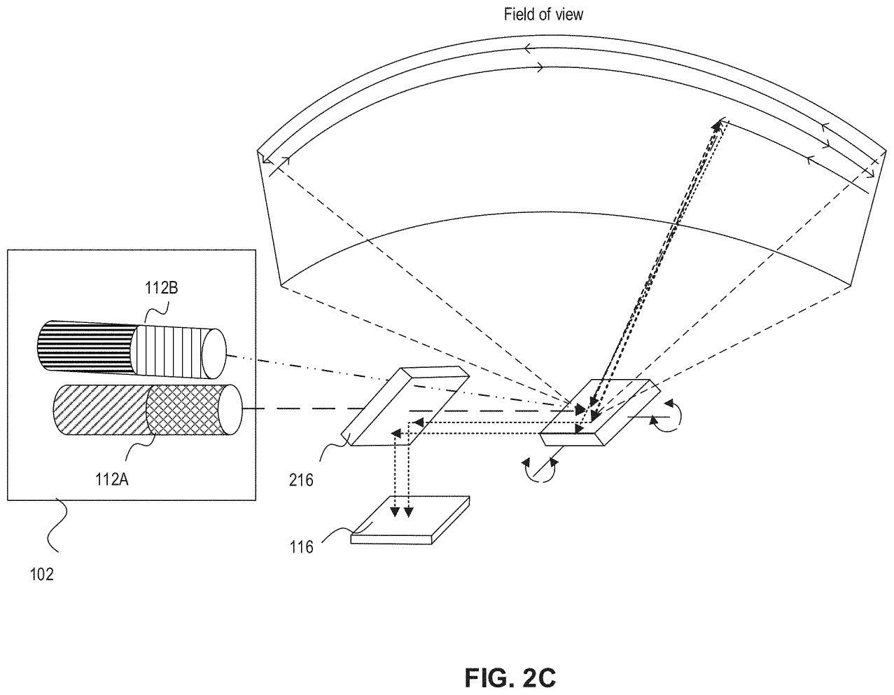

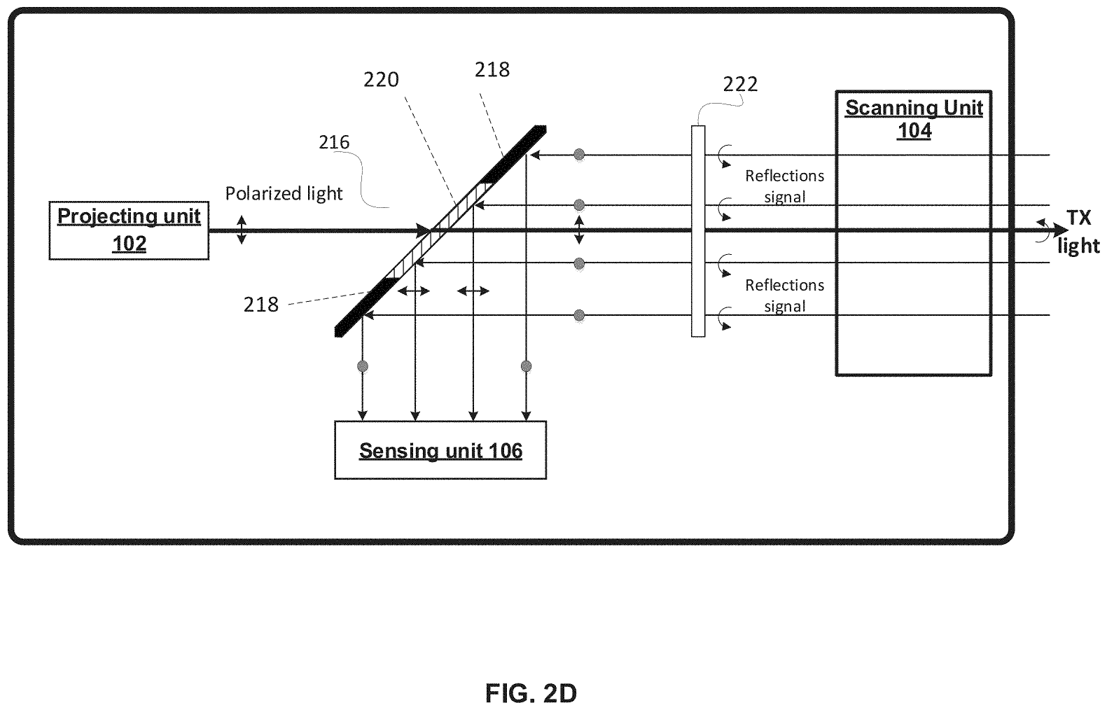

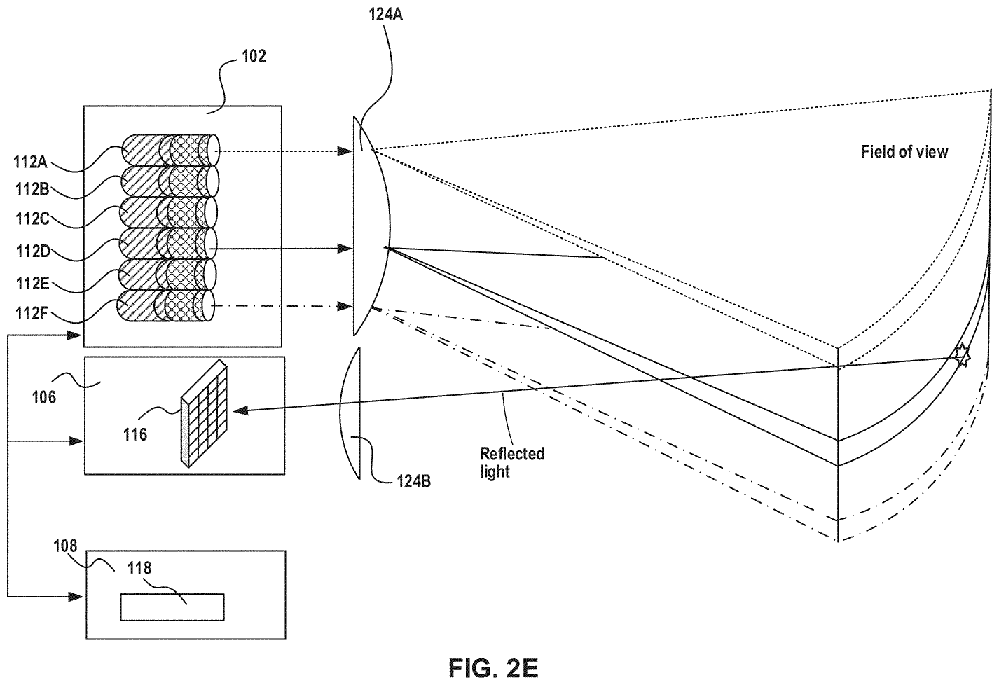

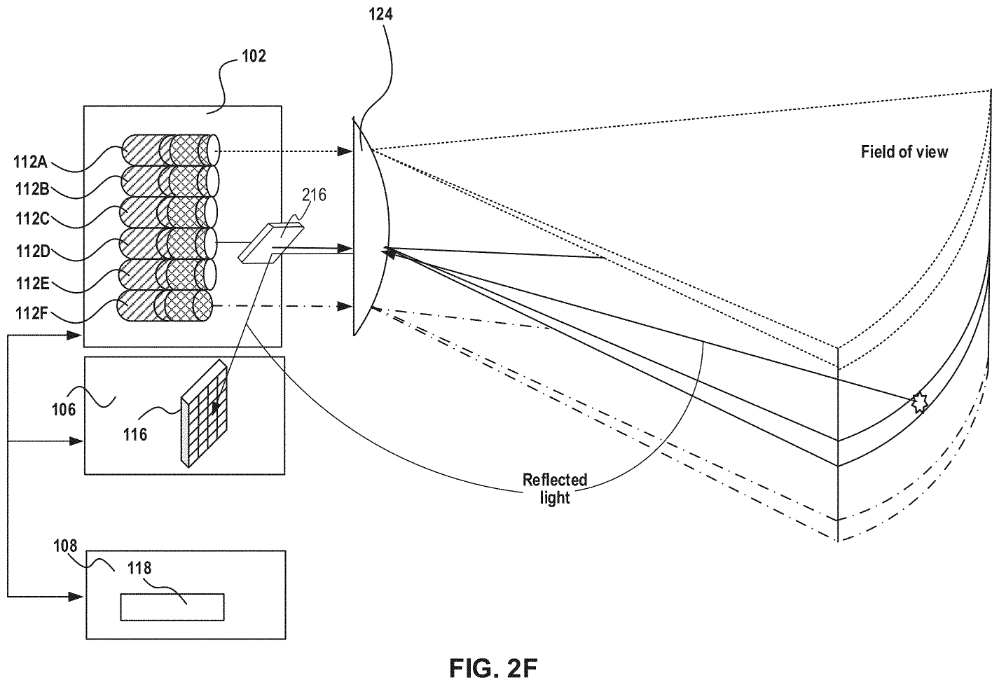

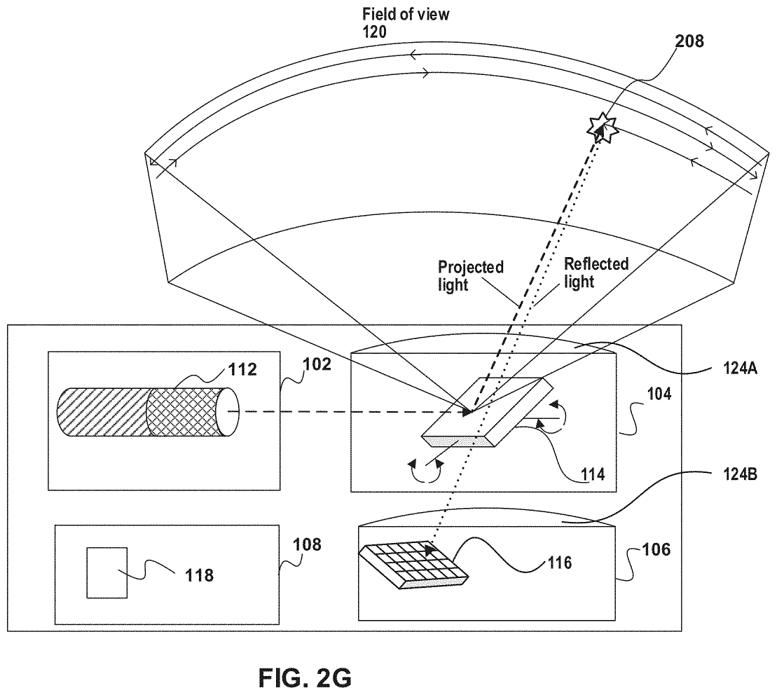

Consistent with disclosed embodiments, the LIDAR system may include at least one projecting unit with a light source configured to project light. As used herein the term “light source” broadly refers to any device configured to emit light. In one embodiment, the light source may be a laser such as a solid-state laser, laser diode, a high power laser, or an alternative light source such as, a light emitting diode (LED)-based light source. In addition, light source 112 as illustrated throughout the figures, may emit light in differing formats, such as light pulses, continuous wave (CW), quasi-CW, and so on. For example, one type of light source that may be used is a vertical-cavity surface-emitting laser (VCSEL). Another type of light source that may be used is an external cavity diode laser (ECDL). In some examples, the light source may include a laser diode configured to emit light at a wavelength between about 650 nm and 1150 nm. Alternatively, the light source may include a laser diode configured to emit light at a wavelength between about 800 nm and about 1000 nm, between about 850 nm and about 950 nm, or between about 1300 nm and about 1600 nm. Unless indicated otherwise, the term “about” with regards to a numeric value is defined as a variance of up to 5% with respect to the stated value. Additional details on the projecting unit and the at least one light source are described below with reference to FIGS. 2A-2G.

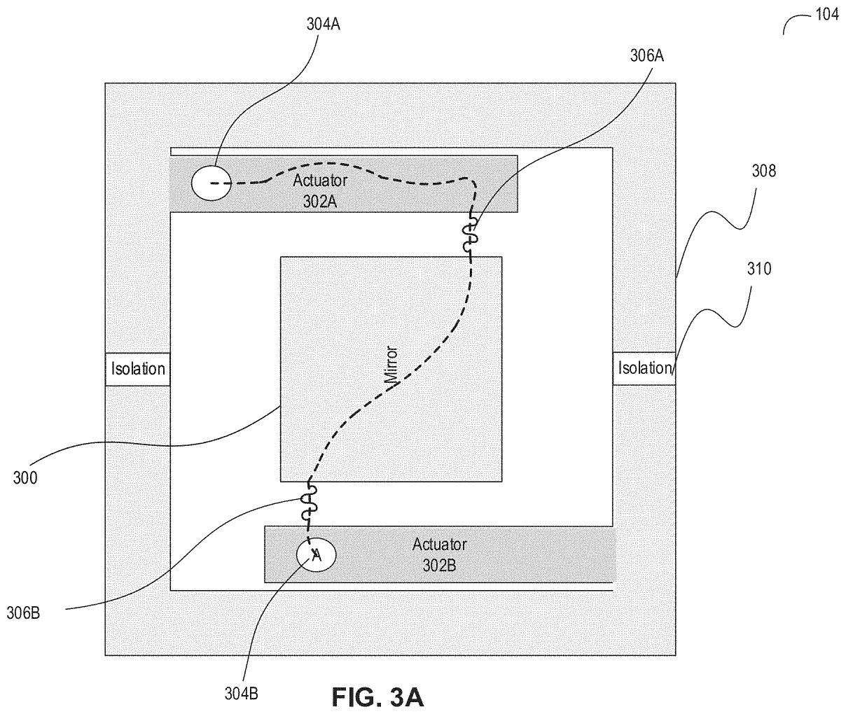

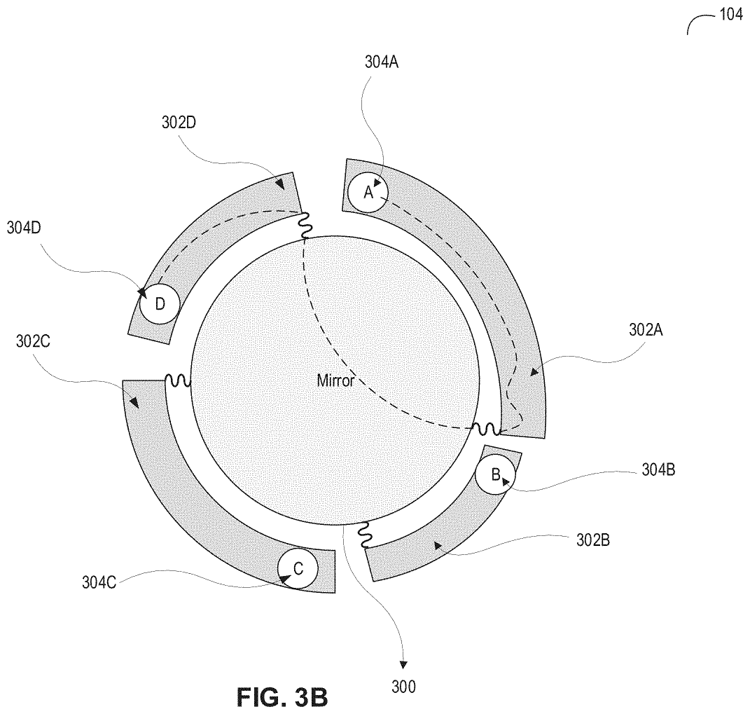

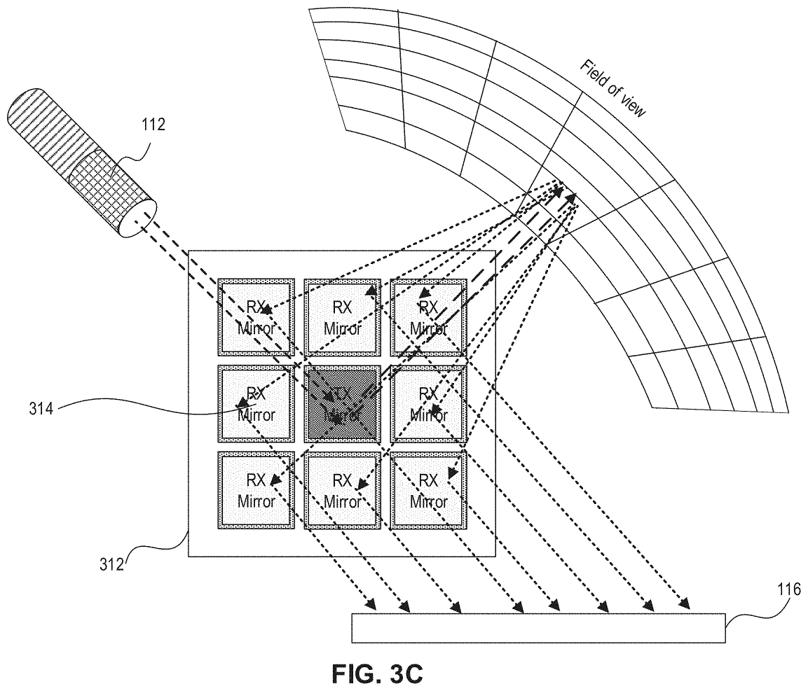

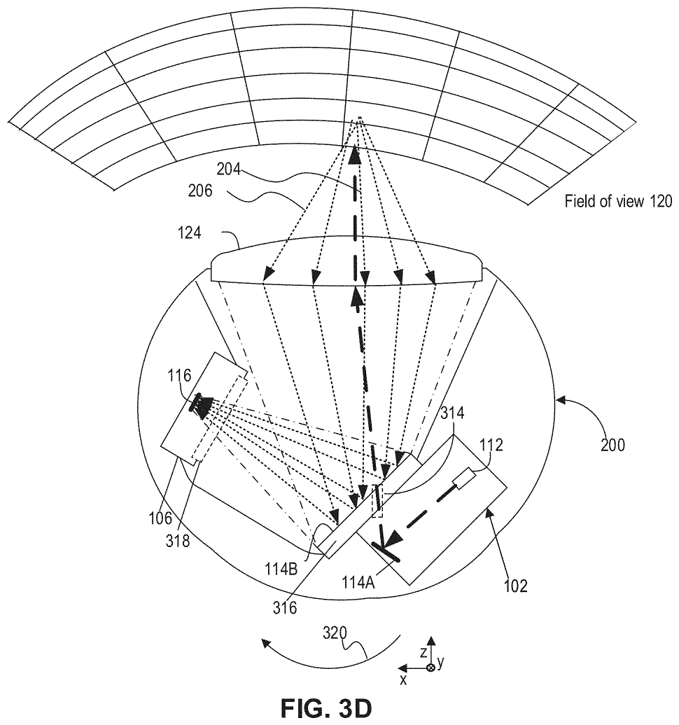

Consistent with disclosed embodiments, the LIDAR system may include at least one scanning unit with at least one light deflector configured to deflect light from the light source in order to scan the field of view. The term “light deflector” broadly includes any mechanism or module which is configured to make light deviate from its original path; for example, a mirror, a prism, controllable lens, a mechanical mirror, mechanical scanning polygons, active diffraction (e.g. controllable LCD), Risley prisms, non-mechanical-electro-optical beam steering (such as made by Vscent), polarization grating (such as offered by Boulder Non-Linear Systems), optical phased array (OPA), and more. In one embodiment, a light deflector may include a plurality of optical components, such as at least one reflecting element (e.g. a mirror), at least one refracting element (e.g. a prism, a lens), and so on. In one example, the light deflector may be movable, to cause light deviate to differing degrees (e.g. discrete degrees, or over a continuous span of degrees). The light deflector may optionally be controllable in different ways (e.g. deflect to a degree α, change deflection angle by Δα, move a component of the light deflector by M millimeters, change speed in which the deflection angle changes). In addition, the light deflector may optionally be operable to change an angle of deflection within a single plane (e.g., θ coordinate). The light deflector may optionally be operable to change an angle of deflection within two non-parallel planes (e.g., θ and ϕ coordinates). Alternatively or in addition, the light deflector may optionally be operable to change an angle of deflection between predetermined settings (e.g. along a predefined scanning route) or otherwise. With respect the use of light deflectors in LIDAR systems, it is noted that a light deflector may be used in the outbound direction (also referred to as transmission direction, or TX) to deflect light from the light source to at least a part of the field of view. However, a light deflector may also be used in the inbound direction (also referred to as reception direction, or RX) to deflect light from at least a part of the field of view to one or more light sensors. Additional details on the scanning unit and the at least one light deflector are described below with reference to FIGS. 3A-3D.

Disclosed embodiments may involve pivoting the light deflector in order to scan the field of view. As used herein the term “pivoting” broadly includes rotating of an object (especially a solid object) about one or more axis of rotation, while substantially maintaining a center of rotation fixed. In one embodiment, the pivoting of the light deflector may include rotation of the light deflector about a fixed axis (e.g., a shaft), but this is not necessarily so. For example, in some MEMS mirror implementation, the MEMS mirror may move by actuation of a plurality of benders connected to the mirror, the mirror may experience some spatial translation in addition to rotation. Nevertheless, such mirror may be designed to rotate about a substantially fixed axis, and therefore consistent with the present disclosure it considered to be pivoted. In other embodiments, some types of light deflectors (e.g. non-mechanical-electro-optical beam steering, OPA) do not require any moving components or internal movements in order to change the deflection angles of deflected light. It is noted that any discussion relating to moving or pivoting a light deflector is also mutatis mutandis applicable to controlling the light deflector such that it changes a deflection behavior of the light deflector. For example, controlling the light deflector may cause a change in a deflection angle of beams of light arriving from at least one direction.

Disclosed embodiments may involve receiving reflections associated with a portion of the field of view corresponding to a single instantaneous position of the light deflector. As used herein, the term “instantaneous position of the light deflector” (also referred to as “state of the light deflector”) broadly refers to the location or position in space where at least one controlled component of the light deflector is situated at an instantaneous point in time, or over a short span of time. In one embodiment, the instantaneous position of light deflector may be gauged with respect to a frame of reference. The frame of reference may pertain to at least one fixed point in the LIDAR system. Or, for example, the frame of reference may pertain to at least one fixed point in the scene. In some embodiments, the instantaneous position of the light deflector may include some movement of one or more components of the light deflector (e.g. mirror, prism), usually to a limited degree with respect to the maximal degree of change during a scanning of the field of view. For example, a scanning of the entire the field of view of the LIDAR system may include changing deflection of light over a span of 30°, and the instantaneous position of the at least one light deflector may include angular shifts of the light deflector within 0.05°. In other embodiments, the term “instantaneous position of the light deflector” may refer to the positions of the light deflector during acquisition of light which is processed to provide data for a single point of a point cloud (or another type of 3D model) generated by the LIDAR system. In some embodiments, an instantaneous position of the light deflector may correspond with a fixed position or orientation in which the deflector pauses for a short time during illumination of a particular sub-region of the LIDAR field of view. In other cases, an instantaneous position of the light deflector may correspond with a certain position/orientation along a scanned range of positions/orientations of the light deflector that the light deflector passes through as part of a continuous or semi-continuous scan of the LIDAR field of view. In some embodiments, the light deflector may be moved such that during a scanning cycle of the LIDAR FOV the light deflector is located at a plurality of different instantaneous positions. In other words, during the period of time in which a scanning cycle occurs, the deflector may be moved through a series of different instantaneous positions/orientations, and the deflector may reach each different instantaneous position/orientation at a different time during the scanning cycle.

Consistent with disclosed embodiments, the LIDAR system may include at least one sensing unit with at least one sensor configured to detect reflections from objects in the field of view. The term “sensor” broadly includes any device, element, or system capable of measuring properties (e.g., power, frequency, phase, pulse timing, pulse duration) of electromagnetic waves and to generate an output relating to the measured properties. In some embodiments, the at least one sensor may include a plurality of detectors constructed from a plurality of detecting elements. The at least one sensor may include light sensors of one or more types. It is noted that the at least one sensor may include multiple sensors of the same type which may differ in other characteristics (e.g., sensitivity, size). Other types of sensors may also be used. Combinations of several types of sensors can be used for different reasons, such as improving detection over a span of ranges (especially in close range); improving the dynamic range of the sensor; improving the temporal response of the sensor; and improving detection in varying environmental conditions (e.g. atmospheric temperature, rain, etc.).

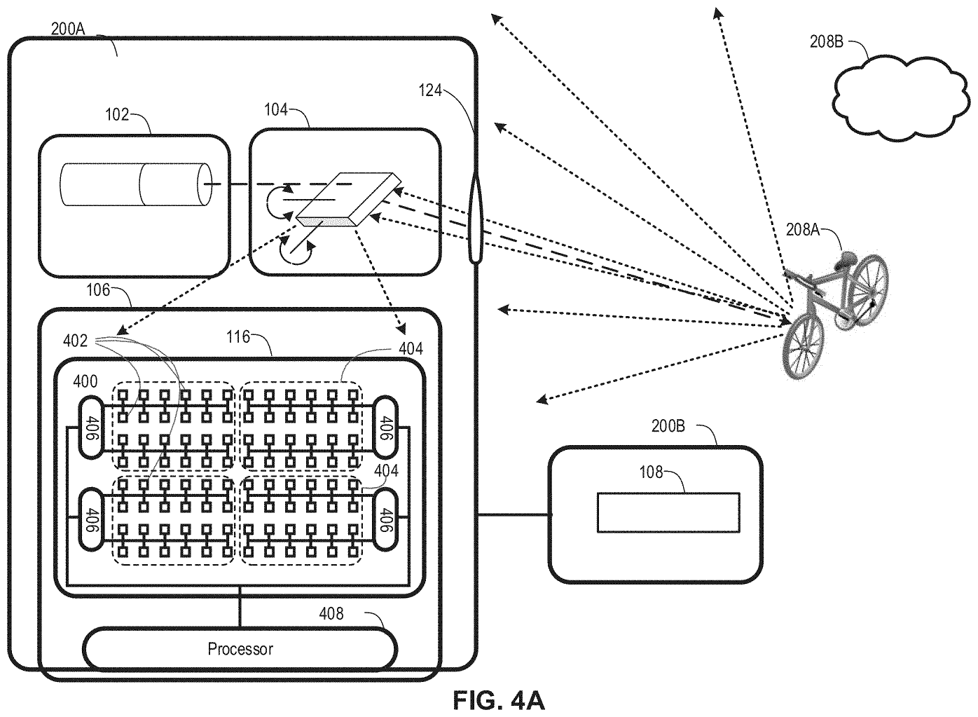

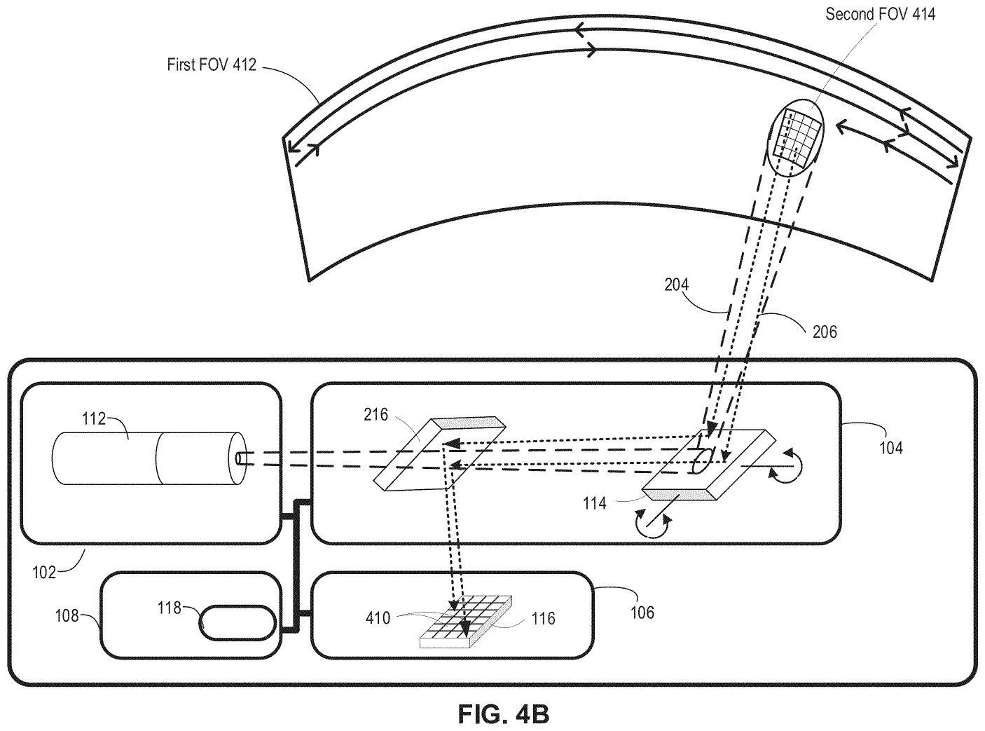

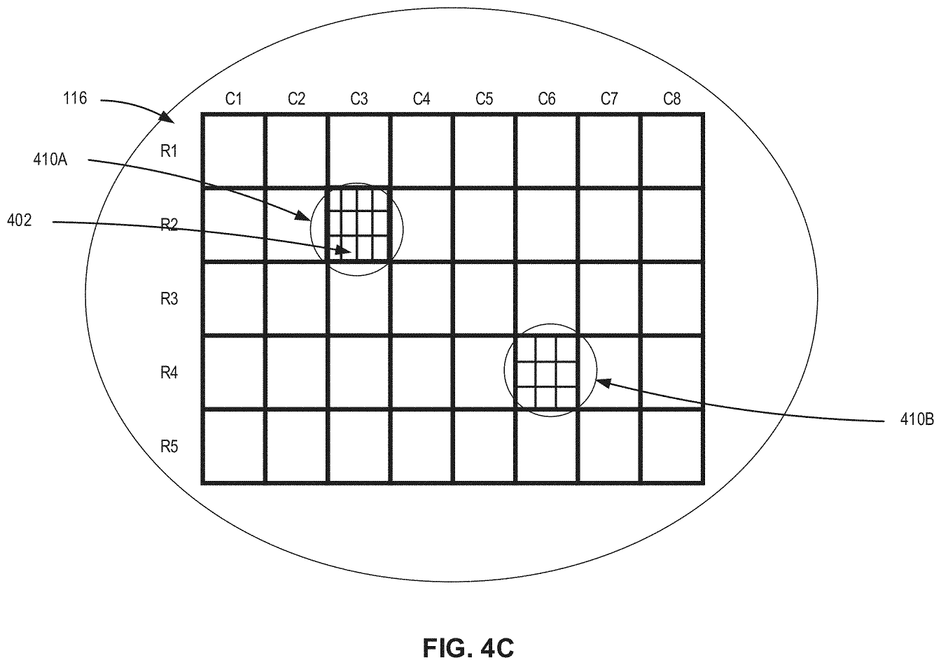

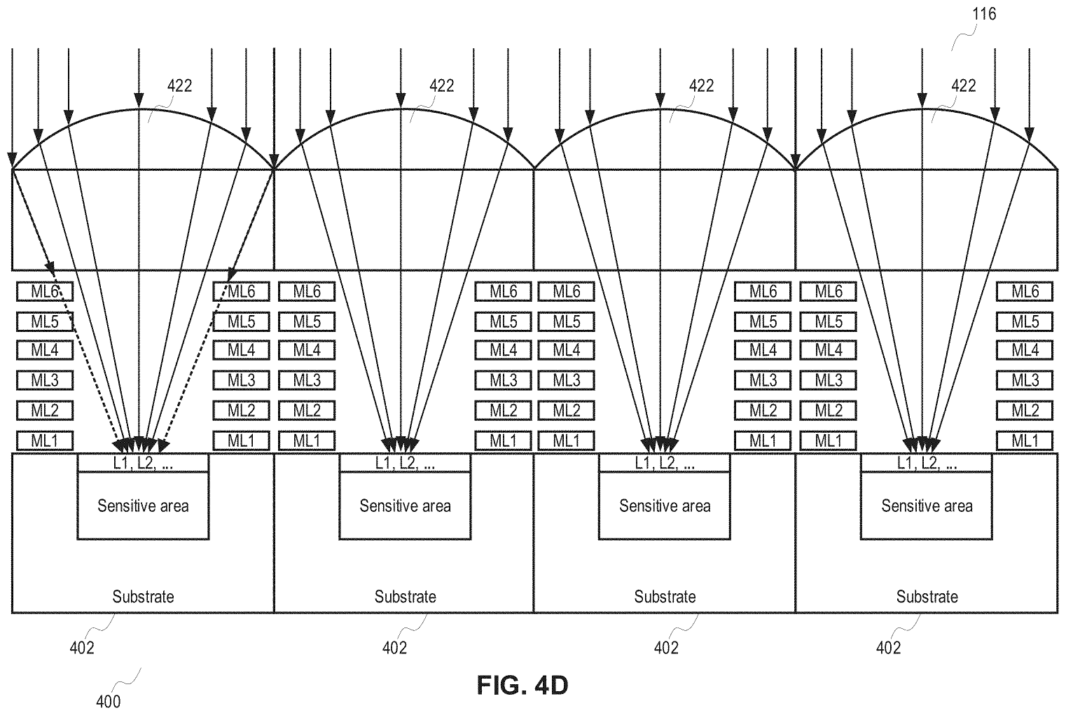

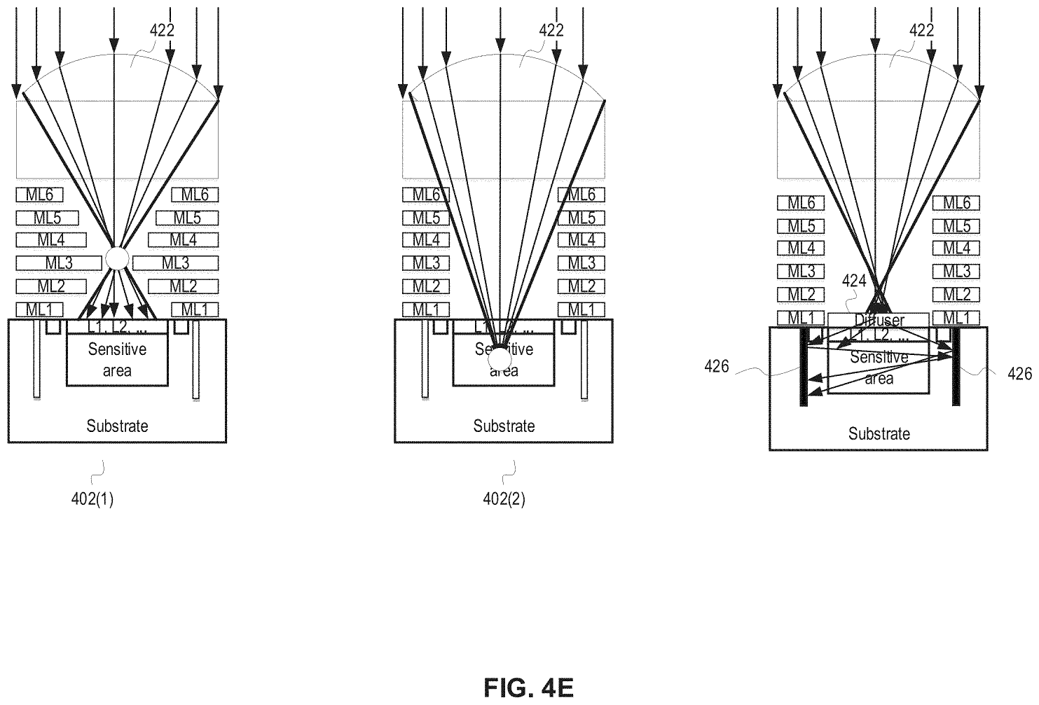

In one embodiment, the at least one sensor includes a SiPM (Silicon photomultipliers) which is a solid-state single-photon-sensitive device built from an array of avalanche photodiode (APD), single photon avalanche diode (SPAD), serving as detection elements on a common silicon substrate. In one example, a typical distance between SPADs may be between about 10 μm and about 50 μm, wherein each SPAD may have a recovery time of between about 20 ns and about 100 ns Similar photomultipliers from other, non-silicon materials may also be used. Although a SiPM device works in digital/switching mode, the SiPM is an analog device because all the microcells may be read in parallel, making it possible to generate signals within a dynamic range from a single photon to hundreds and thousands of photons detected by the different SPADs. It is noted that outputs from different types of sensors (e.g., SPAD, APD, SiPM, PIN diode, Photodetector) may be combined together to a single output which may be processed by a processor of the LIDAR system. Additional details on the sensing unit and the at least one sensor are described below with reference to FIGS. 4A-4E.

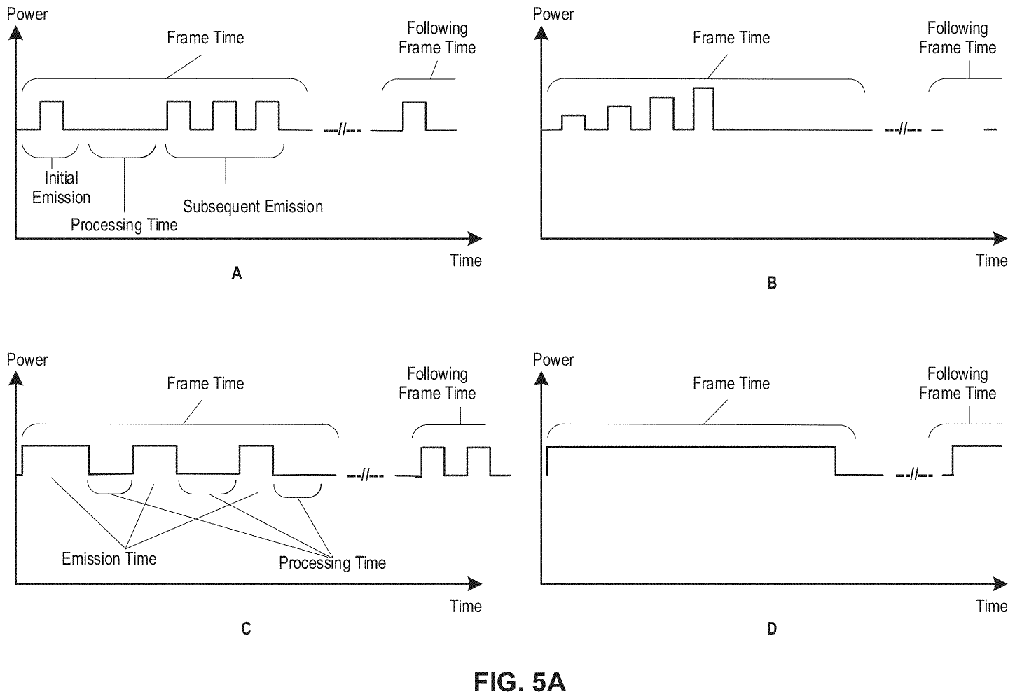

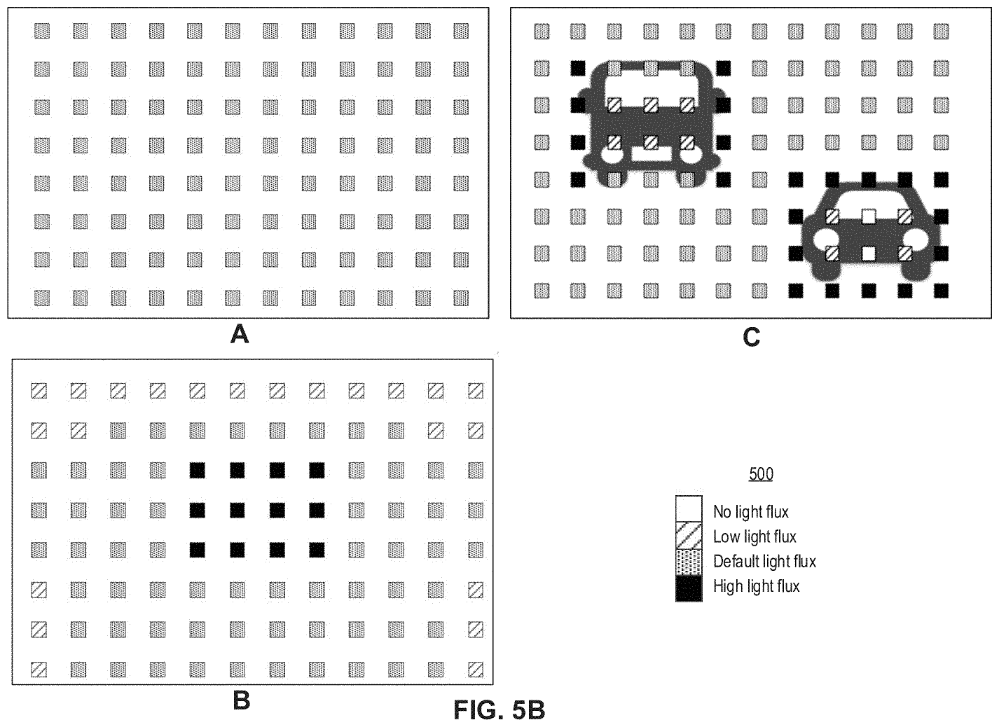

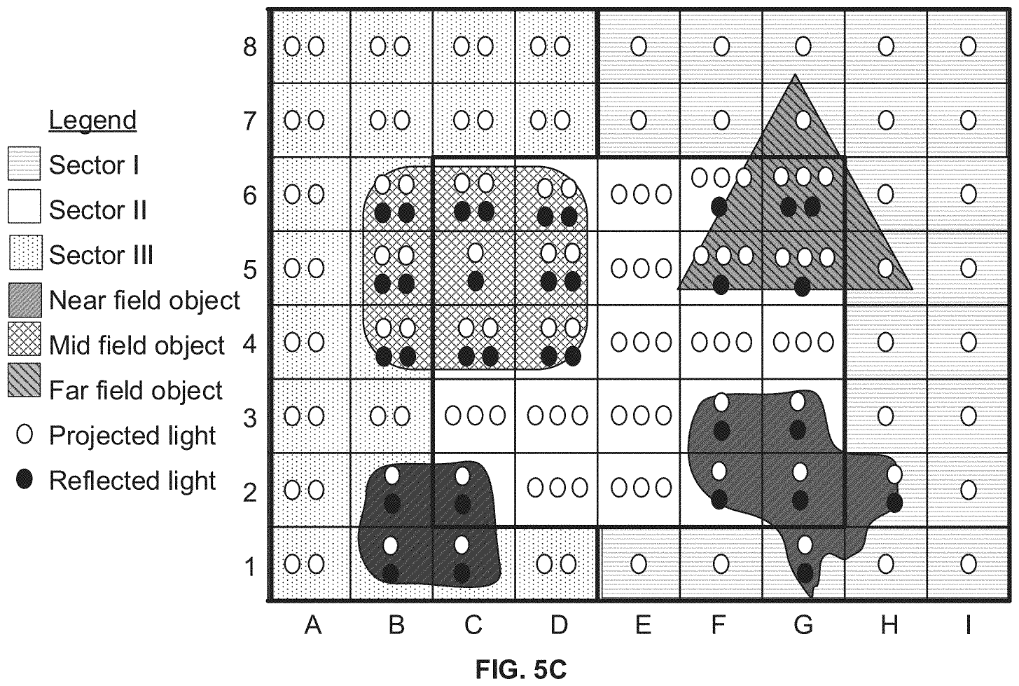

Consistent with disclosed embodiments, the LIDAR system may include or communicate with at least one processor configured to execute differing functions. The at least one processor may constitute any physical device having an electric circuit that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by at least one processor may, for example, be pre-loaded into a memory integrated with or embedded into the controller or may be stored in a separate memory. The memory may comprise a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the memory is configured to store information representative data about objects in the environment of the LIDAR system. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact. Additional details on the processing unit and the at least one processor are described below with reference to FIGS. 5A-5C.

### System Overview

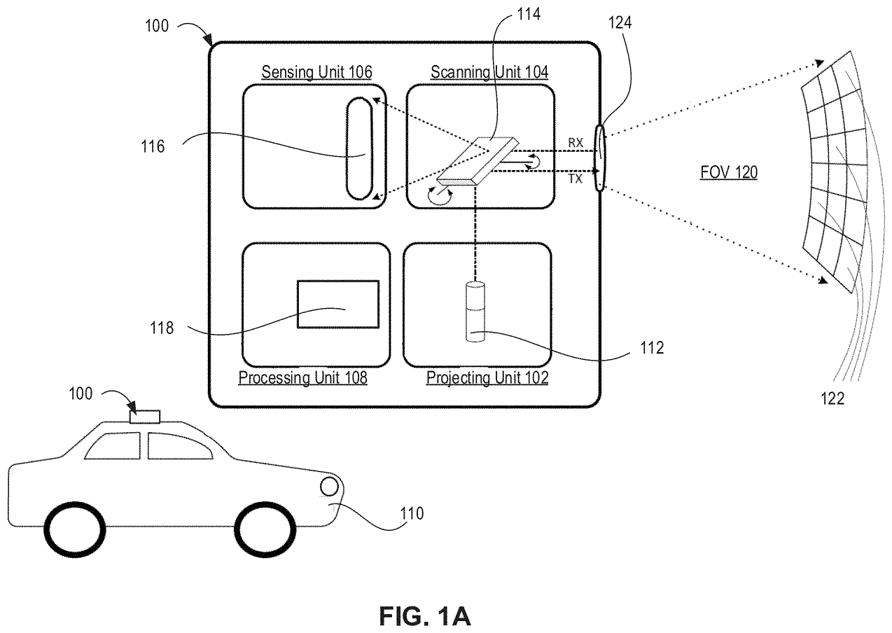

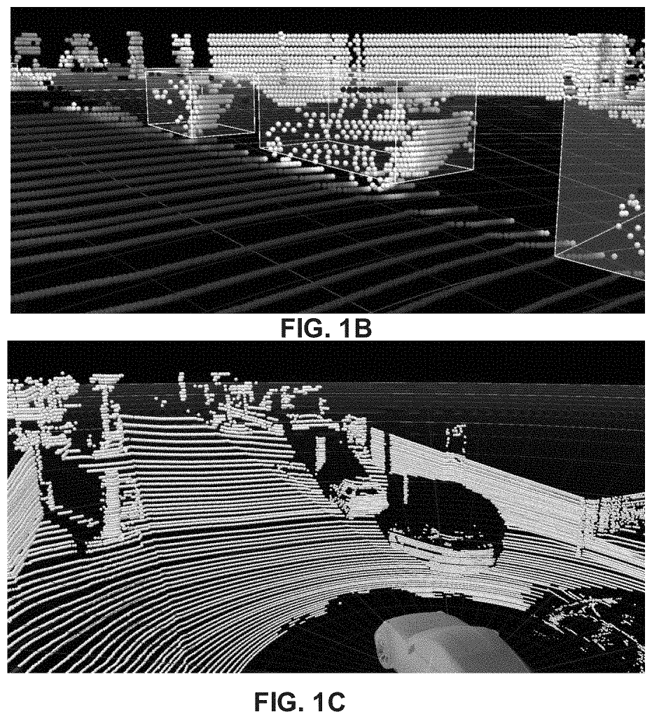

FIG. 1A illustrates a LIDAR system 100 including a projecting unit 102, a scanning unit 104, a sensing unit 106, and a processing unit 108. LIDAR system 100 may be mountable on a vehicle 110. Consistent with embodiments of the present disclosure, projecting unit 102 may include at least one light source 112, scanning unit 104 may include at least one light deflector 114, sensing unit 106 may include at least one sensor 116, and processing unit 108 may include at least one processor 118. In one embodiment, at least one processor 118 may be configured to coordinate operation of the at least one light source 112 with the movement of at least one light deflector 114 in order to scan a field of view 120. During a scanning cycle, each instantaneous position of at least one light deflector 114 may be associated with a particular portion 122 of field of view 120. In addition, LIDAR system 100 may include at least one optional optical window 124 for directing light projected towards field of view 120 and/or receiving light reflected from objects in field of view 120. Optional optical window 124 may serve different purposes, such as collimation of the projected light and focusing of the reflected light. In one embodiment, optional optical window 124 may be an opening, a flat window, a lens, or any other type of optical window.

Consistent with the present disclosure, LIDAR system 100 may be used in autonomous or semi-autonomous road-vehicles (for example, cars, buses, vans, trucks and any other terrestrial vehicle). Autonomous road-vehicles with LIDAR system 100 may scan their environment and drive to a destination vehicle without human input. Similarly, LIDAR system 100 may also be used in autonomous/semi-autonomous aerial-vehicles (for example, UAV, drones, quadcopters, and any other airborne vehicle or device); or in an autonomous or semi-autonomous water vessel (e.g., boat, ship, submarine, or any other watercraft). Autonomous aerial-vehicles and water craft with LIDAR system 100 may scan their environment and navigate to a destination autonomously or using a remote human operator. According to one embodiment, vehicle 110 (either a road-vehicle, aerial-vehicle, or watercraft) may use LIDAR system 100 to aid in detecting and scanning the environment in which vehicle 110 is operating.

It should be noted that LIDAR system 100 or any of its components may be used together with any of the example embodiments and methods disclosed herein. Further, while some aspects of LIDAR system 100 are described relative to an exemplary vehicle-based LIDAR platform, LIDAR system 100, any of its components, or any of the processes described herein may be applicable to LIDAR systems of other platform types.

In some embodiments, LIDAR system 100 may include one or more scanning units 104 to scan the environment around vehicle 110. LIDAR system 100 may be attached or mounted to any part of vehicle 110. Sensing unit 106 may receive reflections from the surroundings of vehicle 110, and transfer reflections signals indicative of light reflected from objects in field of view 120 to processing unit 108. Consistent with the present disclosure, scanning units 104 may be mounted to or incorporated into a bumper, a fender, a side panel, a spoiler, a roof, a headlight assembly, a taillight assembly, a rear-view mirror assembly, a hood, a trunk or any other suitable part of vehicle 110 capable of housing at least a portion of the LIDAR system. In some cases, LIDAR system 100 may capture a complete surround view of the environment of vehicle 110. Thus, LIDAR system 100 may have a 360-degree horizontal field of view. In one example, as shown in FIG. 1A, LIDAR system 100 may include a single scanning unit 104 mounted on a roof vehicle 110. Alternatively, LIDAR system 100 may include multiple scanning units (e.g., two, three, four, or more scanning units 104) each with a field of few such that in the aggregate the horizontal field of view is covered by a 360-degree scan around vehicle 110. One skilled in the art will appreciate that LIDAR system 100 may include any number of scanning units 104 arranged in any manner, each with an 80° to 120° field of view or less, depending on the number of units employed. Moreover, a 360-degree horizontal field of view may be also obtained by mounting multiple LIDAR systems 100 on vehicle 110, each with a single scanning unit 104. It is nevertheless noted, that the one or more LIDAR systems 100 do not have to provide a complete 360° field of view, and that narrower fields of view may be useful in some situations. For example, vehicle 110 may require a first LIDAR system 100 having a field of view of 75° looking ahead of the vehicle, and possibly a second LIDAR system 100 with a similar FOV looking backward (optionally with a lower detection range). It is also noted that different vertical field of view angles may also be implemented.

FIG. 1B is an image showing an exemplary output from a single scanning cycle of LIDAR system 100 mounted on vehicle 110 consistent with disclosed embodiments. In this example, scanning unit 104 is incorporated into a right headlight assembly of vehicle 110. Every gray dot in the image corresponds to a location in the environment around vehicle 110 determined from reflections detected by sensing unit 106. In addition to location, each gray dot may also be associated with different types of information, for example, intensity (e.g., how much light returns back from that location), reflectivity, proximity to other dots, and more. In one embodiment, LIDAR system 100 may generate a plurality of point-cloud data entries from detected reflections of multiple scanning cycles of the field of view to enable, for example, determining a point cloud model of the environment around vehicle 110.

FIG. 1C is an image showing a representation of the point cloud model determined from the output of LIDAR system 100. Consistent with disclosed embodiments, by processing the generated point-cloud data entries of the environment around vehicle 110, a surround-view image may be produced from the point cloud model. In one embodiment, the point cloud model may be provided to a feature extraction module, which processes the point cloud information to identify a plurality of features. Each feature may include data about different aspects of the point cloud and/or of objects in the environment around vehicle 110 (e.g. cars, trees, people, and roads). Features may have the same resolution of the point cloud model (i.e. having the same number of data points, optionally arranged into similar sized 2D arrays), or may have different resolutions. The features may be stored in any kind of data structure (e.g. raster, vector, 2D array, 1D array). In addition, virtual features, such as a representation of vehicle 110, border lines, or bounding boxes separating regions or objects in the image (e.g., as depicted in FIG. 1B), and icons representing one or more identified objects, may be overlaid on the representation of the point cloud model to form the final surround-view image. For example, a symbol of vehicle 110 may be overlaid at a center of the surround-view image.

### The Projecting Unit

FIGS. 2A-2G depict various configurations of projecting unit 102 and its role in LIDAR system 100. Specifically, FIG. 2A is a diagram illustrating projecting unit 102 with a single light source; FIG. 2B is a diagram illustrating a plurality of projecting units 102 with a plurality of light sources aimed at a common light deflector 114; FIG. 2C is a diagram illustrating projecting unit 102 with a primary and a secondary light sources 112; FIG. 2D is a diagram illustrating an asymmetrical deflector used in some configurations of projecting unit 102; FIG. 2E is a diagram illustrating a first configuration of a non-scanning LIDAR system; FIG. 2F is a diagram illustrating a second configuration of a non-scanning LIDAR system; and FIG. 2G is a diagram illustrating a LIDAR system that scans in the outbound direction and does not scan in the inbound direction. One skilled in the art will appreciate that the depicted configurations of projecting unit 102 may have numerous variations and modifications.

FIG. 2A illustrates an example of a bi-static configuration of LIDAR system 100 in which projecting unit 102 includes a single light source 112. The term “bi-static configuration” broadly refers to LIDAR systems configurations in which the projected light exiting the LIDAR system and the reflected light entering the LIDAR system pass through substantially different optical paths. In some embodiments, a bi-static configuration of LIDAR system 100 may include a separation of the optical paths by using completely different optical components, by using parallel but not fully separated optical components, or by using the same optical components for only part of the of the optical paths (optical components may include, for example, windows, lenses, mirrors, beam splitters, etc.). In the example depicted in FIG. 2A, the bi-static configuration includes a configuration where the outbound light and the inbound light pass through a single optical window 124 but scanning unit 104 includes two light deflectors, a first light deflector 114A for outbound light and a second light deflector 114B for inbound light (the inbound light in LIDAR system includes emitted light reflected from objects in the scene, and may also include ambient light arriving from other sources). In the examples depicted in FIGS. 2E and 2G, the bi-static configuration includes a configuration where the outbound light passes through a first optical window 124A, and the inbound light passes through a second optical window 124B. In all the example configurations above, the inbound and outbound optical paths differ from one another.

In this embodiment, all the components of LIDAR system 100 may be contained within a single housing 200, or may be divided among a plurality of housings. As shown, projecting unit 102 is associated with a single light source 112 that includes a laser diode 202A (or one or more laser diodes coupled together) configured to emit light (projected light 204). In one non-limiting example, the light projected by light source 112 may be at a wavelength between about 800 nm and 950 nm, have an average power between about 50 mW and about 500 mW, have a peak power between about 50 W and about 200 W, and a pulse width of between about 2 ns and about 100 ns. In addition, light source 112 may optionally be associated with optical assembly 202B used for manipulation of the light emitted by laser diode 202A (e.g. for collimation, focusing, etc.). It is noted that other types of light sources 112 may be used, and that the disclosure is not restricted to laser diodes. In addition, light source 112 may emit its light in different formats, such as light pulses, frequency modulated, continuous wave (CW), quasi-CW, or any other form corresponding to the particular light source employed. The projection format and other parameters may be changed by the light source from time to time based on different factors, such as instructions from processing unit 108. The projected light is projected towards an outbound deflector 114A that functions as a steering element for directing the projected light in field of view 120. In this example, scanning unit 104 also include a pivotable return deflector 114B that direct photons (reflected light 206) reflected back from an object 208 within field of view 120 toward sensor 116. The reflected light is detected by sensor 116 and information about the object (e.g., the distance to object 212) is determined by processing unit 108.

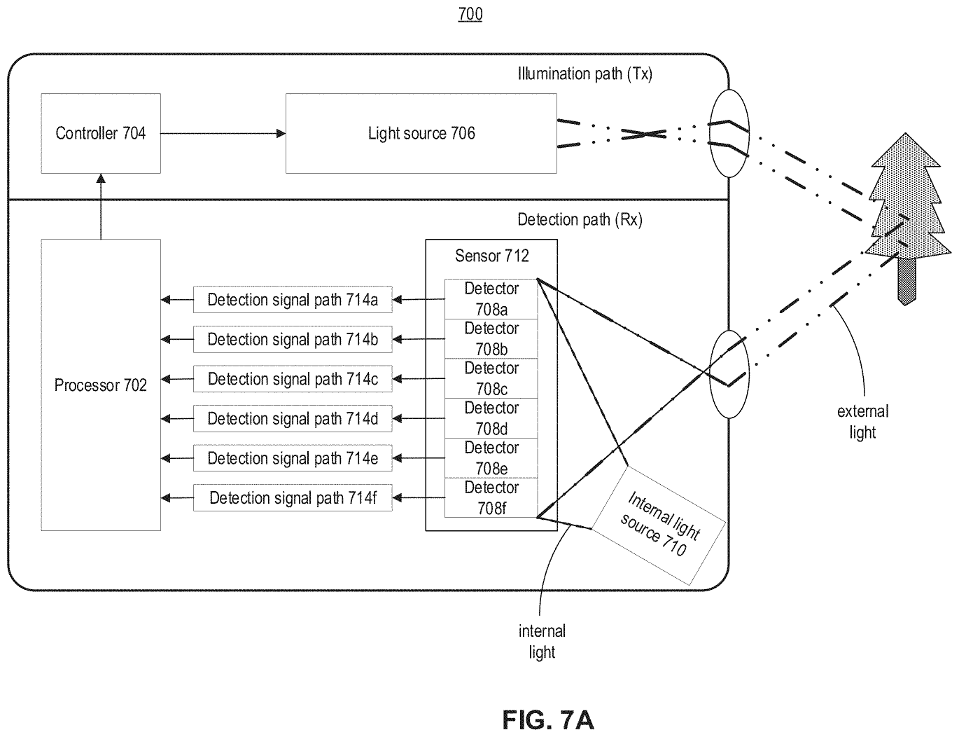

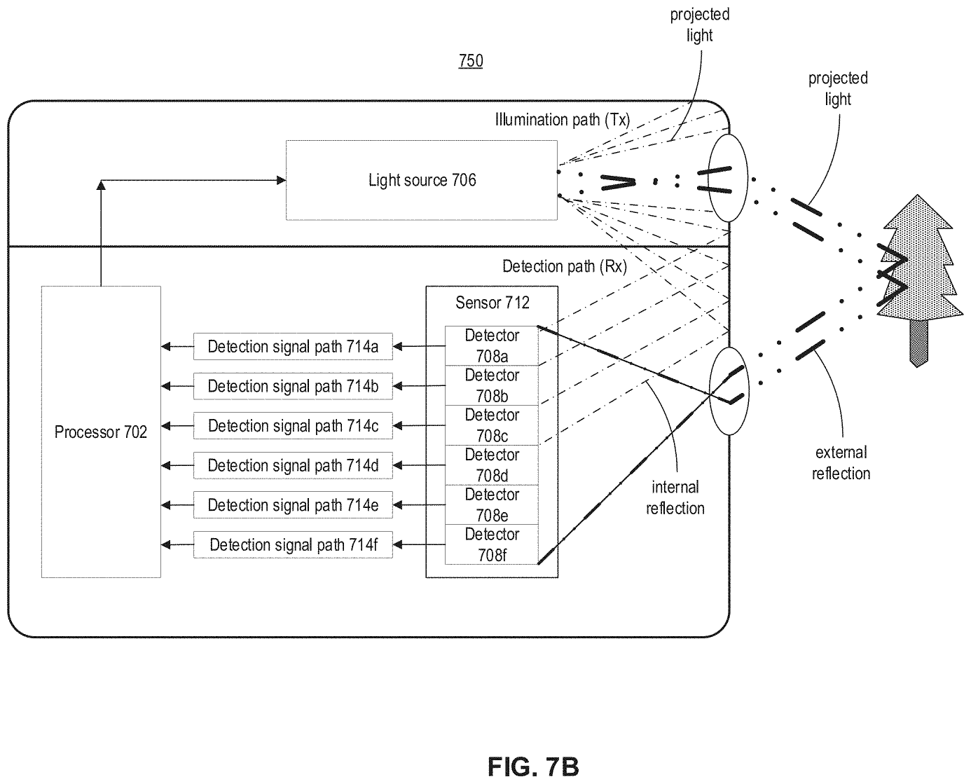

In this figure, LIDAR system 100 is connected to a host 210. Consistent with the present disclosure, the term “host” refers to any computing environment that may interface with LIDAR system 100, it may be a vehicle system (e.g., part of vehicle 110), a testing system, a security system, a surveillance system, a traffic control system, an urban modelling system, or any system that monitors its surroundings. Such computing environment may include at least one processor and/or may be connected LIDAR system 100 via the cloud. In some embodiments, host 210 may also include interfaces to external devices such as camera and sensors configured to measure different characteristics of host 210 (e.g., acceleration, steering wheel deflection, reverse drive, etc.). Consistent with the present disclosure, LIDAR system 100 may be fixed to a stationary object associated with host 210 (e.g. a building, a tripod) or to a portable system associated with host 210 (e.g., a portable computer, a movie camera). Consistent with the present disclosure, LIDAR system 100 may be connected to host 210, to provide outputs of LIDAR system 100 (e.g., a 3D model, a reflectivity image) to host 210. Specifically, host 210 may use LIDAR system 100 to aid in detecting and scanning the environment of host 210 or any other environment. In addition, host 210 may integrate, synchronize or otherwise use together the outputs of LIDAR system 100 with outputs of other sensing systems (e.g. cameras, microphones, radar systems). In one example, LIDAR system 100 may be used by a security system. This embodiment is described in greater detail below with reference to FIG. 7.

LIDAR system 100 may also include a bus 212 (or other communication mechanisms) that interconnect subsystems and components for transferring information within LIDAR system 100. Optionally, bus 212 (or another communication mechanism) may be used for interconnecting LIDAR system 100 with host 210. In the example of FIG. 2A, processing unit 108 includes two processors 118 to regulate the operation of projecting unit 102, scanning unit 104, and sensing unit 106 in a coordinated manner based, at least partially, on information received from internal feedback of LIDAR system 100. In other words, processing unit 108 may be configured to dynamically operate LIDAR system 100 in a closed loop. A closed loop system is characterized by having feedback from at least one of the elements and updating one or more parameters based on the received feedback. Moreover, a closed loop system may receive feedback and update its own operation, at least partially, based on that feedback. A dynamic system or element is one that may be updated during operation.

According to some embodiments, scanning the environment around LIDAR system 100 may include illuminating field of view 120 with light pulses. The light pulses may have parameters such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. Scanning the environment around LIDAR system 100 may also include detecting and characterizing various aspects of the reflected light. Characteristics of the reflected light may include, for example: time-of-flight (i.e., time from emission until detection), instantaneous power (e.g., power signature), average power across entire return pulse, and photon distribution/signal over return pulse period. By comparing characteristics of a light pulse with characteristics of corresponding reflections, a distance and possibly a physical characteristic, such as reflected intensity of object 212 may be estimated. By repeating this process across multiple adjacent portions 122, in a predefined pattern (e.g., raster, Lissajous or other patterns) an entire scan of field of view 120 may be achieved. As discussed below in greater detail, in some situations LIDAR system 100 may direct light to only some of the portions 122 in field of view 120 at every scanning cycle. These portions may be adjacent to each other, but not necessarily so.

In another embodiment, LIDAR system 100 may include network interface 214 for communicating with host 210 (e.g., a vehicle controller). The communication between LIDAR system 100 and host 210 is represented by a dashed arrow. In one embodiment, network interface 214 may include an integrated services digital network (ISDN) card, cable modem, satellite modem, or a modem to provide a data communication connection to a corresponding type of telephone line. As another example, network interface 214 may include a local area network (LAN) card to provide a data communication connection to a compatible LAN. In another embodiment, network interface 214 may include an Ethernet port connected to radio frequency receivers and transmitters and/or optical (e.g., infrared) receivers and transmitters. The specific design and implementation of network interface 214 depends on the communications network(s) over which LIDAR system 100 and host 210 are intended to operate. For example, network interface 214 may be used, for example, to provide outputs of LIDAR system 100 to the external system, such as a 3D model, operational parameters of LIDAR system 100, and so on. In other embodiment, the communication unit may be used, for example, to receive instructions from the external system, to receive information regarding the inspected environment, to receive information from another sensor, etc.

FIG. 2B illustrates an example of a monostatic configuration of LIDAR system 100 including a plurality projecting units 102. The term “monostatic configuration” broadly refers to LIDAR system configurations in which the projected light exiting from the LIDAR system and the reflected light entering the LIDAR system pass through substantially similar optical paths. In one example, the outbound light beam and the inbound light beam may share at least one optical assembly through which both outbound and inbound light beams pass. In another example, the outbound light may pass through an optical window (not shown) and the inbound light radiation may pass through the same optical window. A monostatic configuration may include a configuration where the scanning unit 104 includes a single light deflector 114 that directs the projected light towards field of view 120 and directs the reflected light towards a sensor 116. As shown, both projected light 204 and reflected light 206 hits an asymmetrical deflector 216. The term “asymmetrical deflector” refers to any optical device having two sides capable of deflecting a beam of light hitting it from one side in a different direction than it deflects a beam of light hitting it from the second side. In one example, the asymmetrical deflector does not deflect projected light 204 and deflects reflected light 206 towards sensor 116. One example of an asymmetrical deflector may include a polarization beam splitter. In another example, asymmetrical 216 may include an optical isolator that allows the passage of light in only one direction. A diagrammatic representation of asymmetrical deflector 216 is illustrated in FIG. 2D. Consistent with the present disclosure, a monostatic configuration of LIDAR system 100 may include an asymmetrical deflector to prevent reflected light from hitting light source 112, and to direct all the reflected light toward sensor 116, thereby increasing detection sensitivity.

In the embodiment of FIG. 2B, LIDAR system 100 includes three projecting units 102 each with a single of light source 112 aimed at a common light deflector 114. In one embodiment, the plurality of light sources 112 (including two or more light sources) may project light with substantially the same wavelength and each light source 112 is generally associated with a differing area of the field of view (denoted in the figure as 120A, 120B, and 120C). This enables scanning of a broader field of view than can be achieved with a light source 112. In another embodiment, the plurality of light sources 102 may project light with differing wavelengths, and all the light sources 112 may be directed to the same portion (or overlapping portions) of field of view 120.

FIG. 2C illustrates an example of LIDAR system 100 in which projecting unit 102 includes a primary light source 112A and a secondary light source 112B. Primary light source 112A may project light with a longer wavelength than is sensitive to the human eye in order to optimize SNR and detection range. For example, primary light source 112A may project light with a wavelength between about 750 nm and 1100 nm. In contrast, secondary light source 112B may project light with a wavelength visible to the human eye. For example, secondary light source 112B may project light with a wavelength between about 400 nm and 700 nm. In one embodiment, secondary light source 112B may project light along substantially the same optical path the as light projected by primary light source 112A. Both light sources may be time-synchronized and may project light emission together or in interleaved pattern. An interleave pattern means that the light sources are not active at the same time which may mitigate mutual interference. A person who is of skill in the art would readily see that other combinations of wavelength ranges and activation schedules may also be implemented.

Consistent with some embodiments, secondary light source 112B may cause human eyes to blink when it is too close to the LIDAR optical output port. This may ensure an eye safety mechanism not feasible with typical laser sources that utilize the near-infrared light spectrum. In another embodiment, secondary light source 112B may be used for calibration and reliability at a point of service, in a manner somewhat similar to the calibration of headlights with a special reflector/pattern at a certain height from the ground with respect to vehicle 110. An operator at a point of service could examine the calibration of the LIDAR by simple visual inspection of the scanned pattern over a featured target such a test pattern board at a designated distance from LIDAR system 100. In addition, secondary light source 112B may provide means for operational confidence that the LIDAR is working for the end-user. For example, the system may be configured to permit a human to place a hand in front of light deflector 114 to test its operation.

Secondary light source 112B may also have a non-visible element that can double as a backup system in case primary light source 112A fails. This feature may be useful for fail-safe devices with elevated functional safety ratings. Given that secondary light source 112B may be visible and also due to reasons of cost and complexity, secondary light source 112B may be associated with a smaller power compared to primary light source 112A. Therefore, in case of a failure of primary light source 112A, the system functionality will fall back to secondary light source 112B set of functionalities and capabilities. While the capabilities of secondary light source 112B may be inferior to the capabilities of primary light source 112A, LIDAR system 100 system may be designed in such a fashion to enable vehicle 110 to safely arrive its destination.

FIG. 2D illustrates asymmetrical deflector 216 that may be part of LIDAR system 100. In the illustrated example, asymmetrical deflector 216 includes a reflective surface 218 (such as a mirror) and a one-way deflector 220. While not necessarily so, asymmetrical deflector 216 may optionally be a static deflector. Asymmetrical deflector 216 may be used in a monostatic configuration of LIDAR system 100, in order to allow a common optical path for transmission and for reception of light via the at least one deflector 114, e.g. as illustrated in FIGS. 2B and 2C. However, typical asymmetrical deflectors such as beam splitters are characterized by energy losses, especially in the reception path, which may be more sensitive to power loses than the transmission path.

As depicted in FIG. 2D, LIDAR system 100 may include asymmetrical deflector 216 positioned in the transmission path, which includes one-way deflector 220 for separating between the transmitted and received light signals. Optionally, one-way deflector 220 may be substantially transparent to the transmission light and substantially reflective to the received light. The transmitted light is generated by projecting unit 102 and may travel through one-way deflector 220 to scanning unit 104 which deflects it towards the optical outlet. The received light arrives through the optical inlet, to the at least one deflecting element 114, which deflects the reflections signal into a separate path away from the light source and towards sensing unit 106. Optionally, asymmetrical deflector 216 may be combined with a polarized light source 112 which is linearly polarized with the same polarization axis as one-way deflector 220. Notably, the cross-section of the outbound light beam is much smaller than that of the reflections signals. Accordingly, LIDAR system 100 may include one or more optical components (e.g. lens, collimator) for focusing or otherwise manipulating the emitted polarized light beam to the dimensions of the asymmetrical deflector 216. In one embodiment, one-way deflector 220 may be a polarizing beam splitter that is virtually transparent to the polarized light beam.

Consistent with some embodiments, LIDAR system 100 may further include optics 222 (e.g., a quarter wave plate retarder) for modifying a polarization of the emitted light. For example, optics 222 may modify a linear polarization of the emitted light beam to circular polarization. Light reflected back to system 100 from the field of view would arrive back through deflector 114 to optics 222, bearing a circular polarization with a reversed handedness with respect to the transmitted light. Optics 222 would then convert the received reversed handedness polarization light to a linear polarization that is not on the same axis as that of the polarized beam splitter 216. As noted above, the received light-patch is larger than the transmitted light-patch, due to optical dispersion of the beam traversing through the distance to the target.

Some of the received light will impinge on one-way deflector 220 that will reflect the light towards sensor 106 with some power loss. However, another part of the received patch of light will fall on a reflective surface 218 which surrounds one-way deflector 220 (e.g., polarizing beam splitter slit). Reflective surface 218 will reflect the light towards sensing unit 106 with substantially zero power loss. One-way deflector 220 would reflect light that is composed of various polarization axes and directions that will eventually arrive at the detector. Optionally, sensing unit 106 may include sensor 116 that is agnostic to the laser polarization, and is primarily sensitive to the amount of impinging photons at a certain wavelength range.

It is noted that the proposed asymmetrical deflector 216 provides far superior performances when compared to a simple mirror with a passage hole in it. In a mirror with a hole, all of the reflected light which reaches the hole is lost to the detector. However, in deflector 216, one-way deflector 220 deflects a significant portion of that light (e.g., about 50%) toward the respective sensor 116. In LIDAR systems, the number photons reaching the LIDAR from remote distances is very limited, and therefore the improvement in photon capture rate is important.

According to some embodiments, a device for beam splitting and steering is described. A polarized beam may be emitted from a light source having a first polarization. The emitted beam may be directed to pass through a polarized beam splitter assembly. The polarized beam splitter assembly includes on a first side a one-directional slit and on an opposing side a mirror. The one-directional slit enables the polarized emitted beam to travel toward a quarter-wave-plate/wave-retarder which changes the emitted signal from a polarized signal to a linear signal (or vice versa) so that subsequently reflected beams cannot travel through the one-directional slit.

FIG. 2E shows an example of a bi-static configuration of LIDAR system 100 without scanning unit 104. In order to illuminate an entire field of view (or substantially the entire field of view) without deflector 114, projecting unit 102 may optionally include an array of light sources (e.g., 112A-112F). In one embodiment, the array of light sources may include a linear array of light sources controlled by processor 118. For example, processor 118 may cause the linear array of light sources to sequentially project collimated laser beams towards first optional optical window 124A. First optional optical window 124A may include a diffuser lens for spreading the projected light and sequentially forming wide horizontal and narrow vertical beams. Optionally, some or all of the at least one light source 112 of system 100 may project light concurrently. For example, processor 118 may cause the array of light sources to simultaneously project light beams from a plurality of non-adjacent light sources 112. In the depicted example, light source 112A, light source 112D, and light source 112F simultaneously project laser beams towards first optional optical window 124A thereby illuminating the field of view with three narrow vertical beams. The light beam from fourth light source 112D may reach an object in the field of view. The light reflected from the object may be captured by second optical window 124B and may be redirected to sensor 116. The configuration depicted in FIG. 2E is considered to be a bi-static configuration because the optical paths of the projected light and the reflected light are substantially different. It is noted that projecting unit 102 may also include a plurality of light sources 112 arranged in non-linear configurations, such as a two dimensional array, in hexagonal tiling, or in any other way.

FIG. 2F illustrates an example of a monostatic configuration of LIDAR system 100 without scanning unit 104. Similar to the example embodiment represented in FIG. 2E, in order to illuminate an entire field of view without deflector 114, projecting unit 102 may include an array of light sources (e.g., 112A-112F). But, in contrast to FIG. 2E, this configuration of LIDAR system 100 may include a single optical window 124 for both the projected light and for the reflected light. Using asymmetrical deflector 216, the reflected light may be redirected to sensor 116. The configuration depicted in FIG. 2E is considered to be a monostatic configuration because the optical paths of the projected light and the reflected light are substantially similar to one another. The term “substantially similar” in the context of the optical paths of the projected light and the reflected light means that the overlap between the two optical paths may be more than 80%, more than 85%, more than 90%, or more than 95%.

FIG. 2G illustrates an example of a bi-static configuration of LIDAR system 100. The configuration of LIDAR system 100 in this figure is similar to the configuration shown in FIG. 2A. For example, both configurations include a scanning unit 104 for directing projected light in the outbound direction toward the field of view. But, in contrast to the embodiment of FIG. 2A, in this configuration, scanning unit 104 does not redirect the reflected light in the inbound direction. Instead the reflected light passes through second optical window 124B and enters sensor 116. The configuration depicted in FIG. 2G is considered to be a bi-static configuration because the optical paths of the projected light and the reflected light are substantially different from one another. The term “substantially different” in the context of the optical paths of the projected light and the reflected light means that the overlap between the two optical paths may be less than 10%, less than 5%, less than 1%, or less than 0.25%.

### The Scanning Unit

FIGS. 3A-3D depict various configurations of scanning unit 104 and its role in LIDAR system 100. Specifically, FIG. 3A is a diagram illustrating scanning unit 104 with a MEMS mirror (e.g., square shaped), FIG. 3B is a diagram illustrating another scanning unit 104 with a MEMS mirror (e.g., round shaped), FIG. 3C is a diagram illustrating scanning unit 104 with an array of reflectors used for monostatic scanning LIDAR system, and FIG. 3D is a diagram illustrating an example LIDAR system 100 that mechanically scans the environment around LIDAR system 100. One skilled in the art will appreciate that the depicted configurations of scanning unit 104 are exemplary only, and may have numerous variations and modifications within the scope of this disclosure.

FIG. 3A illustrates an example scanning unit 104 with a single axis square MEMS mirror 300. In this example MEMS mirror 300 functions as at least one deflector 114. As shown, scanning unit 104 may include one or more actuators 302 (specifically, 302A and 302B). In one embodiment, actuator 302 may be made of semiconductor (e.g., silicon) and includes a piezoelectric layer (e.g. PZT, Lead zirconate titanate, aluminum nitride), which changes its dimension in response to electric signals applied by an actuation controller, a semi conductive layer, and a base layer. In one embodiment, the physical properties of actuator 302 may determine the mechanical stresses that actuator 302 experiences when electrical current passes through it. When the piezoelectric material is activated it exerts force on actuator 302 and causes it to bend. In one embodiment, the resistivity of one or more actuators 302 may be measured in an active state (Ractive) when mirror 300 is deflected at a certain angular position and compared to the resistivity at a resting state (Rrest). Feedback including Ractive may provide information to determine the actual mirror deflection angle compared to an expected angle, and, if needed, mirror 300 deflection may be corrected. The difference between Rrest and Ractive may be correlated by a mirror drive into an angular deflection value that may serve to close the loop. This embodiment may be used for dynamic tracking of the actual mirror position and may optimize response, amplitude, deflection efficiency, and frequency for both linear mode and resonant mode MEMS mirror schemes. This embodiment is described in greater detail below with reference to FIGS. 32-34.

During scanning, current (represented in the figure as the dashed line) may flow from contact 304A to contact 304B (through actuator 302A, spring 306A, mirror 300, spring 306B, and actuator 302B). Isolation gaps in semiconducting frame 308 such as isolation gap 310 may cause actuator 302A and 302B to be two separate islands connected electrically through springs 306 and frame 308. The current flow, or any associated electrical parameter (voltage, current frequency, capacitance, relative dielectric constant, etc.), may be monitored by an associated position feedback. In case of a mechanical failure—where one of the components is damaged—the current flow through the structure would alter and change from its functional calibrated values. At an extreme situation (for example, when a spring is broken), the current would stop completely due to a circuit break in the electrical chain by means of a faulty element.

FIG. 3B illustrates another example scanning unit 104 with a dual axis round MEMS mirror 300. In this example MEMS mirror 300 functions as at least one deflector 114. In one embodiment, MEMS mirror 300 may have a diameter of between about 1 mm to about 5 mm. As shown, scanning unit 104 may include four actuators 302 (302A, 302B, 302C, and 302D) each may be at a differing length. In the illustrated example, the current (represented in the figure as the dashed line) flows from contact 304A to contact 304D, but in other cases current may flow from contact 304A to contact 304B, from contact 304A to contact 304C, from contact 304B to contact 304C, from contact 304B to contact 304D, or from contact 304C to contact 304D. Consistent with some embodiments, a dual axis MEMS mirror may be configured to deflect light in a horizontal direction and in a vertical direction. For example, the angles of deflection of a dual axis MEMS mirror may be between about 0° to 30° in the vertical direction and between about 0° to 50° in the horizontal direction. One skilled in the art will appreciate that the depicted configuration of mirror 300 may have numerous variations and modifications. In one example, at least of deflector 114 may have a dual axis square-shaped mirror or single axis round-shaped mirror. Examples of round and square mirror are depicted in FIGS. 3A and 3B as examples only. Any shape may be employed depending on system specifications. In one embodiment, actuators 302 may be incorporated as an integral part of at least of deflector 114, such that power to move MEMS mirror 300 is applied directly towards it. In addition, MEMS mirror 300 maybe connected to frame 308 by one or more rigid supporting elements. In another embodiment, at least of deflector 114 may include an electrostatic or electromagnetic MEMS mirror.

As described above, a monostatic scanning LIDAR system utilizes at least a portion of the same optical path for emitting projected light 204 and for receiving reflected light 206. The light beam in the outbound path may be collimated and focused into a narrow beam while the reflections in the return path spread into a larger patch of light, due to dispersion. In one embodiment, scanning unit 104 may have a large reflection area in the return path and asymmetrical deflector 216 that redirects the reflections (i.e., reflected light 206) to sensor 116. In one embodiment, scanning unit 104 may include a MEMS mirror with a large reflection area and negligible impact on the field of view and the frame rate performance. Additional details about the asymmetrical deflector 216 are provided below with reference to FIG. 2D.

In some embodiments (e.g. as exemplified in FIG. 3C), scanning unit 104 may include a deflector array (e.g. a reflector array) with small light deflectors (e.g. mirrors). In one embodiment, implementing light deflector 114 as a group of smaller individual light deflectors working in synchronization may allow light deflector 114 to perform at a high scan rate with larger angles of deflection. The deflector array may essentially act as a large light deflector (e.g. a large mirror) in terms of effective area. The deflector array may be operated using a shared steering assembly configuration that allows sensor 116 to collect reflected photons from substantially the same portion of field of view 120 being concurrently illuminated by light source 112. The term “concurrently” means that the two selected functions occur during coincident or overlapping time periods, either where one begins and ends during the duration of the other, or where a later one starts before the completion of the other.

FIG. 3C illustrates an example of scanning unit 104 with a reflector array 312 having small mirrors. In this embodiment, reflector array 312 functions as at least one deflector 114. Reflector array 312 may include a plurality of reflector units 314 configured to pivot (individually or together) and steer light pulses toward field of view 120. For example, reflector array 312 may be a part of an outbound path of light projected from light source 112. Specifically, reflector array 312 may direct projected light 204 towards a portion of field of view 120. Reflector array 312 may also be part of a return path for light reflected from a surface of an object located within an illumined portion of field of view 120. Specifically, reflector array 312 may direct reflected light 206 towards sensor 116 or towards asymmetrical deflector 216. In one example, the area of reflector array 312 may be between about 75 to about 150 mm², where each reflector units 314 may have a width of about 10 μm and the supporting structure may be lower than 100 μm.

According to some embodiments, reflector array 312 may include one or more sub-groups of steerable deflectors. Each sub-group of electrically steerable deflectors may include one or more deflector units, such as reflector unit 314. For example, each steerable deflector unit 314 may include at least one of a MEMS mirror, a reflective surface assembly, and an electromechanical actuator. In one embodiment, each reflector unit 314 may be individually controlled by an individual processor (not shown), such that it may tilt towards a specific angle along each of one or two separate axes. Alternatively, reflector array 312 may be associated with a common controller (e.g., processor 118) configured to synchronously manage the movement of reflector units 314 such that at least part of them will pivot concurrently and point in approximately the same direction.

In addition, at least one processor 118 may select at least one reflector unit 314 for the outbound path (referred to hereinafter as “TX Mirror”) and a group of reflector units 314 for the return path (referred to hereinafter as “RX Mirror”). Consistent with the present disclosure, increasing the number of TX Mirrors may increase a reflected photons beam spread. Additionally, decreasing the number of RX Mirrors may narrow the reception field and compensate for ambient light conditions (such as clouds, rain, fog, extreme heat, and other environmental conditions) and improve the signal to noise ratio. Also, as indicated above, the emitted light beam is typically narrower than the patch of reflected light, and therefore can be fully deflected by a small portion of the deflection array. Moreover, it is possible to block light reflected from the portion of the deflection array used for transmission (e.g. the TX mirror) from reaching sensor 116, thereby reducing an effect of internal reflections of the LIDAR system 100 on system operation. In addition, at least one processor 118 may pivot one or more reflector units 314 to overcome mechanical impairments and drifts due, for example, to thermal and gain effects. In an example, one or more reflector units 314 may move differently than intended (frequency, rate, speed etc.) and their movement may be compensated for by electrically controlling the deflectors appropriately.

FIG. 3D illustrates an exemplary LIDAR system 100 that mechanically scans the environment of LIDAR system 100. In this example, LIDAR system 100 may include a motor or other mechanisms for rotating housing 200 about the axis of the LIDAR system 100. Alternatively, the motor (or other mechanism) may mechanically rotate a rigid structure of LIDAR system 100 on which one or more light sources 112 and one or more sensors 116 are installed, thereby scanning the environment. As described above, projecting unit 102 may include at least one light source 112 configured to project light emission. The projected light emission may travel along an outbound path towards field of view 120. Specifically, the projected light emission may be reflected by deflector 114A through an exit aperture 314 when projected light 204 travel towards optional optical window 124. The reflected light emission may travel along a return path from object 208 towards sensing unit 106. For example, the reflected light 206 may be reflected by deflector 114B when reflected light 206 travels towards sensing unit 106. A person skilled in the art would appreciate that a LIDAR system with a rotation mechanism for synchronically rotating one or more light sources or one or more sensors, may use this synchronized rotation instead of (or in addition to) steering an internal light deflector.

In embodiments in which the scanning of field of view 120 is mechanical, the projected light emission may be directed to exit aperture 314 that is part of a wall 316 separating projecting unit 102 from other parts of LIDAR system 100. In some examples, wall 316 can be formed from a transparent material (e.g., glass) coated with a reflective material to form deflector 114B. In this example, exit aperture 314 may correspond to the portion of wall 316 that is not coated by the reflective material. Additionally or alternatively, exit aperture 314 may include a hole or cut-away in the wall 316. Reflected light 206 may be reflected by deflector 114B and directed towards an entrance aperture 318 of sensing unit 106. In some examples, an entrance aperture 318 may include a filtering window configured to allow wavelengths in a certain wavelength range to enter sensing unit 106 and attenuate other wavelengths. The reflections of object 208 from field of view 120 may be reflected by deflector 114B and hit sensor 116. By comparing several properties of reflected light 206 with projected light 204, at least one aspect of object 208 may be determined. For example, by comparing a time when projected light 204 was emitted by light source 112 and a time when sensor 116 received reflected light 206, a distance between object 208 and LIDAR system 100 may be determined. In some examples, other aspects of object 208, such as shape, color, material, etc. may also be determined.

In some examples, the LIDAR system 100 (or part thereof, including at least one light source 112 and at least one sensor 116) may be rotated about at least one axis to determine a three-dimensional map of the surroundings of the LIDAR system 100. For example, the LIDAR system 100 may be rotated about a substantially vertical axis as illustrated by arrow 320 in order to scan field of 120. Although FIG. 3D illustrates that the LIDAR system 100 is rotated clock-wise about the axis as illustrated by the arrow 320, additionally or alternatively, the LIDAR system 100 may be rotated in a counter clockwise direction. In some examples, the LIDAR system 100 may be rotated 360 degrees about the vertical axis. In other examples, the LIDAR system 100 may be rotated back and forth along a sector smaller than 360-degree of the LIDAR system 100. For example, the LIDAR system 100 may be mounted on a platform that wobbles back and forth about the axis without making a complete rotation.

### The Sensing Unit

FIGS. 4A-4E depict various configurations of sensing unit 106 and its role in LIDAR system 100. Specifically, FIG. 4A is a diagram illustrating an example sensing unit 106 with a detector array, FIG. 4B is a diagram illustrating monostatic scanning using a two-dimensional sensor, FIG. 4C is a diagram illustrating an example of a two-dimensional sensor 116, FIG. 4D is a diagram illustrating a lens array associated with sensor 116, and FIG. 4E includes three diagram illustrating the lens structure. One skilled in the art will appreciate that the depicted configurations of sensing unit 106 are exemplary only and may have numerous alternative variations and modifications consistent with the principles of this disclosure.

FIG. 4A illustrates an example of sensing unit 106 with detector array 400. In this example, at least one sensor 116 includes detector array 400. LIDAR system 100 is configured to detect objects (e.g., bicycle 208A and cloud 208B) in field of view 120 located at different distances from LIDAR system 100 (could be meters or more). Objects 208 may be a solid object (e.g. a road, a tree, a car, a person), fluid object (e.g. fog, water, atmosphere particles), or object of another type (e.g. dust or a powdery illuminated object). When the photons emitted from light source 112 hit object 208 they either reflect, refract, or get absorbed. Typically, as shown in the figure, only a portion of the photons reflected from object 208A enters optional optical window 124. As each ˜15 cm change in distance results in a travel time difference of 1 ns (since the photons travel at the speed of light to and from object 208), the time differences between the travel times of different photons hitting the different objects may be detectable by a time-of-flight sensor with sufficiently quick response.

Sensor 116 includes a plurality of detection elements 402 for detecting photons of a photonic pulse reflected back from field of view 120. The detection elements may all be included in detector array 400, which may have a rectangular arrangement (e.g. as shown) or any other arrangement. Detection elements 402 may operate concurrently or partially concurrently with each other. Specifically, each detection element 402 may issue detection information for every sampling duration (e.g. every 1 nanosecond). In one example, detector array 400 may be a SiPM (Silicon photomultipliers) which is a solid-state single-photon-sensitive device built from an array of single photon avalanche diode (SPAD, serving as detection elements 402) on a common silicon substrate. Similar photomultipliers from other, non-silicon materials may also be used. Although a SiPM device works in digital/switching mode, the SiPM is an analog device because all the microcells are read in parallel, making it possible to generate signals within a dynamic range from a single photon to hundreds and thousands of photons detected by the different SPADs. As mentioned above, more than one type of sensor may be implemented (e.g. SiPM and APD). Possibly, sensing unit 106 may include at least one APD integrated into an SiPM array and/or at least one APD detector located next to a SiPM on a separate or common silicon substrate.

In one embodiment, detection elements 402 may be grouped into a plurality of regions 404. The regions are geometrical locations or environments within sensor 116 (e.g. within detector array 400)—and may be shaped in different shapes (e.g. rectangular as shown, squares, rings, and so on, or in any other shape). While not all of the individual detectors, which are included within the geometrical area of a region 404, necessarily belong to that region, in most cases they will not belong to other regions 404 covering other areas of the sensor 310—unless some overlap is desired in the seams between regions. As illustrated in FIG. 4A, the regions may be non-overlapping regions 404, but alternatively, they may overlap. Every region may be associated with a regional output circuitry 406 associated with that region. The regional output circuitry 406 may provide a region output signal of a corresponding group of detection elements 402. For example, the region of output circuitry 406 may be a summing circuit, but other forms of combined output of the individual detector into a unitary output (whether scalar, vector, or any other format) may be employed. Optionally, each region 404 is a single SiPM, but this is not necessarily so, and a region may be a sub-portion of a single SiPM, a group of several SiPMs, or even a combination of different types of detectors.

In the illustrated example, processing unit 108 is located at a separated housing 200B (within or outside) host 210 (e.g. within vehicle 110), and sensing unit 106 may include a dedicated processor 408 for analyzing the reflected light. Alternatively, processing unit 108 may be used for analyzing reflected light 206. It is noted that LIDAR system 100 may be implemented multiple housings in other ways than the illustrated example. For example, light deflector 114 may be located in a different housing than projecting unit 102 and/or sensing module 106. In one embodiment, LIDAR system 100 may include multiple housings connected to each other in different ways, such as: electric wire connection, wireless connection (e.g., RF connection), fiber optics cable, and any combination of the above.

In one embodiment, analyzing reflected light 206 may include determining a time of flight for reflected light 206, based on outputs of individual detectors of different regions. Optionally, processor 408 may be configured to determine the time of flight for reflected light 206 based on the plurality of regions of output signals. In addition to the time of flight, processing unit 108 may analyze reflected light 206 to determine the average power across an entire return pulse, and the photon distribution/signal may be determined over the return pulse period (“pulse shape”). In the illustrated example, the outputs of any detection elements 402 may not be transmitted directly to processor 408, but rather combined (e.g. summed) with signals of other detectors of the region 404 before being passed to processor 408. However, this is only an example and the circuitry of sensor 116 may transmit information from a detection element 402 to processor 408 via other routes (not via a region output circuitry 406).

FIG. 4B is a diagram illustrating LIDAR system 100 configured to scan the environment of LIDAR system 100 using a two-dimensional sensor 116. In the example of FIG. 4B, sensor 116 is a matrix of 4×6 detectors 410 (also referred to as “pixels”). In one embodiment, a pixel size may be about 1×1 mm. Sensor 116 is two-dimensional in the sense that it has more than one set (e.g. row, column) of detectors 410 in two non-parallel axes (e.g. orthogonal axes, as exemplified in the illustrated examples). The number of detectors 410 in sensor 116 may vary between differing implementations, e.g. depending on the desired resolution, signal to noise ratio (SNR), desired detection distance, and so on. For example, sensor 116 may have anywhere between 5 and 5,000 pixels. In another example (not shown in the figure) Also, sensor 116 may be a one-dimensional matrix (e.g. 1×8 pixels).

It is noted that each detector 410 may include a plurality of detection elements 402, such as Avalanche Photo Diodes (APD), Single Photon Avalanche Diodes (SPADs), combination of Avalanche Photo Diodes (APD) and Single Photon Avalanche Diodes (SPADs) or detecting elements that measure both the time of flight from a laser pulse transmission event to the reception event and the intensity of the received photons. For example, each detector 410 may include anywhere between 20 and 5,000 SPADs. The outputs of detection elements 402 in each detector 410 may be summed, averaged, or otherwise combined to provide a unified pixel output.

In the illustrated example, sensing unit 106 may include a two-dimensional sensor 116 (or a plurality of two-dimensional sensors 116), whose field of view is smaller than field of view 120 of LIDAR system 100. In this discussion, field of view 120 (the overall field of view which can be scanned by LIDAR system 100 without moving, rotating or rolling in any direction) is denoted “first FOV 412”, and the smaller FOV of sensor 116 is denoted “second FOV 412” (interchangeably “instantaneous FOV”). The coverage area of second FOV 414 relative to the first FOV 412 may differ, depending on the specific use of LIDAR system 100, and may be, for example, between 0.5% and 50%. In one example, second FOV 412 may be between about 0.05° and 1° elongated in the vertical dimension. Even if LIDAR system 100 includes more than one two-dimensional sensor 116, the combined field of view of the sensors array may still be smaller than the first FOV 412, e.g. by a factor of at least 5, by a factor of at least 10, by a factor of at least 20, or by a factor of at least 50, for example.

In order to cover first FOV 412, scanning unit 106 may direct photons arriving from different parts of the environment to sensor 116 at different times. In the illustrated monostatic configuration, together with directing projected light 204 towards field of view 120 and when least one light deflector 114 is located in an instantaneous position, scanning unit 106 may also direct reflected light 206 to sensor 116. Typically, at every moment during the scanning of first FOV 412, the light beam emitted by LIDAR system 100 covers part of the environment which is larger than the second FOV 414 (in angular opening) and includes the part of the environment from which light is collected by scanning unit 104 and sensor 116.

FIG. 4C is a diagram illustrating an example of a two-dimensional sensor 116. In this embodiment, sensor 116 is a matrix of 8×5 detectors 410 and each detector 410 includes a plurality of detection elements 402. In one example, detector 410A is located in the second row (denoted “R2”) and third column (denoted “C3”) of sensor 116, which includes a matrix of 4×3 detection elements 402. In another example, detector 410B located in the fourth row (denoted “R4”) and sixth column (denoted “C6”) of sensor 116 includes a matrix of 3×3 detection elements 402. Accordingly, the number of detection elements 402 in each detector 410 may be constant, or may vary, and differing detectors 410 in a common array may have a different number of detection elements 402. The outputs of all detection elements 402 in each detector 410 may be summed, averaged, or otherwise combined to provide a single pixel-output value. It is noted that while detectors 410 in the example of FIG. 4C are arranged in a rectangular matrix (straight rows and straight columns), other arrangements may also be used, e.g. a circular arrangement or a honeycomb arrangement.

According to some embodiments, measurements from each detector 410 may enable determination of the time of flight from a light pulse emission event to the reception event and the intensity of the received photons. The reception event may be the result of the light pulse being reflected from object 208. The time of flight may be a timestamp value that represents the distance of the reflecting object to optional optical window 124. Time of flight values may be realized by photon detection and counting methods, such as Time Correlated Single Photon Counters (TCSPC), analog methods for photon detection such as signal integration and qualification (via analog to digital converters or plain comparators) or otherwise.

In some embodiments and with reference to FIG. 4B, during a scanning cycle, each instantaneous position of at least one light deflector 114 may be associated with a particular portion 122 of field of view 120. The design of sensor 116 enables an association between the reflected light from a single portion of field of view 120 and multiple detectors 410. Therefore, the scanning resolution of LIDAR system may be represented by the number of instantaneous positions (per scanning cycle) times the number of detectors 410 in sensor 116. The information from each detector 410 (i.e., each pixel) represents the basic data element that from which the captured field of view in the three-dimensional space is built. This may include, for example, the basic element of a point cloud representation, with a spatial position and an associated reflected intensity value. In one embodiment, the reflections from a single portion of field of view 120 that are detected by multiple detectors 410 may be returning from different objects located in the single portion of field of view 120. For example, the single portion of field of view 120 may be greater than 50×50 cm at the far field, which can easily include two, three, or more objects partly covered by each other.

FIG. 4D is a cross cut diagram of a part of sensor 116, in accordance with examples of the presently disclosed subject matter. The illustrated part of sensor 116 includes a part of a detector array 400 which includes four detection elements 402 (e.g., four SPADs, four APDs). Detector array 400 may be a photodetector sensor realized in complementary metal-oxide-semiconductor (CMOS). Each of the detection elements 402 has a sensitive area, which is positioned within a substrate surrounding. While not necessarily so, sensor 116 may be used in a monostatic LiDAR system having a narrow field of view (e.g., because scanning unit 104 scans different parts of the field of view at different times). The narrow field of view for the incoming light beam—if implemented—eliminates the problem of out-of-focus imaging. As exemplified in FIG. 4D, sensor 116 may include a plurality of lenses 422 (e.g., microlenses), each lens 422 may direct incident light toward a different detection element 402 (e.g., toward an active area of detection element 402), which may be usable when out-of-focus imaging is not an issue. Lenses 422 may be used for increasing an optical fill factor and sensitivity of detector array 400, because most of the light that reaches sensor 116 may be deflected toward the active areas of detection elements 402

Detector array 400, as exemplified in FIG. 4D, may include several layers built into the silicon substrate by various methods (e.g., implant) resulting in a sensitive area, contact elements to the metal layers and isolation elements (e.g., shallow trench implant STI, guard rings, optical trenches, etc.). The sensitive area may be a volumetric element in the CMOS detector that enables the optical conversion of incoming photons into a current flow given an adequate voltage bias is applied to the device. In the case of a APD/SPAD, the sensitive area would be a combination of an electrical field that pulls electrons created by photon absorption towards a multiplication area where a photon induced electron is amplified creating a breakdown avalanche of multiplied electrons.

A front side illuminated detector (e.g., as illustrated in FIG. 4D) has the input optical port at the same side as the metal layers residing on top of the semiconductor (Silicon). The metal layers are required to realize the electrical connections of each individual photodetector element (e.g., anode and cathode) with various elements such as: bias voltage, quenching/ballast elements, and other photodetectors in a common array. The optical port through which the photons impinge upon the detector sensitive area is comprised of a passage through the metal layer. It is noted that passage of light from some directions through this passage may be blocked by one or more metal layers (e.g., metal layer ML6, as illustrated for the leftmost detector elements 402 in FIG. 4D). Such blockage reduces the total optical light absorbing efficiency of the detector.

FIG. 4E illustrates three detection elements 402, each with an associated lens 422, in accordance with examples of the presenting disclosed subject matter. Each of the three detection elements of FIG. 4E, denoted 402(1), 402(2), and 402(3), illustrates a lens configuration which may be implemented in associated with one or more of the detecting elements 402 of sensor 116. It is noted that combinations of these lens configurations may also be implemented.

In the lens configuration illustrated with regards to detection element 402(1), a focal point of the associated lens 422 may be located above the semiconductor surface. Optionally, openings in different metal layers of the detection element may have different sizes aligned with the cone of focusing light generated by the associated lens 422. Such a structure may improve the signal-to-noise and resolution of the array 400 as a whole device. Large metal layers may be important for delivery of power and ground shielding. This approach may be useful, e.g., with a monostatic LiDAR design with a narrow field of view where the incoming light beam is comprised of parallel rays and the imaging focus does not have any consequence to the detected signal.

In the lens configuration illustrated with regards to detection element 402(2), an efficiency of photon detection by the detection elements 402 may be improved by identifying a sweet spot. Specifically, a photodetector implemented in CMOS may have a sweet spot in the sensitive volume area where the probability of a photon creating an avalanche effect is the highest. Therefore, a focal point of lens 422 may be positioned inside the sensitive volume area at the sweet spot location, as demonstrated by detection elements 402(2). The lens shape and distance from the focal point may take into account the refractive indices of all the elements the laser beam is passing along the way from the lens to the sensitive sweet spot location buried in the semiconductor material.

In the lens configuration illustrated with regards to the detection element on the right of FIG. 4E, an efficiency of photon absorption in the semiconductor material may be improved using a diffuser and reflective elements. Specifically, a near IR wavelength requires a significantly long path of silicon material in order to achieve a high probability of absorbing a photon that travels through. In a typical lens configuration, a photon may traverse the sensitive area and may not be absorbed into a detectable electron. A long absorption path that improves the probability for a photon to create an electron renders the size of the sensitive area towards less practical dimensions (tens of um for example) for a CMOS device fabricated with typical foundry processes. The rightmost detector element in FIG. 4E demonstrates a technique for processing incoming photons. The associated lens 422 focuses the incoming light onto a diffuser element 424. In one embodiment, light sensor 116 may further include a diffuser located in the gap distant from the outer surface of at least some of the detectors. For example, diffuser 424 may steer the light beam sideways (e.g., as perpendicular as possible) towards the sensitive area and the reflective optical trenches 426. The diffuser is located at the focal point, above the focal point, or below the focal point. In this embodiment, the incoming light may be focused on a specific location where a diffuser element is located. Optionally, detector element 422 is designed to optically avoid the inactive areas where a photon induced electron may get lost and reduce the effective detection efficiency. Reflective optical trenches 426 (or other forms of optically reflective structures) cause the photons to bounce back and forth across the sensitive area, thus increasing the likelihood of detection. Ideally, the photons will get trapped in a cavity consisting of the sensitive area and the reflective trenches indefinitely until the photon is absorbed and creates an electron/hole pair.

Consistent with the present disclosure, a long path is created for the impinging photons to be absorbed and contribute to a higher probability of detection. Optical trenches may also be implemented in detecting element 422 for reducing cross talk effects of parasitic photons created during an avalanche that may leak to other detectors and cause false detection events. According to some embodiments, a photo detector array may be optimized so that a higher yield of the received signal is utilized, meaning, that as much of the received signal is received and less of the signal is lost to internal degradation of the signal. The photo detector array may be improved by: (a) moving the focal point at a location above the semiconductor surface, optionally by designing the metal layers above the substrate appropriately; (b) by steering the focal point to the most responsive/sensitive area (or “sweet spot”) of the substrate and (c) adding a diffuser above the substrate to steer the signal toward the “sweet spot” and/or adding reflective material to the trenches so that deflected signals are reflected back to the “sweet spot.”

While in some lens configurations, lens 422 may be positioned so that its focal point is above a center of the corresponding detection element 402, it is noted that this is not necessarily so. In other lens configuration, a position of the focal point of the lens 422 with respect to a center of the corresponding detection element 402 is shifted based on a distance of the respective detection element 402 from a center of the detection array 400. This may be useful in relatively larger detection arrays 400, in which detector elements further from the center receive light in angles which are increasingly off-axis. Shifting the location of the focal points (e.g., toward the center of detection array 400) allows correcting for the incidence angles. Specifically, shifting the location of the focal points (e.g., toward the center of detection array 400) allows correcting for the incidence angles while using substantially identical lenses 422 for all detection elements, which are positioned at the same angle with respect to a surface of the detector.

Adding an array of lenses 422 to an array of detection elements 402 may be useful when using a relatively small sensor 116 which covers only a small part of the field of view because in such a case, the reflection signals from the scene reach the detectors array 400 from substantially the same angle, and it is, therefore, easy to focus all the light onto individual detectors. It is also noted, that in one embodiment, lenses 422 may be used in LIDAR system 100 for favoring about increasing the overall probability of detection of the entire array 400 (preventing photons from being “wasted” in the dead area between detectors/sub-detectors) at the expense of spatial distinctiveness. This embodiment is in contrast to prior art implementations such as CMOS RGB camera, which prioritize spatial distinctiveness (i.e., light that propagates in the direction of detection element A is not allowed to be directed by the lens toward detection element B, that is, to “bleed” to another detection element of the array). Optionally, sensor 116 includes an array of lens 422, each being correlated to a corresponding detection element 402, while at least one of the lenses 422 deflects light which propagates to a first detection element 402 toward a second detection element 402 (thereby it may increase the overall probability of detection of the entire array).

Specifically, consistent with some embodiments of the present disclosure, light sensor 116 may include an array of light detectors (e.g., detector array 400), each light detector (e.g., detector 410) being configured to cause an electric current to flow when light passes through an outer surface of a respective detector. In addition, light sensor 116 may include at least one micro-lens configured to direct light toward the array of light detectors, the at least one micro-lens having a focal point. Light sensor 116 may further include at least one layer of conductive material interposed between the at least one micro-lens and the array of light detectors and having a gap therein to permit light to pass from the at least one micro-lens to the array, the at least one layer being sized to maintain a space between the at least one micro-lens and the array to cause the focal point (e.g., the focal point may be a plane) to be located in the gap, at a location spaced from the detecting surfaces of the array of light detectors.

In related embodiments, each detector may include a plurality of Single Photon Avalanche Diodes (SPADs) or a plurality of Avalanche Photo Diodes (APD). The conductive material may be a multi-layer metal constriction, and the at least one layer of conductive material may be electrically connected to detectors in the array. In one example, the at least one layer of conductive material includes a plurality of layers. In addition, the gap may be shaped to converge from the at least one micro-lens toward the focal point, and to diverge from a region of the focal point toward the array. In other embodiments, light sensor 116 may further include at least one reflector adjacent each photo detector. In one embodiment, a plurality of micro-lenses may be arranged in a lens array and the plurality of detectors may be arranged in a detector array. In another embodiment, the plurality of micro-lenses may include a single lens configured to project light to a plurality of detectors in the array.

Referring by way of a nonlimiting example to FIGS. 2E, 2F and 2G, it is noted that the one or more sensors 116 of system 100 may receive light from a scanning deflector 114 or directly from the FOV without scanning. Even if light from the entire FOV arrives to the at least one sensor 116 at the same time, in some implementations the one or more sensors 116 may sample only parts of the FOV for detection output at any given time. For example, if the illumination of projection unit 102 illuminates different parts of the FOV at different times (whether using a deflector 114 and/or by activating different light sources 112 at different times), light may arrive at all of the pixels or sensors 116 of sensing unit 106, and only pixels/sensors which are expected to detect the LIDAR illumination may be actively collecting data for detection outputs. This way, the rest of the pixels/sensors do not unnecessarily collect ambient noise. Referring to the scanning—in the outbound or in the inbound directions—it is noted that substantially different scales of scanning may be implemented. For example, in some implementations the scanned area may cover 1‰ or 0.1‰ of the FOV, while in other implementations the scanned area may cover 10% or 25% of the FOV. All other relative portions of the FOV values may also be implemented, of course.

### The Processing Unit

FIGS. 5A-5C depict different functionalities of processing units 108 in accordance with some embodiments of the present disclosure. Specifically, FIG. 5A is a diagram illustrating emission patterns in a single frame-time for a single portion of the field of view, FIG. 5B is a diagram illustrating emission scheme in a single frame-time for the whole field of view, and. FIG. 5C is a diagram illustrating the actual light emission projected towards field of view during a single scanning cycle.

FIG. 5A illustrates four examples of emission patterns in a single frame-time for a single portion 122 of field of view 120 associated with an instantaneous position of at least one light deflector 114. Consistent with embodiments of the present disclosure, processing unit 108 may control at least one light source 112 and light deflector 114 (or coordinate the operation of at least one light source 112 and at least one light deflector 114) in a manner enabling light flux to vary over a scan of field of view 120. Consistent with other embodiments, processing unit 108 may control only at least one light source 112 and light deflector 114 may be moved or pivoted in a fixed predefined pattern.

Diagrams A-D in FIG. 5A depict the power of light emitted towards a single portion 122 of field of view 120 over time. In Diagram A, processor 118 may control the operation of light source 112 in a manner such that during scanning of field of view 120 an initial light emission is projected toward portion 122 of field of view 120. When projecting unit 102 includes a pulsed-light light source, the initial light emission may include one or more initial pulses (also referred to as “pilot pulses”). Processing unit 108 may receive from sensor 116 pilot information about reflections associated with the initial light emission. In one embodiment, the pilot information may be represented as a single signal based on the outputs of one or more detectors (e.g. one or more SPADs, one or more APDs, one or more SiPMs, etc.) or as a plurality of signals based on the outputs of multiple detectors. In one example, the pilot information may include analog and/or digital information. In another example, the pilot information may include a single value and/or a plurality of values (e.g. for different times and/or parts of the segment).

Based on information about reflections associated with the initial light emission, processing unit 108 may be configured to determine the type of subsequent light emission to be projected towards portion 122 of field of view 120. The determined subsequent light emission for the particular portion of field of view 120 may be made during the same scanning cycle (i.e., in the same frame) or in a subsequent scanning cycle (i.e., in a subsequent frame). This embodiment is described in greater detail below with reference to FIGS. 23-25.

In Diagram B, processor 118 may control the operation of light source 112 in a manner such that during scanning of field of view 120 light pulses in different intensities are projected towards a single portion 122 of field of view 120. In one embodiment, LIDAR system 100 may be operable to generate depth maps of one or more different types, such as any one or more of the following types: point cloud model, polygon mesh, depth image (holding depth information for each pixel of an image or of a 2D array), or any other type of 3D model of a scene. The sequence of depth maps may be a temporal sequence, in which different depth maps are generated at a different time. Each depth map of the sequence associated with a scanning cycle (interchangeably “frame”) may be generated within the duration of a corresponding subsequent frame-time. In one example, a typical frame-time may last less than a second. In some embodiments, LIDAR system 100 may have a fixed frame rate (e.g. 10 frames per second, 25 frames per second, 50 frames per second) or the frame rate may be dynamic. In other embodiments, the frame-times of different frames may not be identical across the sequence. For example, LIDAR system 100 may implement a 10 frames-per-second rate that includes generating a first depth map in 100 milliseconds (the average), a second frame in 92 milliseconds, a third frame at 142 milliseconds, and so on.

In Diagram C, processor 118 may control the operation of light source 112 in a manner such that during scanning of field of view 120 light pulses associated with different durations are projected towards a single portion 122 of field of view 120. In one embodiment, LIDAR system 100 may be operable to generate a different number of pulses in each frame. The number of pulses may vary between 0 to 32 pulses (e.g., 1, 5, 12, 28, or more pulses) and may be based on information derived from previous emissions. The time between light pulses may depend on desired detection range and can be between 500 ns and 5000 ns. In one example, processing unit 108 may receive from sensor 116 information about reflections associated with each light-pulse. Based on the information (or the lack of information), processing unit 108 may determine if additional light pulses are needed. It is noted that the durations of the processing times and the emission times in diagrams A-D are not in-scale. Specifically, the processing time may be substantially longer than the emission time. In diagram D, projecting unit 102 may include a continuous-wave light source. In one embodiment, the initial light emission may include a period of time where light is emitted and the subsequent emission may be a continuation of the initial emission, or there may be a discontinuity. In one embodiment, the intensity of the continuous emission may change over time.

Consistent with some embodiments of the present disclosure, the emission pattern may be determined per each portion of field of view 120. In other words, processor 118 may control the emission of light to allow differentiation in the illumination of different portions of field of view 120. In one example, processor 118 may determine the emission pattern for a single portion 122 of field of view 120, based on detection of reflected light from the same scanning cycle (e.g., the initial emission), which makes LIDAR system 100 extremely dynamic. In another example, processor 118 may determine the emission pattern for a single portion 122 of field of view 120, based on detection of reflected light from a previous scanning cycle. The differences in the patterns of the subsequent emissions may result from determining different values for light-source parameters for the subsequent emission, such as any one of the following.

a. Overall energy of the subsequent emission.
b. Energy profile of the subsequent emission.
c. A number of light-pulse-repetition per frame.
d. Light modulation characteristics such as duration, rate, peak, average power, and pulse shape.
e. Wave properties of the subsequent emission, such as polarization, wavelength, etc.

Consistent with the present disclosure, the differentiation in the subsequent emissions may be put to different uses. In one example, it is possible to limit emitted power levels in one portion of field of view 120 where safety is a consideration, while emitting higher power levels (thus improving signal-to-noise ratio and detection range) for other portions of field of view 120. This is relevant for eye safety, but may also be relevant for skin safety, safety of optical systems, safety of sensitive materials, and more. In another example, it is possible to direct more energy towards portions of field of view 120 where it will be of greater use (e.g. regions of interest, further distanced targets, low reflection targets, etc.) while limiting the lighting energy to other portions of field of view 120 based on detection results from the same frame or previous frame. It is noted that processing unit 108 may process detected signals from a single instantaneous field of view several times within a single scanning frame time; for example, subsequent emission may be determined upon after every pulse emitted, or after a number of pulses emitted.

FIG. 5B illustrates three examples of emission schemes in a single frame-time for field of view 120. Consistent with embodiments of the present disclosure, at least on processing unit 108 may use obtained information to dynamically adjust the operational mode of LIDAR system 100 and/or determine values of parameters of specific components of LIDAR system 100. The obtained information may be determined from processing data captured in field of view 120, or received (directly or indirectly) from host 210. Processing unit 108 may use the obtained information to determine a scanning scheme for scanning the different portions of field of view 120. The obtained information may include a current light condition, a current weather condition, a current driving environment of the host vehicle, a current location of the host vehicle, a current trajectory of the host vehicle, a current topography of road surrounding the host vehicle, or any other condition or object detectable through light reflection. In some embodiments, the determined scanning scheme may include at least one of the following: (a) a designation of portions within field of view 120 to be actively scanned as part of a scanning cycle, (b) a projecting plan for projecting unit 102 that defines the light emission profile at different portions of field of view 120; (c) a deflecting plan for scanning unit 104 that defines, for example, a deflection direction, frequency, and designating idle elements within a reflector array; and (d) a detection plan for sensing unit 106 that defines the detectors sensitivity or responsivity pattern.

In addition, processing unit 108 may determine the scanning scheme at least partially by obtaining an identification of at least one region of interest within the field of view 120 and at least one region of non-interest within the field of view 120. In some embodiments, processing unit 108 may determine the scanning scheme at least partially by obtaining an identification of at least one region of high interest within the field of view 120 and at least one region of lower-interest within the field of view 120. The identification of the at least one region of interest within the field of view 120 may be determined, for example, from processing data captured in field of view 120, based on data of another sensor (e.g. camera, GPS), received (directly or indirectly) from host 210, or any combination of the above. In some embodiments, the identification of at least one region of interest may include identification of portions, areas, sections, pixels, or objects within field of view 120 that are important to monitor. Examples of areas that may be identified as regions of interest may include, crosswalks, moving objects, people, nearby vehicles or any other environmental condition or object that may be helpful in vehicle navigation. Examples of areas that may be identified as regions of non-interest (or lower-interest) may be static (non-moving) far-away buildings, a skyline, an area above the horizon and objects in the field of view. Upon obtaining the identification of at least one region of interest within the field of view 120, processing unit 108 may determine the scanning scheme or change an existing scanning scheme. Further to determining or changing the light-source parameters (as described above), processing unit 108 may allocate detector resources based on the identification of the at least one region of interest. In one example, to reduce noise, processing unit 108 may activate detectors 410 where a region of interest is expected and disable detectors 410 where regions of non-interest are expected. In another example, processing unit 108 may change the detector sensitivity, e.g., increasing sensor sensitivity for long range detection where the reflected power is low.

Diagrams A-C in FIG. 5B depict examples of different scanning schemes for scanning field of view 120. Each square in field of view 120 represents a different portion 122 associated with an instantaneous position of at least one light deflector 114. Legend 500 details the level of light flux represented by the filling pattern of the squares. Diagram A depicts a first scanning scheme in which all of the portions have the same importance/priority and a default light flux is allocated to them. The first scanning scheme may be utilized in a start-up phase or periodically interleaved with another scanning scheme to monitor the whole field of view for unexpected/new objects. In one example, the light source parameters in the first scanning scheme may be configured to generate light pulses at constant amplitudes. Diagram B depicts a second scanning scheme in which a portion of field of view 120 is allocated with high light flux while the rest of field of view 120 is allocated with default light flux and low light flux. The portions of field of view 120 that are the least interesting may be allocated with low light flux. Diagram C depicts a third scanning scheme in which a compact vehicle and a bus (see silhouettes) are identified in field of view 120. In this scanning scheme, the edges of the vehicle and bus may be tracked with high power and the central mass of the vehicle and bus may be allocated with less light flux (or no light flux). Such light flux allocation enables concentration of more of the optical budget on the edges of the identified objects and less on their center which have less importance.

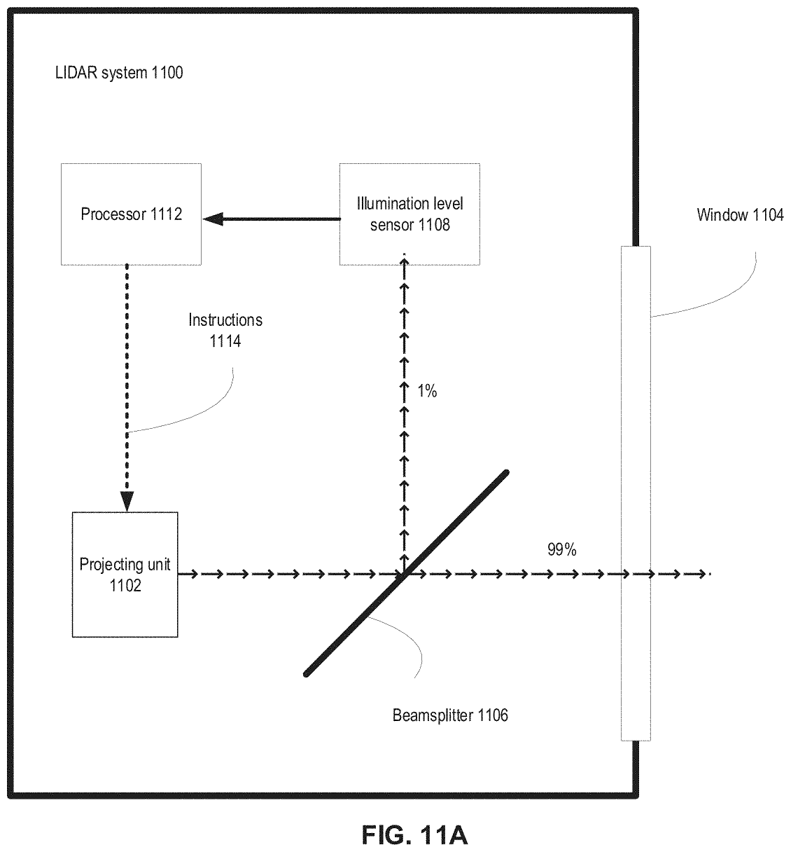

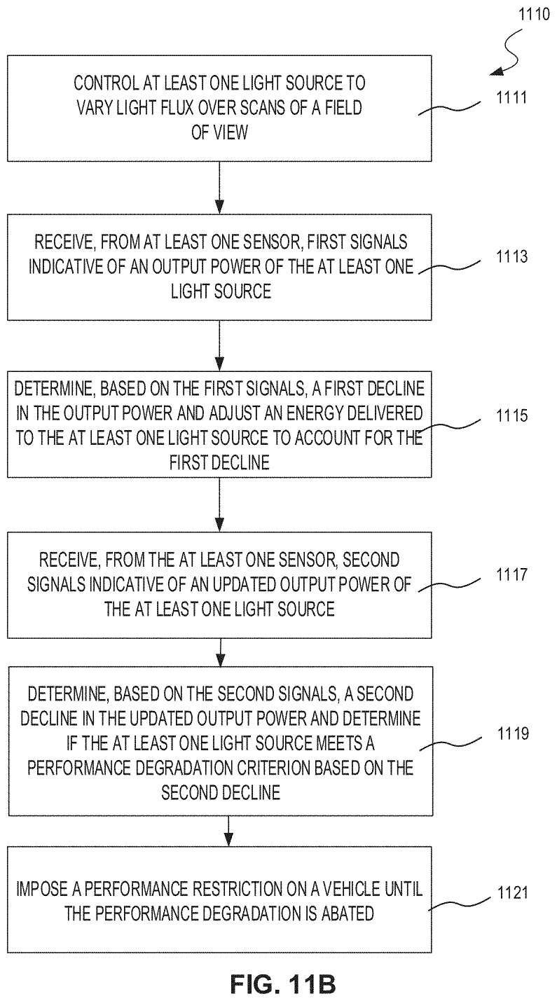

FIG. 5C illustrating the emission of light towards field of view 120 during a single scanning cycle. In the depicted example, field of view 120 is represented by an 8×9 matrix, where each of the 72 cells corresponds to a separate portion 122 associated with a different instantaneous position of at least one light deflector 114. In this exemplary scanning cycle, each portion includes one or more white dots that represent the number of light pulses projected toward that portion, and some portions include black dots that represent reflected light from that portion detected by sensor 116. As shown, field of view 120 is divided into three sectors: sector I on the right side of field of view 120, sector II in the middle of field of view 120, and sector III on the left side of field of view 120. In this exemplary scanning cycle, sector I was initially allocated with a single light pulse per portion; sector II, previously identified as a region of interest, was initially allocated with three light pulses per portion; and sector III was initially allocated with two light pulses per portion. Also as shown, scanning of field of view 120 reveals four objects 208: two free-form objects in the near field (e.g., between 5 and 50 meters), a rounded-square object in the mid field (e.g., between 50 and 150 meters), and a triangle object in the far field (e.g., between 150 and 500 meters). While the discussion of FIG. 5C uses number of pulses as an example of light flux allocation, it is noted that light flux allocation to different parts of the field of view may also be implemented in other ways such as: pulse duration, pulse angular dispersion, wavelength, instantaneous power, photon density at different distances from light source 112, average power, pulse power intensity, pulse width, pulse repetition rate, pulse sequence, pulse duty cycle, wavelength, phase, polarization, and more. The illustration of the light emission as a single scanning cycle in FIG. 5C demonstrates different capabilities of LIDAR system 100. In a first embodiment, processor 118 is configured to use two light pulses to detect a first object (e.g., the rounded-square object) at a first distance, and to use three light pulses to detect a second object (e.g., the triangle object) at a second distance greater than the first distance. This embodiment is described in greater detail below with reference to FIGS. 11-13. In a second embodiment, processor 118 is configured to allocate more light to portions of the field of view where a region of interest is identified. Specifically, in the present example, sector II was identified as a region of interest and accordingly it was allocated with three light pulses while the rest of field of view 120 was allocated with two or less light pulses. This embodiment is described in greater detail below with reference to FIGS. 20-22. In a third embodiment, processor 118 is configured to control light source 112 in a manner such that only a single light pulse is projected toward to portions B1, B2, and Cl in FIG. 5C, although they are part of sector III that was initially allocated with two light pulses per portion. This occurs because the processing unit 108 detected an object in the near field based on the first light pulse. This embodiment is described in greater detail below with reference to FIGS. 23-25. Allocation of less than maximal amount of pulses may also be a result of other considerations. For examples, in at least some regions, detection of object at a first distance (e.g. a near field object) may result in reducing an overall amount of light emitted to this portion of field of view 120. This embodiment is described in greater detail below with reference to FIGS. 14-16. Other reasons to for determining power allocation to different portions is discussed below with respect to FIGS. 29-31, FIGS. 53-55, and FIGS. 50-52.

Additional details and examples on different components of LIDAR system 100 and their associated functionalities are included in Applicant's U.S. patent application Ser. No. 15/391,916 filed Dec. 28, 2016; Applicant's U.S. patent application Ser. No. 15/393,749 filed Dec. 29, 2016; Applicant's U.S. patent application Ser. No. 15/393,285 filed Dec. 29, 2016; and Applicant's U.S. patent application Ser. No. 15/393,593 filed Dec. 29, 2016, which are incorporated herein by reference in their entirety.

### Example Implementation: Vehicle

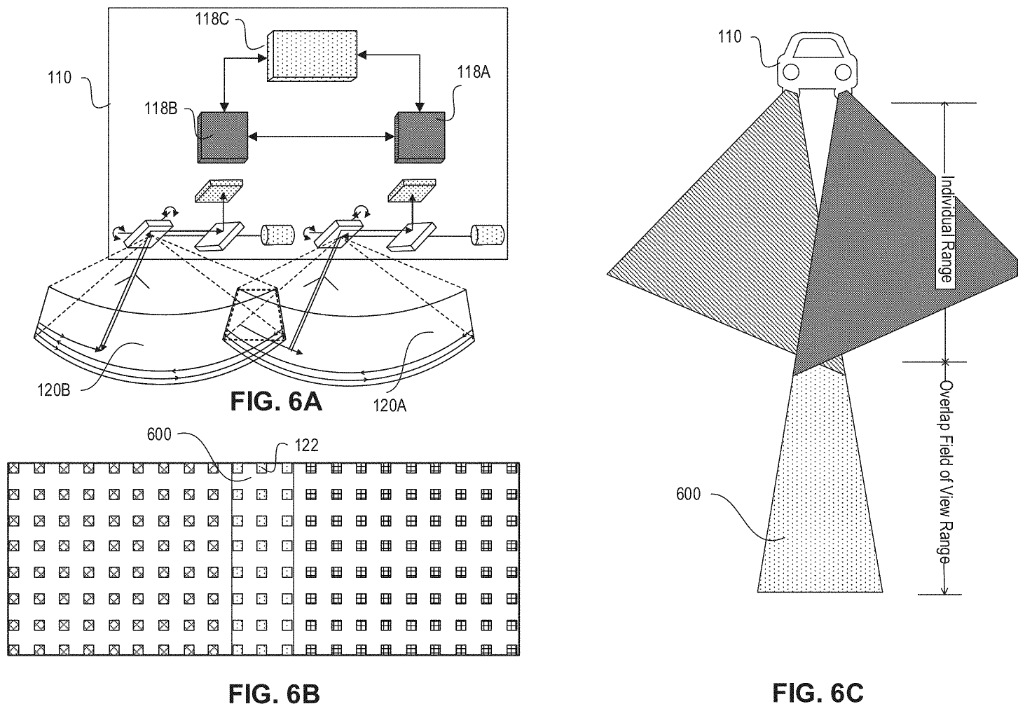

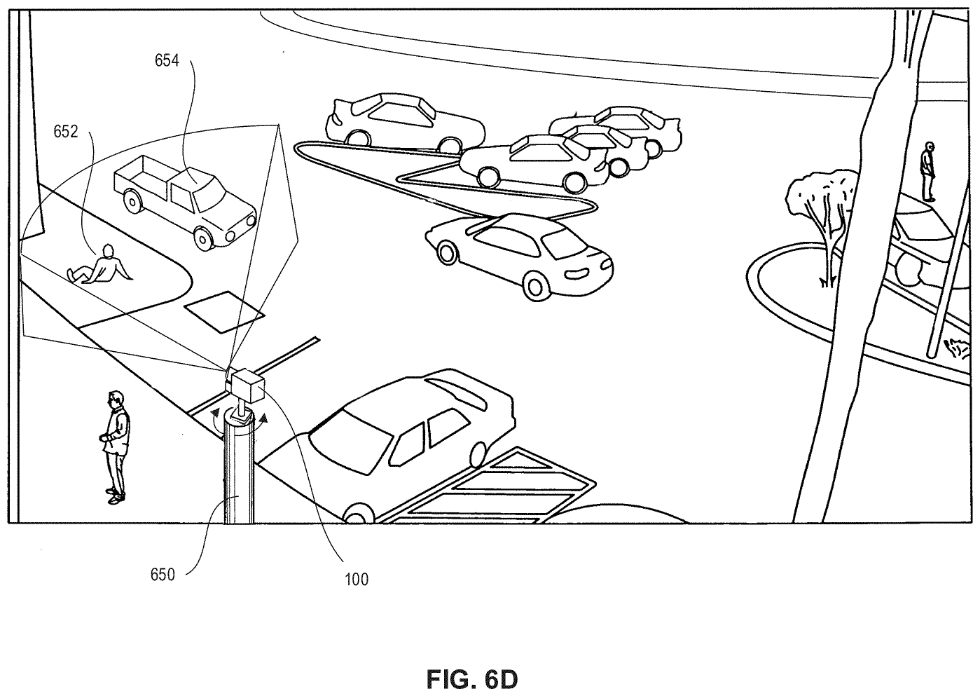

FIGS. 6A-6C illustrate the implementation of LIDAR system 100 in a vehicle (e.g., vehicle 110). Any of the aspects of LIDAR system 100 described above or below may be incorporated into vehicle 110 to provide a range-sensing vehicle. Specifically, in this example, LIDAR system 100 integrates multiple scanning units 104 and potentially multiple projecting units 102 in a single vehicle. In one embodiment, a vehicle may take advantage of such a LIDAR system to improve power, range and accuracy in the overlap zone and beyond it, as well as redundancy in sensitive parts of the FOV (e.g. the forward movement direction of the vehicle). As shown in FIG. 6A, vehicle 110 may include a first processor 118A for controlling the scanning of field of view 120A, a second processor 118B for controlling the scanning of field of view 120B, and a third processor 118C for controlling synchronization of scanning the two fields of view. In one example, processor 118C may be the vehicle controller and may have a shared interface between first processor 118A and second processor 118B. The shared interface may enable an exchanging of data at intermediate processing levels and a synchronization of scanning of the combined field of view in order to form an overlap in the temporal and/or spatial space. In one embodiment, the data exchanged using the shared interface may be: (a) time of flight of received signals associated with pixels in the overlapped field of view and/or in its vicinity; (b) laser steering position status; (c) detection status of objects in the field of view.

FIG. 6B illustrates overlap region 600 between field of view 120A and field of view 120B. In the depicted example, the overlap region is associated with 24 portions 122 from field of view 120A and 24 portions 122 from field of view 120B. Given that the overlap region is defined and known by processors 118A and 118B, each processor may be designed to limit the amount of light emitted in overlap region 600 in order to conform with an eye safety limit that spans multiple source lights, or for other reasons such as maintaining an optical budget. In addition, processors 118A and 118B may avoid interferences between the light emitted by the two light sources by loose synchronization between the scanning unit 104A and scanning unit 104B, and/or by control of the laser transmission timing, and/or the detection circuit enabling timing.

FIG. 6C illustrates how overlap region 600 between field of view 120A and field of view 120B may be used to increase the detection distance of vehicle 110. Consistent with the present disclosure, two or more light sources 112 projecting their nominal light emission into the overlap zone may be leveraged to increase the effective detection range. The term “detection range” may include an approximate distance from vehicle 110 at which LIDAR system 100 can clearly detect an object. In one embodiment, the maximum detection range of LIDAR system 100 is about 300 meters, about 400 meters, or about 500 meters. For example, for a detection range of 200 meters, LIDAR system 100 may detect an object located 200 meters (or less) from vehicle 110 at more than 95%, more than 99%, more than 99.5% of the times. Even when the object's reflectivity may be less than 50% (e.g., less than 20%, less than 10%, or less than 5%). In addition, LIDAR system 100 may have less than 1% false alarm rate. In one embodiment, light from projected from two light sources that are collocated in the temporal and spatial space can be utilized to improve SNR and therefore increase the range and/or quality of service for an object located in the overlap region. Processor 118C may extract high-level information from the reflected light in field of view 120A and 120B. The term “extracting information” may include any process by which information associated with objects, individuals, locations, events, etc., is identified in the captured image data by any means known to those of ordinary skill in the art. In addition, processors 118A and 118B may share the high-level information, such as objects (road delimiters, background, pedestrians, vehicles, etc.), and motion vectors, to enable each processor to become alert to the peripheral regions about to become regions of interest. For example, a moving object in field of view 120A may be determined to soon be entering field of view 120B.

### Example Implementation: Surveillance System

FIG. 6D illustrates the implementation of LIDAR system 100 in a surveillance system. As mentioned above, LIDAR system 100 may be fixed to a stationary object 650 that may include a motor or other mechanisms for rotating the housing of the LIDAR system 100 to obtain a wider field of view. Alternatively, the surveillance system may include a plurality of LIDAR units. In the example depicted in FIG. 6D, the surveillance system may use a single rotatable LIDAR system 100 to obtain 3D data representing field of view 120 and to process the 3D data to detect people 652, vehicles 654, changes in the environment, or any other form of security-significant data.

Consistent with some embodiment of the present disclosure, the 3D data may be analyzed to monitor retail business processes. In one embodiment, the 3D data may be used in retail business processes involving physical security (e.g., detection of: an intrusion within a retail facility, an act of vandalism within or around a retail facility, unauthorized access to a secure area, and suspicious behavior around cars in a parking lot). In another embodiment, the 3D data may be used in public safety (e.g., detection of: people slipping and falling on store property, a dangerous liquid spill or obstruction on a store floor, an assault or abduction in a store parking lot, an obstruction of a fire exit, and crowding in a store area or outside of the store). In another embodiment, the 3D data may be used for business intelligence data gathering (e.g., tracking of people through store areas to determine, for example, how many people go through, where they dwell, how long they dwell, how their shopping habits compare to their purchasing habits).

Consistent with other embodiments of the present disclosure, the 3D data may be analyzed and used for traffic enforcement. Specifically, the 3D data may be used to identify vehicles traveling over the legal speed limit or some other road legal requirement. In one example, LIDAR system 100 may be used to detect vehicles that cross a stop line or designated stopping place while a red traffic light is showing. In another example, LIDAR system 100 may be used to identify vehicles traveling in lanes reserved for public transportation. In yet another example, LIDAR system 100 may be used to identify vehicles turning in intersections where specific turns are prohibited on red.

### Monitoring and Detecting Degradation of Detectors

Monitoring and calibration of detection elements (also referred to as “detectors”) of LIDAR systems is important to ensure accurate operation of the LIDAR and the safety of people and objects around the LIDAR. Many conventional calibration techniques are cumbersome and require static, or at least predetermined, fields of view. Moreover, monitoring often focuses on detecting electrical anomalies such as short-circuits rather than both minor degradations along with major failures.

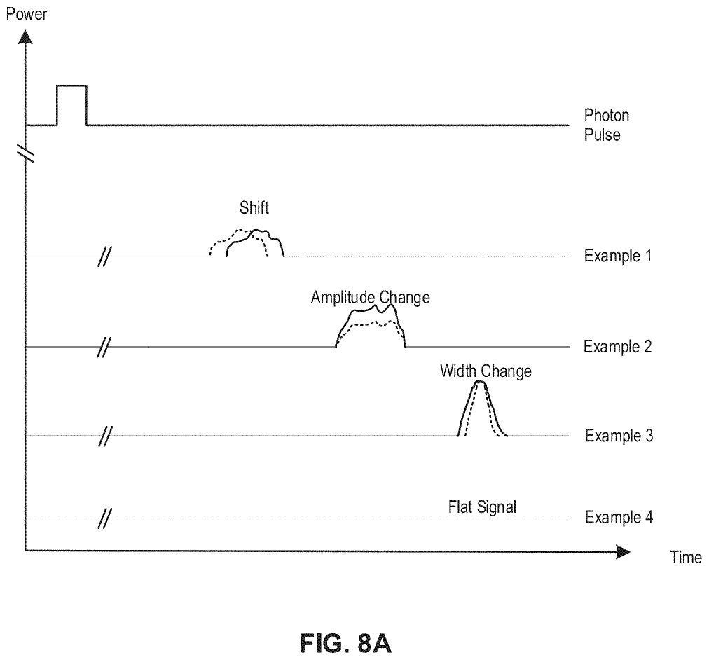

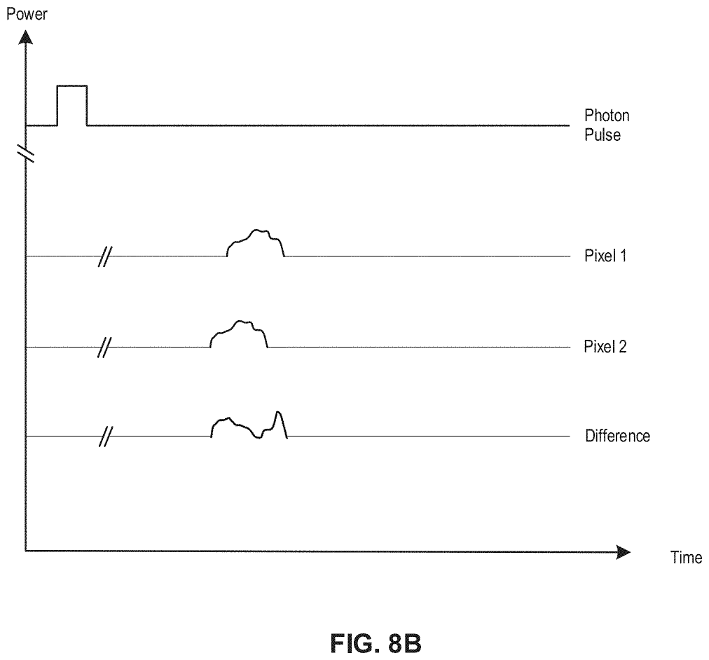

Accordingly, some embodiments of the present disclosure may use an internal light source configured for testing and calibrating detectors of a LIDAR system. Additionally or alternatively, internal reflections from a main light source of the LIDAR system may be used for testing and calibrating detectors. Accordingly, in some embodiments, processing unit 108 may control at least one light source 112 and receive from a group of detectors (e.g., of sensing unit 106) a first plurality of input signals. The first plurality of input signals may be associated with light projected by the at least one light source 112 and reflected from an object external to the LIDAR system. Moreover, as described with respect to LIDAR system 100, processing unit 108 may determine, based on the first plurality of input signals, a distance to the object. Processing unit 108 may further receive from the group of detectors a second plurality of input signals. The second plurality of input signals are associated with light projected internal to the LIDAR system by the at least one light source and impinging on the group of detectors at a time when external light reflections are not expected. For example, processing unit 108 may receive and process the second plurality of input signals between captured frames of a field of view including the object. As explained further below, the second plurality of input signals may be caused by an internal light source separate from a light source projecting into the field of view and/or by internal reflections caused by the at least one light source. Then, based on the second plurality of input signals, processing unit 108 may determine that there is performance degradation in at least one detector of the group of detectors. Techniques for determining the performance degradation are discussed below with respect to FIGS. 8A and 8B. Processing unit 108 may, in response to the determined performance degradation, initiate a remedial action, such as adjusting one or more parameters associated with the detectors and/or the at least one light source, disabling the LIDAR system or one or more components of the LIDAR system, or the like. Accordingly, embodiments of the present disclosure may provide greater safety by detecting sensor degradations and failures and initiating remedial action before damage is done to objects and people in the environment of the LIDAR.

### Internal Light Source

Some embodiments of the present disclosure may use an internal light source configured for testing and calibrating detectors of a LIDAR system. Unlike many previous systems, such calibration may be performed without relying on stationary or other test environments. Moreover, if used in combination with stationary or other test environments, calibrations may be more accurate than in previous systems.

Additionally or alternatively, the monitoring the LIDAR system using the internal light source may be executed during use of the LIDAR system for detection and ranging of objects in its FOV. Accordingly, problems may be detected during use rather than during testing and calibration with stationary or other test environments. Moreover, minor degradations, examples of which are depicted in FIG. 8A and described below, may be detected and remediated before the LIDAR system experiences a more dangerous error or malfunction.

FIG. 7A is a diagram illustrating an exemplary LIDAR system with an internal light source 710. LIDAR system 700 of FIG. 7A may be LIDAR system 100 of FIG. 1A, but this is not necessarily so. Any one or more of the components of LIDAR system 700 may be the same or equivalent to the respective (e.g., similarly named) component of LIDAR system 100 of FIG. 1A, but this is not necessarily so.

LIDAR system 700 may include an illumination path, e.g., similar to projecting unit 102. The illumination path may include at least one light source 706 with a controller 704. Controller 704 may command the at least one light source 706. Moreover, although not depicted in FIG. 7A, controller 704 may command one or more components of the scanning unit (e.g., any variation discussed above of scanning unit 104). In some embodiments, any functions discussed with respect to controller 704 may be performed by a processor (e.g., by processor 702, as depicted in FIG. 7B described below). Additionally or alternatively, controller 704 may be implemented as part of processor 702 or, more generally, as part of processing unit 108.

LIDAR system 700 may further include a scanning unit, e.g., similar to scanning unit 104. The scanning unit may include one or more deflectors along the illumination path and/or one or more deflectors along a detection path (not shown in FIG. 7A for simplicity). Any one or more types of deflectors may be used, such as but not limited to: mirrors, lenses, beam splitters, prisms, or the like, for directing light from light source 706 and reflections toward sensor 712 and/or to direct light from light source 706 and to direct reflections toward sensor 712. LIDAR system 700 may further include the detection path, e.g., similar to sensing unit 106. The detection path may include at least one sensor 712. Sensor 712 may include a plurality of detection elements (also referred to as “detectors”), as depicted in FIG. 7A.

In some embodiments, each element may comprise a pixel of sensor 712. In other embodiments, each element may comprise a sub-unit of a pixel (e.g., one or more photodiodes of a larger photodiode array forming the pixel) or a be larger than a pixel (e.g., a plurality of pixels grouped together spatially and/or electrically). As explained above, each pixel may include a plurality of detection elements, such as Avalanche Photo Diodes (APD), Single Photon Avalanche Diodes (SPADs), combination of Avalanche Photo Diodes (APD) and Single Photon Avalanche Diodes (SPADs), or other detecting elements that measure both the time of flight from a laser pulse transmission event to the reception event and the intensity of the received photons. The outputs of the detection elements in each pixel may be summed, averaged, or otherwise combined to provide a unified pixel output. Accordingly, a “pixel” may refer to a particular portion of output from sensor 712, such as a point in a point cloud. However, some embodiments may use binning or other techniques to combine.

As depicted in FIG. 7A, light source 706 may emit one or more light beams (or groups of light beams), e.g., toward a field of view. For example, one or more deflectors in the scanning unit may direct the one or more light beams toward portions of the field of view. The projected beams may reflect off objects, road markings, or the like in the field of view (e.g., the tree depicted in FIG. 7A), causing corresponding one or more reflected light beams (or groups of light beams) to travel back towards the LIDAR system.

As depicted in FIG. 7A, each detector (e.g., detectors 708a, 708b, 708c, 708d, 708e, and 7080 of sensor 712 may use a corresponding detection signal path (e.g., paths 714a, 714b, 714c, 714d, 714e, and 7140 to transmit signals caused by the reflected light beams to processor 702 (e.g., similar to processing unit 108). Accordingly, processor 702 may control at least one light source 706 and receive from a group of detectors a first plurality of input signals, the first plurality of input signals being associated with light projected by the at least one light source 706 and reflected from an object external to the LIDAR system. Although processor 702 is depicted as the same processor transferring commands through controller 704, a different processor may process signals from sensor 712.

In some embodiments, the detection path may include the detectors (e.g., SPADs, SiPMs, APDs) connected to additional components such as an amplifier, a multiplexer, or any other circuitry configured to adjust properties of the signals and/or combine signals from different detection elements (e.g., to aggregate signals from multiple elements forming part of the same pixel). The detection path may further include an analog-to-digital converter (ADC), a time-to-digital converter (TDC), or any other circuitry configured to covert signals from the detection elements (whether analog or time-based or the like) into digital signals for use by processor 702. Any additional circuitry elements, such as arbiters or the like, may form part of the detection paths. Similarly, all of the parts described above may be considered optional depending on the configuration of sensor 712 and its readout path to processor 702.

In addition to receiving reflections caused by light source 706, sensor 712 may also be operable to receive light from internal light source 710. For example, LIDAR system 700 may be configured such that internal light source 710 projects, at least in part, toward sensor 712. As used herein, a light source may be referred to as “internal” if inside the same housing as sensor 712 or if the light source is configured to project toward sensor 712 without reflecting off an object in the field of view. A light source may still be “internal” even if it projects light that is refracted, reflected, or otherwise modified before being received at sensor 712. Light from an internal light source reaches sensor 712 in an optical path which is different than light which is arriving from the FOV.

Internal light source 710 may comprise a light emitting diode (whether a conventional LED or an organic LED), a laser, or any other apparatus configured to generate and emit light beams. In some embodiments, the internal light source 710 may have one or more wavelengths different from one or more wavelengths of the at least one light source 706. For example, the sensor 712 may be configured to differentiate wavelength(s) of the internal light source 710 from wavelength(s) of the at least one light source 706. The differentiation may be performed in hardware (e.g., by adjusting parameters of the detection elements) and/or in software (e.g., by filtering out signals from other wavelengths). Additionally or alternatively, an optical filter may block other wavelengths from transmitting to sensor 712. For example, an optical filter may be incorporated into a path from light source 706 to the field of view and/or a path from the field of view to sensor 712 to filter all but wavelengths associated with at least one light source 706. Processor 702 may then differentiate wavelengths originating from internal light source 710 because they may comprise wavelengths that would be otherwise blocked by the optical filter.

Internal light source 710 may be configured for different types of illumination. For example, internal light source 710 may emit pulsed light, continuous light, or the like. Additionally or alternatively, internal light source 710 may emit pulses or continuous bursts with different durations, pulses or continuous bursts with different amplitudes or wavelengths, or pulses or continuous bursts that encode symbols (e.g., time codes or the like). The illumination scheme (e.g., continuous wave in comparison to pulsed lights) of internal light source 710 may be similar to that of light source 706, but this is not necessarily so.

Internal light source 710 may be configured to emit light having amplitudes above amplitudes of noise levels detected by sensor 712 but lower than saturation levels of sensor 712. Accordingly, internal light source 710 may be controlled to adjust amplitudes higher or lower depending on a current level of noise detected by sensor 712 but while subject to a saturation threshold. The saturation threshold may be predetermined based on the hardware of sensor 712 or may be dynamic depending on sensitivity settings of sensor 712 and/or environmental factors such as temperature or the like.

Moreover, illumination from internal light source 710 may be adjusted (e.g., in any of the ways described above) to compensate for one or more environmental factors such as temperature or the like. For example, internal light source 710 may generate higher amplitudes, longer pulses, shorter wavelengths, or the like in response to lower temperatures, which may decrease the sensitivity of the detection elements. Additionally or alternatively, illumination from internal light source 710 may be adjusted (e.g., in any of the ways described above) to compensate for one or more sensor conditions such as sensitivity settings or the like. For example, internal light source 710 may generate higher amplitudes, longer pulses, shorter wavelengths, or the like in response to hardware settings of the detection elements that reduce sensitivity. Additionally or alternatively, settings of sensor 712 (such as sensitivity levels) may be adjusted to compensate for one or more conditions of internal light source 710 such as power levels or the like. For example, sensor 712 may increase sensitivity or the like in response to settings of the internal light source 710 that reduce power output.

Although depicted as a single source in FIG. 7A, other embodiments may use multiple light sources. For example, one internal light source per detector 708a, 708b, 708c, 708d, 708e, and 708f, one internal light source per a subgroup of multiple detectors, one internal light source per pixel, one internal light source per other subgroup of components of sensor 712, one internal light source per scanning pattern (as described below), or the like may be used.

In some embodiments, an optical filter may be used to filter some of the light from the internal light source 710 in addition to or in lieu of an optical filter used in a path from light source 706 to the field of view and/or a path from the field of view to sensor 712, as described above. Accordingly, the optical filter may reduce amplitudes, filter unwanted wavelengths, or otherwise alter the light projected from internal light source 710 before the light is received at sensor 712.

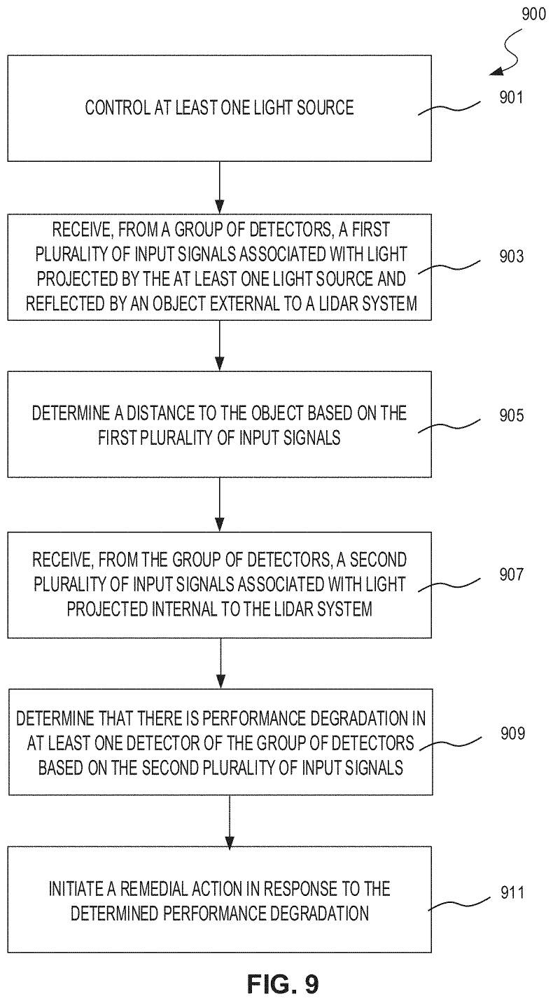

Signals from internal light source 710 may be used to detect performance degradation of sensor 712 or portions thereof. For example, processor 702 (e.g., similar to processing unit 108) may receive from the group of detectors a second plurality of input signals, the second plurality of input signals being associated with light projected internal to the LIDAR system by the at least one light source (in this example, projected by internal light source 710) and impinging on the group of detectors at a time when external light reflections are not expected; determine based on the second plurality of input signals that there is performance degradation in at least one detector of the group of detectors; and initiate a remedial action in response to the determined performance degradation. Accordingly, processor 702 may execute method 900 of FIG. 9, explained below (and any variation of method 900 discussed below, mutatis mutandis), to detect performance degradation of the LIDAR system, and especially of the LIDAR system detection paths. Additionally or alternatively, signals from internal light source may be used for calibration or other parameter adjustment for sensor 712 or portions thereof, e.g., as explained below with respect to FIG. 9.

### Internal Light Reflections

In some LIDAR systems (e.g., low-power LIDAR systems), adding an additional internal light source as described above may be impractical or at least not preferable. Accordingly, in some embodiments, sensor calibration and/or monitoring of one or more components may be detected using internal reflections from the existing light source(s) of the LIDAR system (e.g., one or more light sources 112 of LIDAR system 100). Moreover, some embodiments may use both internal reflections of at least one main light source and one or more dedicated internal light sources. The at least one main light source may comprise the light source(s) configured to project light towards a field of view associated with the LIDAR system.

FIG. 7B is a diagram illustrating an exemplary LIDAR system using internal reflections from a light source consistent with disclosed embodiments. LIDAR system 750 of FIG. 7B may be LIDAR system 100 of FIG. 1A, but this is not necessarily so. Any one or more of the components of LIDAR system 750 may be the same or equivalent to the respective (e.g., similarly named) component of LIDAR system 100 of FIG. 1A, but this is not necessarily so.

As depicted in FIG. 7B, processor 702 may command the at least one light source 706. Moreover, although not depicted in FIG. 7B, processor 702 may command one or more components of the scanning unit (e.g., any variation discussed above of scanning unit 104). In some embodiments, any functions discussed with respect to processor 702 may be performed by a controller (e.g., by controller 704, as depicted in FIG. 7A described above). Additionally or alternatively, the controller may be implemented as part of processor 702 or, more generally, as part of processing unit 108.

LIDAR system 750 is similar to LIDAR system 700 of FIG. 7A such that one or more of the components of LIDAR system 750 may be the same or equivalent to the respective (e.g., similarly named) component of LIDAR system 700 of FIG. 7A, but this is not necessarily so. For example, processor 702 may control at least one light source 706 and receive from a group of detectors a first plurality of input signals, the first plurality of input signals being associated with light projected by the at least one light source 706 and reflected from an object external to the LIDAR system.

In LIDAR system 750, in addition to receiving reflections caused by light source 706, sensor 712 may also be configured to receive internal reflections (labeled “internal reflection” in FIG. 7B) from deflector 758a. As used herein, reflections may be referred to as “internal” if originating from the same light source that projects light toward the field of view but the light travels only inside the same housing as sensor 712 or if the light travels toward sensor 712 without reflecting off an object in the field of view. Light may still be “internal” even if it is refracted, reflected, or otherwise modified before being received at sensor 712. Internal reflections reach sensor 712 in an optical path which is different than light which is arriving from the FOV even though internal light originates from the same light source 706.

In some embodiments, an optical filter may block certain wavelengths emitted by light source 706 from transmitting to sensor 712. For example, an optical filter may be incorporated along a path from light source 706 to the field of view and/or a path from the field of view to sensor 712 to filter one or more desired wavelengths from the total number of wavelengths emitted by at least one light source 706. Processor 702 may then differentiate wavelengths originating from internal reflections because they may comprise wavelengths that would be otherwise blocked by the optical filter.

Illumination from light source 706 may be adjusted (e.g., in any of the ways described above) to compensate for one or more environmental factors such as temperature or the like. For example, light source 706 may generate higher amplitudes, longer pulses, shorter wavelengths, or the like in response to lower temperatures, which may decrease the sensitivity of the detection elements (and thus render the internal reflections harder to detect with accuracy). Additionally or alternatively, illumination from light source 706 may be adjusted (e.g., in any of the ways described above) to compensate for one or more sensor conditions such as sensitivity settings or the like. For example, light source 706 may generate higher amplitudes, longer pulses, shorter wavelengths, or the like in response to hardware settings of the detection elements that reduce sensitivity (and thus render the internal reflections light less distinguishable from other noise). Additionally or alternatively, settings of sensor 712 (such as sensitivity levels) may be adjusted to compensate for one or more conditions of light source 706 such as power levels or the like. For example, sensor 712 may increase sensitivity or the like in response to settings of the light source 706 that reduce power output (and thus reduce the amplitude of any internal reflections).

In some embodiments, an optical filter may be used to filter some of the internal reflections in addition to or in lieu of an optical filter used along a path from light source 706 to the field of view and/or a path from the field of view to sensor 712, as described above. Accordingly, the optical filter may reduce amplitudes, filter unwanted wavelengths, or otherwise alter the internal reflections before received at sensor 712.

Signals from internal reflections may be used to detect performance degradation of sensor 712 or portions thereof. For example, processor 702 (e.g., similar to processing unit 108) may receive from the group of detectors a second plurality of input signals, the second plurality of input signals being associated with light projected internal to the LIDAR system by the at least one light source (in this example, internal reflections) and impinging on the group of detectors at a time when external light reflections are not expected; determine based on the second plurality of input signals that there is performance degradation in at least one detector of the group of detectors; and initiate a remedial action in response to the determined performance degradation. Accordingly, processor 702 may execute method 900 of FIG. 9, explained below (and any variation of method 900 discussed below), to detect performance degradation. Additionally or alternatively, signals caused by the internal reflections may be used for calibration or other parameter adjustment for sensor 712 or portions thereof, e.g., as explained below with respect to FIG. 9.

### Detecting Degradation

LIDAR systems with internal light sources (such as LIDAR system 700 of FIG. 7A) and/or using internal reflections (such as LIDAR system 750 of FIG. 7B) may detect performance degradation in detectors and/or other detection path components. As discussed in greater detail below, a variety of processing techniques may be used on the signals caused by the internal light source(s) and/or the parasitic reflections to determine whether degradation is present. As used herein, a “degradation” may refer to any change in hardware or software that affects how a detection element transforms impinging light into an electrical signal. A “degradation” may also refer to a change that was not caused by a controller action (e.g., was an unintentional change to the detection element).

FIG. 8A is a diagram illustrating different signal changes indicative of performance degradation consistent with disclosed embodiments. Example 1 of FIG. 8A includes a shift in the signal over time due to degradation of the element generating the signal. Example 2 of FIG. 8A includes a change in amplitude in the signal over time due to degradation of the element generating the signal. Example 3 of FIG. 8A includes a change in width in the signal over time due to degradation of the element generating the signal. Other changes in the signal not shown in FIG. 8A may additionally be indicative of degradation. For example, a signal generated by the element may warp unevenly, e.g., such that different portions of the signal undergo different width and/or amplitude changes. Moreover, signals may exhibit combinations of alterations due to degradation (e.g., shifting in time as well as amplitude and/or width changes, or the like).

The first three changes depicted in FIG. 8A are relatively minor and therefore indicative of a minor degradation rather than an overt failure of a detection element. However, the final change (Example 4) depicted in FIG. 8A depicts an overt failure (e.g., a disconnect, an electrical short-circuit, or the like). Embodiments of the present disclosure may detect both minor degradations and overt failures or the like.

Changes in the behavior of the detection path may be detected in different ways. For example, the behavior of any one or more detection paths may be monitored over time for detection of deterioration. In another way, the behavior of a detection path may be compared to a reference response (“expected response”). Another option is to compare the behavior of different detection path to one another. Use of one or more such comparison techniques is discussed with respect to FIG. 8B. Other techniques of using the response of the detection paths to internal illumination for detection of deterioration may also be used. For example, if a signal indicative of failure is received (e.g., Example 4 rather than Examples 1-3), the system may saturate an output from the internal light source 710 and/or saturate an internal reflection from light source 706 to confirm an overt failure of one or more detectors (and/or components of corresponding detection signal path(s)).

FIG. 8B is a diagram illustrating an example comparison of signals at different detectors to identify performance degradation consistent with disclosed embodiments. As shown in FIG. 8B, signals at one detector (or detection path) may be directly compared with signals at another detector (or detection path, respectively). For example, the comparison may yield a signal representing the difference between the signals. Other types of comparisons and corresponding output signals may also be used. Accordingly, degradation at one detector (or detection path, respectively) may be determined by measuring the comparison output signal (e.g., by determining an integral of the difference signal, determining a total energy of the difference signal, determining a width of the difference signal, or the like).

Although shown as a direct comparison in FIG. 8B, other comparisons may be used. For example, the signal from each detector may be compared to an average across other detectors or all other detectors. In another example, the signal from each detector may be compared with a template of an expected signal. In such embodiments, the template may be adjusted based on one or more factors, such as environmental factors (e.g., temperature or the like), light source parameters (e.g., power supplied to the light source or the internal light source, or the like), deflector parameters (e.g., angle of the deflector or refraction index of the deflector, which may affect properties of parasitic light reflections, or the like), or the like. In yet another example, the signal from each detector may be compared to signals from other detectors to generate a plurality of difference signals. Accordingly, degradation may be determined based on the plurality of difference signals rather than a single one.

Any of the comparisons described above may be implemented in hardware and/or software. For example, comparators may be incorporated into detection signal paths to compare the signals to signals from other detectors (or to multiplexed signals from other detectors or to template signals from a storage device). Additionally or alternatively, processor 702 may perform the comparison on the digital signals.

In any of the embodiments described above, the signal may be compared to an adjusted signal from one or more other detectors and/or an adjusted template. For example, positioning of a detection element in sensor 712 may affect how light from the internal light source and/or parasitic reflections are received. For example, position of the detection element may change an angle at which the light impinges, a distance the light travels (and thus reduces in amplitude) or the like. Accordingly, the signals may be adjusted before comparison to compensate for these differences.

FIG. 9 is a flowchart of a method for identifying performance degradation in a LIDAR detector consistent with disclosed embodiments. For example, method 900 may be implemented by at least one processor of a LIDAR system (e.g., at least one processor 118 of LIDAR system 100 of FIG. 1A, processor 702 of LIDAR systems 700 or 750 of FIG. 7A or 7B, respectively) and/or by at least one processor within a body of a vehicle (e.g., processor 408 of housing 200B of vehicle 110). Additionally with or alternatively to at least one processor, at least one controller (e.g., controller 704 of LIDAR system 700 of FIG. 7A) may execute one or more steps of method 900. Accordingly, controller 704 may cooperate with processor 702 to execute method 900.

In some embodiments, method 900 may be implemented by a vehicle. For example, the vehicle may comprise at least one housing (e.g., mounted on a roof of the vehicle, a hood of the vehicle, a bumper of the vehicle, or the like) and at least one LIDAR system (e.g., LIDAR system 100, LIDAR system 700, LIDAR system 750, or the like) mounted in the at least one housing. As explained above, the LIDAR system may comprise at least one light source 112 or 706 configured to project light toward an environment of the vehicle (e.g., FOV 120); a group of detectors 116 or 708a, 708b, 708c, 708d, 708e, and 708f; and at least one mirror (e.g., deflector 114) configured to direct the projected light toward portions of the environment and to direct reflections from objects in the environment toward the group of detectors.

At step 901, the at least one processor may control at least one light source (e.g., light source 706 and/or 710 of LIDAR systems 700 or 750 of FIG. 7A or 7B, respectively). For example, while not necessarily so, the at least one processor may control the at least one LIDAR light source in a manner enabling light flux to vary over a plurality of scans of a field of view. For example, the at least one processor may vary the timing of pulses from the at least one light source. Alternatively or concurrently, the at least one processor may vary the length of pulses from the at least one light source. By way of further example, the at least one processor may alternatively or concurrently vary a size (e.g., length or width or otherwise alter a cross-sectional area) of pulses from the at least one light source. In a yet further example, the at least one processor may alternatively or concurrently vary the amplitude and/or frequency of pulses from the at least one light source. In certain aspects, the at least one processor may vary the light flux during a single scan and/or across a plurality of scans. Additionally or alternatively, the at least one processor may vary the light flux across a plurality of regions in the field of view (e.g., during a scan and/or across a plurality of scans).

In some embodiments, method 900 may further include controlling at least one light deflector (e.g., deflector 114 or the like) to deflect light from the at least one light source such that during a single scanning cycle the at least one light deflector instantaneously assumes a plurality of instantaneous positions. In one example, the at least one processor may coordinate the at least one light deflector and the at least one light source such that when the at least one light deflector assumes a particular instantaneous position, a portion of a light beam is deflected by the at least one light deflector from the at least one light source towards an object in the field of view, and reflections of the portion of the light beam from the object are deflected by the at least one light deflector toward at least one sensor. In another example, the at least one light source may comprise a plurality of lights sources aimed at the at least one light deflector, and the at least one processor may control the at least one light deflector such that when the at least one light deflector assumes a particular instantaneous position, light from the plurality of light sources is projected towards a plurality of independent regions in the field of view.

In other embodiments, method 900 may be performed without varying the light flux of the at least one light source. For example, method 900 may be performed with a LIDAR system that is fixed-power rather than variable-power. Additionally or alternatively, the LIDAR system may illuminate a scene without scanning.

The at least one light source may include a first light source 706 for projecting light externally relative to the LIDAR system and a second light source 710, other than the first light source 706, for projecting light internally towards the group of detectors, e.g., as depicted in FIG. 7A. Accordingly, the at least one processor may control an internal-directed light source other than the at least one light source. Alternatively, the at least one light source may include only one or more sources for projecting light external to the LIDAR system, e.g., as depicted in FIG. 7B.

At step 903, the at least one processor may receive, from a group of detectors (e.g., in sensor 712 of LIDAR systems 700 or 750 of FIG. 7A or 7B, respectively), a first plurality of input signals. The first plurality of input signals may be associated with light projected by the at least one light source and reflected from an object external to the LIDAR system. In some embodiments, as described above, each detector may include a plurality of Single Photon Avalanche Diodes (SPADs) or at least one Avalanche Photo Diode (APD). Other types of detectors may also be used, such as PIN diode or any type of photodetector.

At step 905, the at least one processor may determine, based on the first plurality of input signals, a distance to the object. For example, the at least one processor may use time-of-flight, triangulation, or any other calculation based on the first plurality of input signals to determine the distance.

Step 905 may include direct identification of the object, but this is not necessarily so. For example, the at least one processor may determine distances associated with the field of view based on signals from the reflections without identifying objects or explicitly associating the calculated distances with objects. Any techniques described with respect to LIDAR system 100 may be used in step 905.

At step 907, the at least one processor may receive, from the group of detectors, a second plurality of input signals. The second plurality of input signals may be associated with light projected internal to the LIDAR system by the at least one light source and impinging on the group of detectors at a time when external light reflections are not expected. For example, the second plurality of input signals may be generated during space between frames, the frames capturing portions of the field of view. In some embodiments, the second plurality of input signals may be caused by light from internal light source 710, as depicted in FIG. 7A, and/or from internal reflections, as depicted in FIG. 7B. Thus, the second plurality of input signals may be associated with light projected from a same light source used to cause reflections from the object external to the LIDAR system or with light projected from a different light source.

At step 909, the at least one processor may determine, based on the second plurality of input signals, that there is performance degradation in at least one detector of the group of detectors. For example, any of the comparisons described above with respect to FIG. 8B may be used to determine the performance degradation. Accordingly, determining that there is a performance degradation of at least one of the group of detectors may include comparing the second plurality of input signals with data indicative of expected performance. Additionally or alternatively, determining that there is a performance degradation of at least one of the group of detectors may include comparing at least one input signal out of the second plurality of input signals with at least one other input signal out of the second plurality of input signals (or comparing at least one property of at least one input signal out of the second plurality of input signals with the at least one property of at least one other input signal out of the second plurality of input signals).

The differences resulting from the comparison may be subject to one or more thresholds to determine the performance degradation. For example, the integral of the difference signal, the total energy of the difference signal, the width of the difference signal, the peak amplitude of the difference signal, or the like may be compared against a degradation threshold. Additionally or alternatively, a plurality of difference signals may be combined before comparison to the threshold and/or a majority (or plurality comprising a threshold number) of the difference signals may be required to exceed the threshold before a performance degradation is determined. The degradation threshold may be static or dynamic. For example, the at least one processor may increase or decrease the degradation threshold in response to environment factors, deflector parameters, parameters of the at least one light source, or the like.

At step 911, the at least one processor may initiate one or more remedial actions in response to the determined performance degradation. For example, the remedial action may include modifying at least one sensitivity setting of the at least one of the group of detectors. In such embodiments, the at least one sensitivity setting may include a voltage supply to the at least one of the group of detectors or any other hardware or software modification to increase or decrease sensitivity of the at least one detector. For example, a reduced amplitude indicative of degradation may trigger the at least one processor to increase the sensitivity setting.

Additionally or alternatively, the remedial action may include modifying an illumination scheme of the at least one light source. For example, modifying the illumination scheme may include at least one of stopping light emission of the at least one light source, altering an illumination level of the at least one light source, or changing a number of pulses per pixel of the group of detectors. Any other flux or scanning modification as described above with respect to step 901 may be included in the remedial action.

Additionally or alternatively, the remedial action may include sending a message to a host in response to determining that there is a performance degradation. For example, the host may comprise a server, a host vehicle, or other device to which the LIDAR system is connected and sends, for example, status updates. Accordingly, the at least one processor may send the message using one or more computer networks.

Additionally or alternatively, the remedial action may include preventing a vehicle from initiating one or more autonomous driving operations or may include causing a vehicle to initiate one or more remedial autonomous driving operations. For example, the at least one processor may prevent the vehicle from turning the vehicle into traffic or exceeding a particular speed or the like. As another example, the remedial autonomous driving operation may include at least one of stopping the vehicle or pulling the vehicle over to a side of a road.

Additionally or alternatively, the remedial action may include changing a scanning pattern of the at least one light source, at least one mirror directing the projected light toward a scene including the object external to the LIDAR system, or a combination thereof. For example, the at least one processor may cause any of the flux or energy modifications described in step 901 above. Additionally or alternatively, the at least one processor may modify how the at least one deflector (e.g., mirror or the like) scans the field of view, as described above with respect to step 901. For example, changing the scanning pattern may include increasing at least one dimension of a scanning path (e.g., adding scanning lines or rows, activating additional pixels along a line or row, or the like).

Although described with reference to performance degradation, the internal light source and/or internal light reflections may be used to calibration or parameter adjustment in addition with or in lieu of degradation detection. For example, the step 911 may include adjusting one or more settings (e.g., a sensitivity setting) of one or more detectors of the group of detectors to reduce difference signals. Additionally or alternatively, the step 911 may include adjusting settings (e.g., amplitudes, pulse times, or the like) of the at least one light source to reduce power of the projected light (and thus, for example, increase safety to pedestrians) or to increase power of the projected light (and thus, for example, increase a signal-to-noise ratio at the group of detectors) or the like.

Moreover, as explained above with respect to FIG. 8A, method 900 may additionally or alternatively be used to detect an overt failure of one or more components of the system. For example, the performance degradation detected in step 909 may comprise an electric short-circuit or the like. Accordingly, the remedial action may comprise deactivation of the failed detectors (or other components of a corresponding detection signal path) and/or deactivation of the entire LIDAR system. The severity of the failure (e.g., the number of detectors that failed) may determine whether all or a portion of the LIDAR system is deactivated.

### Detecting and Modifying LIDAR Systems Based on Deflector Behavior

In scanning LIDAR systems (e.g., LIDAR system 100), faults in the operation of the scanning unit (e.g., scanning unit 104 and especially of at least one light deflector 114 thereof) may render the LIDAR system inoperable or at least sub-optimally operable. Moreover, a failure of the scanning unit may result in danger or harm to the platform on which the LIDAR system is installed and/or to people, animals and objects in its environment. For example, failure of the scanning unit may result in any one or more of: failure to detect objects in the field of view, wrong detection of objects in the field of view (e.g., calculating that objects are located in different directions than they actually are), emission of light in unintended direction, extended emission of light to the same direction for prolonged periods of time (e.g., if a steering mirror or other deflector hardware is stuck), or the like.

Accordingly, in some embodiments, a processor (e.g., processor 118) of the LIDAR system may be configured to determine whether an actual performance of one or more of the at least one light deflector (e.g., scanning mirror, lens, or the like) deviates from an expected performance. Moreover, the processor may initiate one or more remedial actions if a deviation is detected.

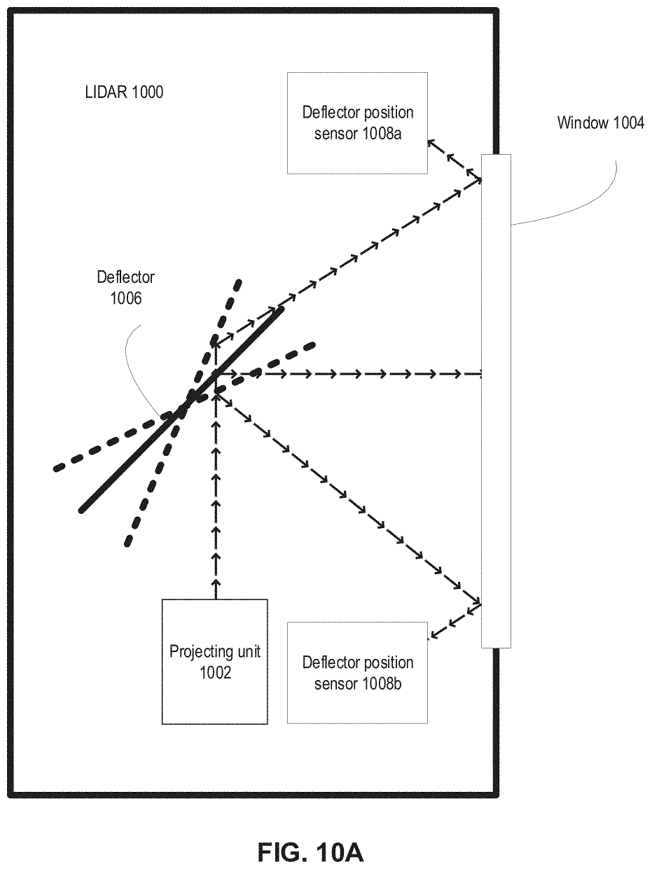

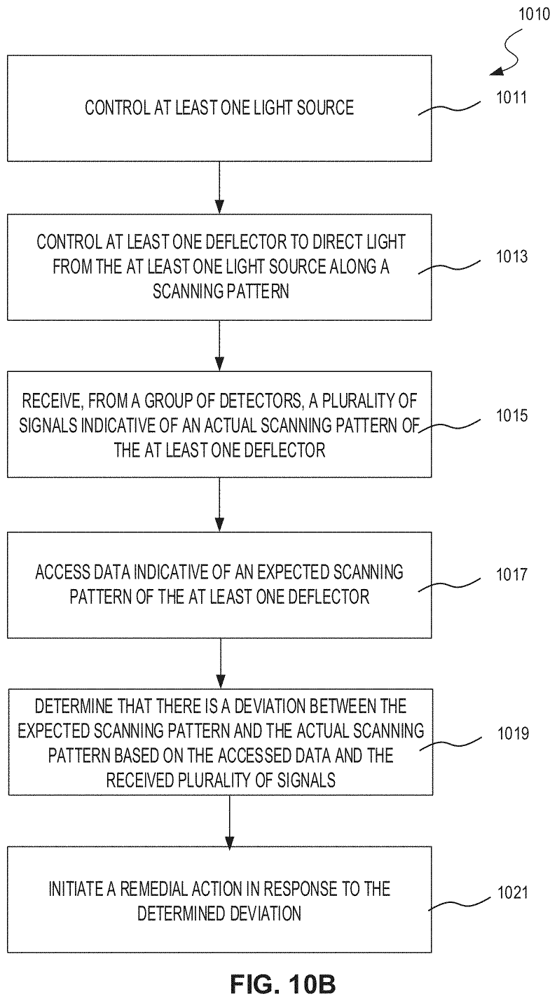

FIG. 10A is a diagram illustrating an exemplary LIDAR system with a deflector position sensor consistent with disclosed embodiments. LIDAR system 1000 of FIG. 10A may be LIDAR system 100 of FIG. 1A, but this is not necessarily so. Any one or more of the components of LIDAR system 1000 may be the same or equivalent to the respective (e.g., similarly named) component of LIDAR system 100 of FIG. 1A, but this is not necessarily so.

LIDAR system 1000 includes one or more sensors, e.g., sensor 1008a and sensor 1008b, which may be operable to detect internal reflection of the LIDAR illumination (used for detection of objects in the FOV). Accordingly, sensors 1008a and 1008b may detect internal reflections, whether from deflector 1006 or, as depicted in FIG. 10A, from window 1004. In the example of FIG. 10A, the LIDAR illumination is reflected from the window (or other optical component such as a prism) 1004 through which light from one or more of the at least one light deflector 1006 passes. For example, window 1004 may be an external window of the LIDAR system 1000, or a window of a sealed compartment within LIDAR system 1000 (or any other scanning electrooptical system). The at least one deflector 1006 may be a scanning mirror (e.g., MEMS or otherwise), or any other type of scanner (e.g. an optical phase array (OPA)). The LIDAR illumination may be emitted by projecting unit 1002, which may include one or more light sources. FIG. 10A illustrates the deflector 1006 in different instantiates positions (one using continuous line and two using dashed lines in the example of FIG. 10A) of the deflector, to illustrate scanning of the at least one light deflector 1006 (e.g., as explained above with respect to step 901 of FIG. 9).

Each of the one or more sensors 1008a and 1008b may be operable to detect internal reflections indicative of impinging of light on (and possibly passing of light through) at least one location of the window 1004, e.g., along a scanning of the at least one deflector 1006. In the illustrated example, the two sensors 1008a and 1008b detect when light reaches opposing sides of the scanned field of view.

A processor (not shown in FIG. 10A) may receive signals caused by the internal reflections of the scanned light and generated by the one or more sensors 1008a and 1008b and may determine an operational status of the one or more light deflectors 1006 based thereon. For example, the processor may determine that the scanning of light deflector 1006 (e.g., mirror, lens, or the like) reaches both ends of its scanning pattern in the expected frequency, and therefore that the one or more light deflectors 1006 is fully operational. The same or similar sensor(s) 1008a and 1008b may also be used to detect problems with the window, prism, or other optical component through which LIDAR projection passes.

In some implementations, portions of an actual scanning pattern of deflector 1006 may be sampled in addition to or instead of some locations which are not part of the actual scanning pattern but which are nevertheless indicative that the actual scanning pattern differs from the expected scanning pattern.

FIG. 10B is a flowchart of a method for detecting scanning deviations in a LIDAR deflector consistent with disclosed embodiments. For example, method 1010 may be implemented by at least one processor of a LIDAR system (e.g., at least one processor 118 of LIDAR system 100 of FIG. 1A, a processor of LIDAR system 1000 of FIG. 10A, or the like) and/or by at least one processor within a body of a vehicle (e.g., processor 408 of housing 200B of vehicle 110).

In some embodiments, method 1010 may be implemented by a vehicle. For example, the vehicle may comprise at least one housing (e.g., mounted on a roof of the vehicle, a hood of the vehicle, a bumper of the vehicle, or the like) and at least one LIDAR system (e.g., LIDAR system 100, LIDAR system 1000, or the like) mounted in the at least one housing. As explained above, the LIDAR system may comprise at least one light source (e.g., of projecting unit 102 or 1002) configured to project light toward an environment of the vehicle (e.g., toward FOV 120); a group of detectors 116; and at least one mirror (e.g., deflector 114 or 1006) configured to direct the projected light toward portions of the environment and to direct reflections from objects in the environment toward the group of detectors.

At step 1011, the processor may control light emission of at least one light source (e.g., light sources(s) 112). Light projected from the at least one light source may be directed to at least one deflector (e.g., deflector 114 of FIG. 1A, deflector 1006 of FIG. 10A, or the like) for scanning a field of view (e.g., field of view 120).

At step 1013, the processor may control positioning of the at least one light deflector to deflect light from the at least one light source along a scanning pattern to scan the field of view. For example, as explained above with respect to step 901 of FIG. 9, the processor may control the at least one light deflector (e.g., deflector 1006 of FIG. 10A or the like) to deflect light from the at least one light source such that during a single scanning cycle the at least one light deflector instantaneously assumes a plurality of instantaneous positions.

At step 1015, the processor may receive signals from at least one sensor (e.g., sensor 1008a and/or sensor 1008b of FIG. 10A) configured to measure positions of the at least one light deflector. The received signals may be indicative of an actual scanning pattern of the at least one deflector. Additionally, for example, the received signals may be received from a group or plurality of deflectors.

The one or more sensors which measure the positions (e.g., instantaneous positions, as describe above) of the at least one light deflector may measure the position of the at least one light deflector directly (e.g., by measuring the position of a scanning mirror or configuration of a lens), indirectly (e.g., by measuring the direction of the light deflected by the at least one deflector or reflections of that light), or a combination of both. In embodiments where the deflector comprises a MEMS mirror, a Fresnel lens, or any other electrically implemented optical component, the sensor may determine the positions by measuring input(s) to and/or output(s) from the electronic components comprising the optical component(s).

Additionally or alternatively, the at least one sensor used for the detection of the signals indicative of the position of the at least one deflector may include one or more sensors (e.g., sensors 116). This may be achieved, for example, by using a sensing array which includes a 2D array of detectors (e.g., pixels or the like) and, based upon the detectors, identify the reflections of the light emission of the light source, thereby determining in which direction the at least one deflector was emitting light.

Additionally or alternatively, the at least one sensor used for the detection of the signals indicative of the position of the at least one deflector may include one or more sensors other than the sensors used for the LIDAR detection of objects in the field of view. Several nonlimiting examples of sensors which may be used for determining the position of the at least one deflector are described in PCT application no. PCT/IB2017/001320, filed Sep. 20, 2017, which is expressly incorporated herein by reference. For example, the at least one sensor whose detection signals are indicative of the position of the at least one deflector may include one or more of: a sensor configured to detect reflections of an additional light source (e.g., internal light source 710 of FIG. 7A or the like), a variable capacitor configured to detect capacitance changes caused by movement of the at least one light deflector, a plurality of dummy piezoelectric elements configured to generate electric current when the at least one light deflector moves, a sensor configured to measure dielectric coefficient changes of actuators that move the at least one light deflector, or the like.

The scanning pattern may include data indicative of any one or more of: orientations of the at least one light deflector relative to a resting plane of the at least one light deflector, locations of the at least one light deflector relative to the resting plane, a scanning frequency of the at least one light deflector, displacements of the at least one light deflector relative to the resting plane, or the like.

At step 1017, the processor may access data indicative of an expected scanning pattern of the at least one deflector. Such data may be stored on volatile or involatile memory, may be produced by the at least one processor or received from a component external to it, or the like. For example, the processor may copy any commands sent to the at least one deflector and/or may access the stored commands from a database.

The data indicative of the expected scanning pattern may be indicative of the entire expected scanning pattern (e.g., the expected instantaneous position of the at least one deflector at each moment in time) or of one or more portions of the expected scanning pattern (e.g., times in which the scanning patterns should reach a finite number of points in the pattern). Optionally, during a scanning cycle, the expected scanning pattern may include an identification of multiple expected positions of the at least one light deflector. The expected positions may include, for example, at least one of locations and orientations.

In some embodiments, the expected scanning pattern may be the same for many consecutive scanning cycles of the LIDAR system, but may also change between consecutive scanning cycles. Accordingly, the at least one processor may be further configured to access data indicative of an expected scanning pattern that is specific to each scanning cycle. Additionally or alternatively, the at least one processor may be further configured to access data indicative of an expected scanning pattern that is identical to a plurality of scanning cycles. The expected scanning pattern may be continuous (e.g., comprising a raster scan) or may be non-continuous (e.g., using an optical phased array which can emit light in random-access fashion toward different directions).

At step 1019, the processor may use the accessed data and the received signals to determine that there is a deviation between the expected scanning pattern and the actual scanning pattern. For example, the deviation may comprise a different in location and/or orientation at one or more times. The deviation may be compared to one or thresholds, e.g., against thresholds for magnitude in location or orientation deviations, against thresholds for timing deviations (e.g., being in a location too early or an orientation too late or the like).

At step 1021, the processor may initiate a remedial action in response to the determined deviation. For example, the at least one processor may initiate, in response to the determined deviation, any combination of any one or more of: modifying scanning instructions to the at least one deflector (e.g., increasing—or otherwise modifying—the driving force to the at least one deflector or any other modifications described above in method 900), sending a message to a host (e.g., as described above in method 900), modifying a lighting emission scheme by the at least one light source (e.g., decreasing emission level, stopping light emission of the light source, changing emission timings, changing number of pulses per pixel, or any other modifications described above in method 900), preventing the vehicle (e.g., on which the LIDAR system is installed) from initiating one or more autonomous driving operations (e.g., as described above in method 900), causing the vehicle to initiate a remedial autonomous driving operation (e.g., stopping the vehicle, getting down to the side of the road, or any other operation described above in method 900), modifying at least one sensitivity setting of the at least one of the group of detectors (e.g., voltage supply to the at least one of the group of detectors or any other modification described above in method 900), or the like. For example, if the sensor is a focal plane array in which only relevant pixels are activated for each instantaneous position of the at least one deflector, the modification may comprise changing the scanning pattern of the sensor to match the actual scanning pattern of the at least one deflector.

With respect to any one of the one or more remedial actions taken by the at least one processor, the at least one processor may be further configured to determine that a deviation from the expected scanning pattern (or a modified expected scanning pattern) still exists after executing the one or more remedial actions, and to initiate a one or more additional remedial action thereafter (whether the same one or more remedial actions—e.g., using different parameters—or another combination of one or more remedial actions).

In some embodiments, the at least one processor may be configured to select the one or more remedial action to initiate in response to the determined deviation based on determined parameters of the deviations (e.g., the type of deviation, the severity of deviation, the duration of the deviation, or the like). Moreover, the at least one processor may determine that no remedial action should be initiated even when a deviation is detected. For example, the at least one processor may be configured to initiate the remedial action only after determining that the deviation is above a predetermined threshold, as explained above. Alternatively, the threshold may be dynamic, e.g., as explained with respect to FIG. 9.

### Restricting Performance in Response to Light Source Degradation

Degradation of at least one light source of a LIDAR system (e.g., laser diodes of LIDAR system 100) caused, for example, by diode aging or malfunction, may lower the detection distance of the LIDAR system and/or the ability of the LIDAR system to detect objects with low reflectivity. Once a degradation of the at least one light source (in contrast to temporary decrease of performances) is confirmed, the LIDAR system may report the condition to the vehicle controller, which can use the information to impose performance restrictions until the problem is abated (e.g., by servicing of the LIDAR system, by adjusting of settings of the sensor or light source or the like).

FIG. 11A is a diagram illustrating an exemplary LIDAR system with an illumination level sensor consistent with disclosed embodiments. LIDAR system 1100 of FIG. 11A may be LIDAR system 100, but this is not necessarily so. Any one or more of the components of LIDAR system 1100 may be the same or equivalent to the respective (e.g., similarly named) component of LIDAR system 100, but this is not necessarily so.

As depicted in FIG. 11A, a beam-splitter 1106 (or an equivalent optical assembly) may deflect some of the light of projecting unit 1002 towards a dedicated internal illumination level sensor 1108. The light may be reflected from a window 1104 (or other optical component such as a prism) through which light from the beam-splitter 1106 (or an equivalent optical assembly) passes. Window 1104 may be similar to or the same as window 1004, discussed above. In the illustrated example, approximately 1% of the light is directed towards the at least one sensor 1108, but this is just an example, and other portions may very well be used. The outputs of the one or more illumination level sensors 1108 are provided to at least one processor 1112, which controls light source 1112 as well as other components of LIDAR system 1100, as discussed above. Processor 1112 may, for example, transmit instructions 1114 to projecting unit 1102 in order to control projecting unit 1102. In some embodiments, a different processor may receive signals from sensor 1108 and process them accordingly.

FIG. 11B is a flowchart of a method for detecting illumination level changes consistent with disclosed embodiments. For example, method 1110 may be implemented by at least one processor of a LIDAR system (e.g., at least one processor 118 of LIDAR system 100 of FIG. 1A, processor 1112 of LIDAR system 1100 of FIG. 11A, or the like) and/or by at least one processor within a body of a vehicle (e.g., processor 408 of housing 200B of vehicle 110).

At step 1111, the processor may control at least one light source (e.g., light sources(s) 112) in a manner enabling light flux to vary over scans of a field of view using light from the at least one light source. For example, the processor may scan the field of view as explained above with respect to step 901 of FIG. 9.

In some embodiments, method 1110 may be implemented by a vehicle. For example, the vehicle may comprise at least one housing (e.g., mounted on a roof of the vehicle, a hood of the vehicle, a bumper of the vehicle, or the like) and at least one LIDAR system (e.g., LIDAR system 100, LIDAR system 1100, or the like) mounted in the at least one housing. As explained above, the LIDAR system may comprise at least one light source (e.g., of projecting unit 102 or 1102) configured to project light toward an environment of the vehicle (e.g., toward FOV 120); a group of detectors 116; and at least one mirror (e.g., deflector 114 or 1106) configured to direct the projected light toward portions of the environment and to direct reflections from objects in the environment toward the group of detectors.

At step 1113, the processor may receive from at least one sensor (e.g., sensor 1108 of FIG. 11A) first signals indicative of an output power of the at least one light source. The one or more sensors which measure the output power of the at least one light source may measure the power directly (e.g., measure illumination level of internally reflected light), indirectly (e.g., measuring temperature induced expansion of a gauge caused by the illumination of the light source), or a combination of both. In some embodiments, the sensor may determine the output power by measuring input(s) to and/or output(s) from the at least one light source.

Additionally or alternatively, the at least one sensor used for the measuring the output power of the at least one light source may include one or more sensors (e.g., sensors 116). This may be implemented, for example, by measuring internal reflections of the light source when an optical path of the LIDAR system is closed (e.g., the deflector deflects all the illumination internally within the LIDAR system, possibly not during a scanning cycle of the LIDAR system) or the like.

At step 1115, the processor may determine from the first signals a first decline in the output power of the at least one light source and may adjust an amount of energy delivered to the at least one light source to increase the output power of the light source in response to the first decline. For example, the increase may account for the first decline in the output power.

At step 1117, the processor may receive from the at least one sensor second signals indicative of an updated output power of the at least one light source after the amount of energy delivered to the at least one light source was increased. For example, step 1117 may be performed using the same techniques as discussed for step 1113.

At step 1119, the processor may determine from the second signals a second drop in the updated output power of the at least one light source and, based at least on the second decline, may determine if a performance of the at least one light source meets a performance degradation criterion. In some embodiments, determining that the performance of the at least one light source meets the performance degradation criterion may be based on both the first decline and the second decline.

For example, determining that the performance of the at least one light source meets the performance degradation criterion may be based on a time duration between the first decline and the second decline. Any other threshold with respect to time, change in amplitude, or any other properties of the first decline and/or the second decline may be used as the performance degradation criterion.

At step 1121, after determining that the performance of the at least one light source meets the performance degradation criterion, the processor may output a signal to impose a performance restriction on the vehicle until the performance degradation is abated. For example, the performance restriction may comprise a slowing of a vehicle on which the LIDAR system is installed or any other restriction discussed above with respect to method 900 of FIG. 9.

Additionally or alternatively, the at least one processor may be further configured to stop light emission of the at least one light source when the degradation value surpasses the performance threshold. Additionally or alternatively, the at least one processor may be further configured to inform a controller of the vehicle about a decrease in a detection distance of the LIDAR system. For example, the informing may comprise the message sending discussed above with respect to method 900 of FIG. 9.

In some embodiments, the value of the performance threshold may be dynamic and depend on a velocity of the vehicle and/or another operational parameter of the vehicle (whether kinematic or other, such as driving environment). Additionally or alternatively, the value of performance threshold may be dynamic and depend on operational conditions of other components of the LIDAR system. Additionally or alternatively, the value of performance threshold may be dynamic and depend on the time of the day (e.g., nighttime vs. daytime

Method 1110 may include further steps. For example, the at least one processor may be further configured to access stored information associated with the performance degradation of the light source over a period of time. Accordingly, the measurement of the output power of the at least one light source may comprise a statistical measurement executed over time.

In some embodiments, the at least one processor may be further configured to output a signal to modify detection parameters of the LIDAR system in response to at least one of the first decline and the second decline. For example, the at least one processor may increase a sensitivity setting of a sensor of the LIDAR system to account for the decline in light output.

A single LIDAR system may implement any combination of the above embodiments. For example, a LIDAR system may include an internal light source 710 and/or use internal reflections to monitor (and/or calibrate) detectors 708a, 708b, 708c, 708d, 708e, and 708f, or the like (and/or corresponding detection signal paths 714a, 714b, 714c, 714d, 714e, 714f, or the like) and also include one or more deflector position detectors 1008a and 1008b to monitor deflector 1006. In another example, a LIDAR system may include an internal light source 710 and/or use internal reflections to monitor (and/or calibrate) detectors 708a, 708b, 708c, 708d, 708e, and 708f, or the like (and/or corresponding detection signal paths 714a, 714b, 714c, 714d, 714e, 714f, or the like) and also include an illumination level sensor 1108 to monitor projecting unit 1102. Additional combinations (e.g., including an embodiment with one or more deflector position detectors 1008a and 1008b as well as illumination level sensor 1108 or an embodiment using internal light source 710 and/or internal reflections while also including one or more deflector position detectors 1008a and 1008b as well as illumination level sensor 1108) are within the scope of the present disclosure.

It should be noted that while examples of various disclosed embodiments have been described above and below with respect to a control unit that controls scanning of a deflector, the various features of the disclosed embodiments are not limited to such systems. Rather, the techniques for allocating light to various portions of a LIDAR FOV may be applicable to type of light-based sensing system (LIDAR or otherwise) in which there may be a desire or need to direct different amounts of light to different portions of field of view. In some cases, such light allocation techniques may positively impact detection capabilities, as described herein, but other advantages may also result.

It should also be noted that various sections of the disclosure and the claims may refer to various components or portions of components (e.g., light sources, sensors, sensor pixels, field of view portions, field of view pixels, etc.) using such terms as “first,” “second,” “third,” etc. These terms are used only to facilitate the description of the various disclosed embodiments and are not intended to be limiting or to indicate any necessary correlation with similarly named elements or components in other embodiments. For example, characteristics described as associated with a “first sensor” in one described embodiment in one section of the disclosure may or may not be associated with a “first sensor” of a different embodiment described in a different section of the disclosure.

It is noted that LIDAR system 100, or any of its components, may be used together with any of the embodiments and methods disclosed herein. Nevertheless, the particular embodiments and methods disclosed herein are not necessarily limited to LIDAR system 100, and may be implemented in or by other systems (such as but not limited to other LIDAR systems, other electrooptical systems, other optical systems, etc.—whichever is applicable). Also, while system 100 is described relative to an exemplary vehicle-based LIDAR platform, system 100, any of its components, and any of the processes described herein may be applicable to LIDAR systems disposed on other platform types. Likewise, the embodiments and processes disclosed herein may be implemented on or by LIDAR systems (or other systems such as other electro-optical systems, etc.) which are installed on systems disposed on platforms other than vehicles, or even regardless of any specific platform.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A LIDAR system, comprising:
at least one processor configured to:
control at least one light source;
receive from a group of detectors a first plurality of input signals, wherein the first plurality of input signals are associated with light projected by the at least one light source and reflected from an object external to the LIDAR system;
determine based on the first plurality of input signals a distance to the object;
receive from the group of detectors a second plurality of input signals, wherein the second plurality of input signals are associated with light projected internal to the LIDAR system by the at least one light source and impinging on the group of detectors at a time when external light reflections are not expected;
determine based on the second plurality of input signals that there is performance degradation in at least one detector of the group of detectors; and
initiate a remedial action in response to the determined performance degradation.

2. The LIDAR system of claim 1, wherein the at least one light source includes a first light source for projecting light externally relative to the LIDAR system and a second light source, other than the first light source, for projecting light internally towards the group of detectors.

3. The LIDAR system of claim 1, wherein the at least one processor is further configured to control an internal-directed light source other than the at least one light source.

4. The LIDAR system of claim 1, wherein the second plurality of input signals are associated with light projected from a same light source used to cause reflections from the object external to the LIDAR system.

5. The LIDAR system of claim 1, wherein the remedial action includes modifying at least one sensitivity setting of the at least one of the group of detectors.

6. The LIDAR system of claim 5, wherein the at least one sensitivity setting includes a voltage supply to at least one detector out of the group of detectors.

7. The LIDAR system of claim 1, wherein the remedial action includes modifying an illumination scheme of the at least one light source.

8. The LIDAR system of claim 7, wherein modifying the illumination scheme includes at least one of: stopping light emission of the at least one light source, altering an illumination level of the at least one light source, or changing a number of pulses per pixel of the group of detectors.

9. The LIDAR system of claim 1, wherein determining that there is a performance degradation of at least one of the group of detectors includes comparing the second plurality of input signals with data indicative of expected performance.

10. The LIDAR system of claim 1, wherein determining that there is a performance degradation of at least one of the group of detectors includes comparing at least one input signal out of the second plurality of input signals with at least one other input signal out of the second plurality of input signals.

11. The LIDAR system of claim 1, wherein determining that there is a performance degradation of at least one of the group of detectors includes comparing at least one property of at least one input signal out of the second plurality of input signals with the at least one property of at least one other input signal out of the second plurality of input signals.

12. The LIDAR system of claim 1, wherein each detector includes a plurality of Single Photon Avalanche Diodes (SPADs) or at least one Avalanche Photo Diode (APD).

13. A method for detecting degradation in a LIDAR system, comprising:
controlling at least one light source;
receiving, from a group of detectors, a first plurality of input signals, wherein the first plurality of input signals are associated with light projected by the at least one light source and reflected from an object external to the LIDAR system;
determining, based on the first plurality of input signals, a distance to the object;
receiving, from the group of detectors, a second plurality of input signals, wherein the second plurality of input signals are associated with light projected internal to the LIDAR system by the at least one light source and impinging on the group of detectors at a time when external light reflections are not expected;
determining, based on the second plurality of input signals, that there is performance degradation in at least one detector of the group of detectors; and
initiating a remedial action in response to the determined performance degradation.

14. The method of claim 13, wherein the remedial action includes sending a message to a host in response to determining that there is a performance degradation.

15. The method of claim 13, wherein the remedial action includes preventing a vehicle from initiating one or more autonomous driving operations.

16. The method of claim 13, wherein the remedial action includes causing a vehicle to initiate a remedial autonomous driving operation.

17. The method of claim 16, wherein the remedial autonomous driving operation includes at least one of stopping the vehicle or pulling the vehicle over to a side of a road.

18. The method of claim 13, wherein the remedial action includes changing a scanning pattern of the at least one light source, at least one mirror directing the projected light toward a scene including the object external to the LIDAR system, or a combination thereof.

19. The method of claim 18, wherein changing the scanning pattern includes increasing at least one dimension of a scanning path.

20. A vehicle, comprising:
at least one housing;
at least one LIDAR system mounted in the at least one housing and comprising:
at least one light source configured to project light toward an environment of the vehicle;
a group of detectors; and
at least one mirror configured to direct the projected light toward portions of the environment and to direct reflections from objects in the environment toward the group of detectors; and
at least one processor configured to:
control the at least one light source;
receive from the group of detectors a first plurality of input signals, wherein the first plurality of input signals are associated with the light projected by the at least one light source and reflected from an object external to the LIDAR system;
determine based on the first plurality of input signals a distance to the object;
receive from the group of detectors a second plurality of input signals, wherein the second plurality of input signals are associated with light projected internal to the LIDAR system by the at least one light source and impinging on the group of detectors at a time when external light reflections are not expected;
determine based on the second plurality of input signals that there is performance degradation in at least one detector of the group of detectors; and
initiate a remedial action in response to the determined performance degradation.

21. A LIDAR system, comprising:
at least one processor configured to:
control light emission of at least one light source, wherein light projected from the at least one light source is directed to at least one deflector for scanning a field of view;
control positioning of the at least one light deflector to deflect light from the at least one light source along a scanning pattern to scan the field of view;
receive signals from at least one sensor configured to measure positions of the at least one light deflector, wherein the received signals are indicative of an actual scanning pattern of the at least one deflector;
access data indicative of an expected scanning pattern of the at least one deflector;
use the accessed data and the received signals to determine that there is a deviation between the expected scanning pattern and the actual scanning pattern; and
initiate a remedial action in response to the determined deviation.

22. A LIDAR system for use in a vehicle, the LIDAR system comprising:
at least one processor configured to:
control at least one light source in a manner enabling light flux to vary over scans of a field of view using light from the at least one light source;
receive from at least one sensor first signals indicative of an output power of the at least one light source;
determine from the first signals a first decline in the output power of the at least one light source;
adjust an amount of energy delivered to the at least one light source to increase the output power of the light source in response to the first decline;
receive from the at least one sensor second signals indicative of an updated output power of the at least one light source after the amount of energy delivered to the at least one light source was increased;
determine from the second signals a second drop in the updated output power of the at least one light source;
based at least on the second decline, determine if a performance of the at least one light source meets a performance degradation criterion; and
after determining that the performance of the at least one light source meets the performance degradation criterion, output a signal to impose a performance restriction on the vehicle until the performance degradation is abated.
